(19) United States
(12) Patent Application Publication
(10) Pub. No.: US 2024/0134298 A1
(43) Pub. Date: Apr. 25, 2024

(54) ELECTROSTATIC CHARGE IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Yasuo KADOKURA, Minamiashigara-shi (JP); Yosuke TSURUMI, Minamiashigara-shi (JP); Moegi IGUCHI, Minamiashigara-shi (JP)

(73) Assignee: FUJIFILM Business Innovation Corp., Tokyo (JP)

(21) Appl. No.: 18/309,291

(22) Filed: Apr. 28, 2023

(30) Foreign Application Priority Data
Sep. 22, 2022 (JP) 2022-151972

(51) Int. Cl. G03G 9/087; G03G 9/097; G03G 9/113; G03G 21/18

(52) U.S. Cl. CPC G03G 9/08728; G03G 9/09725; G03G 9/1133; G03G 21/1814

(57) ABSTRACT

An electrostatic charge image developer includes: a toner A incorporating toner particles and silica particles (A) as an external additive, the toner particles containing a binder resin and resin particles, and the silica particles (A) containing a nitrogen-containing compound containing the element molybdenum; and a carrier B incorporating a core and a coating resin layer, the coating resin layer covering the core and containing inorganic particles, and the ratio N_{Mo}/N_{Si} is 0.035 or greater and 0.45 or less, where N_{Mo} and N_{Si} are measured net intensities for the element molybdenum and the element silicon, respectively, in the silica particles (A) in x-ray fluorescence analysis.

### CROSS-REFERENCE TO RELATED APPLICATIONS

This application is based on and claims priority under 35 USC 119 from Japanese Patent Application No. 2022-151972 filed Sep. 22, 2022.

### BACKGROUND

### (i) Technical Field

The present disclosure relates to an electrostatic charge image developer, a process cartridge, an image forming apparatus, and an image forming method.

### (ii) Related Art

Japanese Unexamined Patent Application Publication No. 2021-51149 discloses a carrier for developing electrostatic charge images having a core and a coating resin layer, the coating resin layer covering the core and containing inorganic particles, wherein the inorganic particle content of the coating resin layer is 10% by mass or more and 60% by mass or less of the total mass of the layer, and relation (1) holds:

0.007≤D/T≤0.24 (1)

where D is the volume-average diameter (μm) of the inorganic particles, and T is the thickness (μm) of the coating resin layer.

Japanese Unexamined Patent Application Publication No. 8-123073 discloses a toner for developing electrostatic charge images composed of toner particles and an additive, the additive containing hydrophobized silica and positively charged silica, wherein the relation expressed by formula (1) holds between the relative amount to the toner and BET specific surface area of the hydrophobized silica, those of the positively charged silica, and the volume-average diameter of the toner particles.

Japanese Unexamined Patent Application Publication No. 2020-42122 discloses a toner for developing electrostatic latent images incorporating toner particles containing a binder resin, the binder resin containing amorphous and crystalline resins, wherein when the strain dispersion as a dynamic rheological parameter of the toner is measured under the conditions of a temperature of 130° C., a frequency of 1 Hz, and strain amplitudes of 1.0% to 500%, the integral of stress in the stress-strain curve at a strain amplitude of 100% is more than 0 Pa and 350000 Pa or less, and the inclination of the major axis is more than 22° and less than 90°.

Japanese Unexamined Patent Application Publication No. 2020-42121 discloses a toner for developing electrostatic latent images incorporating toner particles containing a binder resin, the binder resin containing amorphous vinyl and crystalline resins, wherein when the strain dispersion as a dynamic rheological parameter of the toner is measured under the conditions of a temperature of 130° C., a frequency of 1 Hz, and strain amplitudes of 1.0% to 500%, the integral of stress in the stress-strain curve at a strain amplitude of 100% is more than 0 Pa and 350000 Pa or less, and the inclination of the major axis is 0° or more and less than 10°.

Japanese Unexamined Patent Application Publication No. 2020-106685 discloses a toner for developing electrostatic charge images containing a binder resin and a release agent, the binder resin incorporating a crystalline resin, wherein a particular relation holds for the storage modulus of the toner measured with varying strains from 0.01% to 1000% at a frequency of 1 Hz and 150° C.

Japanese Unexamined Patent Application Publication No. 2019-144368 discloses a toner for developing electrostatic charge images containing base toner particles and an external additive, the base toner particles containing a binder resin and a release agent and the binder resin containing a crystalline resin, wherein a particular relation holds between the maximum of the peak of the loss tangent of the toner measured at 25° C. to 100° C. under the conditions of a frequency of 1 Hz and a heating rate of 6° C./min and that measured at 25° C. to 100° C. under the conditions of a frequency of 1 Hz and a heating rate of 3° C./min.

Japanese Unexamined Patent Application Publication No. 2013-160886 discloses a toner for developing electrostatic charge images containing an amorphous resin, a crystalline resin, a coloring agent, and a release agent, wherein the percentage change in the storage modulus G′ of the toner is more than 50% and less than 86%, that in loss modulus G″ is more than 50%, and the storage modulus G′ of the toner under strains of 1% to 50% at a temperature of 150° C. is from 5×10² to 3.5×10³ Pa·s.

Japanese Unexamined Patent Application Publication Nos. 2011-237793 and 2011-237792 disclose toners for developing electrostatic charge images composed of toner particles containing a binder resin, wherein a cross-sectional elasticity map of the toner particles measured by atomic force microscopy has a particular structure.

Japanese Unexamined Patent Application Publication No. 2021-151944 discloses silica particles containing a quaternary ammonium salt, wherein the ratio F_{BEFORE}/F_{AFTER} is 0.90 or greater and 1.10 or less, where F_{BEFORE} is the maximum frequency of pores having a diameter of 2 nm or less determined in a pore size distribution curve of unwashed silica particles obtained by nitrogen adsorption, and F_{AFTER} is that determined in a pore size distribution curve of washed silica particles obtained by nitrogen adsorption, and the ratio F_{SINTERING}/F_{BEFORE} is 5 or greater and 20 or less, where F_{SINTERING} is the maximum frequency of pores having a diameter of 2 nm or less determined in a pore size distribution curve of unwashed silica particles fired at 600° C.

### SUMMARY

Aspects of non-limiting embodiments of the present disclosure relate to an electrostatic charge image developer that includes toner particles containing a binder resin and resin particles and may be superior in fog control compared with when the ratio N_{Mo}/N_{Si} is less than 0.035 or greater than 0.45, where N_{Mo} and N_{Si} are measured net intensities for the element molybdenum and the element silicon, respectively, in x-ray fluorescence analysis.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic charge image developer including: a toner A incorporating a toner particle and a silica particle (A) as an external additive, the toner particle containing a binder resin and a resin particle, and the silica particle (A) containing a nitrogen-containing compound containing element molybdenum; and a carrier B incorporating a core and a coating resin layer, the coating resin layer covering the core and containing an inorganic particle, wherein a ratio N_{Mo}/N_{Si} is 0.035 or greater and 0.45 or less, where N_{Mo} and N_{Si} are measured net intensities for the element molybdenum and element silicon, respectively, in the silica particle (A) in x-ray fluorescence analysis.

### BRIEF DESCRIPTION OF THE DRAWINGS

Exemplary embodiments of the present disclosure will be described in detail based on the following figures, wherein:

FIG. 1 is a schematic diagram illustrating the structure of an example of an image forming apparatus according to an exemplary embodiment; and

FIG. 2 is a schematic diagram illustrating the structure of an example of a process cartridge, according to an exemplary embodiment, attachable to and detachable from an image forming apparatus.

### DETAILED DESCRIPTION

Exemplary embodiments will now be described. The descriptions and the Examples section are for illustrative purposes and are not intended to limit the scope of embodiments.

Numerical ranges specified in the descriptions of exemplary embodiments with “A-B,” “between A and B,” “(from) A to B,” etc., represent inclusive ranges, which include the minimum A and the maximum B as well as all values in between.

In a series of numerical ranges presented in the descriptions of exemplary embodiments, the upper or lower limit of a numerical range may be substituted with that of another in the same series. The upper or lower limit of a numerical range, furthermore, may be substituted with a value indicated in the Examples section.

As used in the descriptions of exemplary embodiments, the word “step” does not always represent an independent step; as long as its purpose is fulfilled, a step may be continuous with or part of another.

Reference to a drawing in a description of an exemplary embodiment does not mean that the structure of the exemplary embodiment is limited to the structure illustrated in the drawing. The size of elements in each drawing is conceptual; the relative sizes of the elements do not need to be as illustrated.

A constituent in the descriptions of exemplary embodiments may be a combination of multiple substances. If a composition mentioned in the descriptions of exemplary embodiments contains a combination of multiple substances as one of its constituents, the amount of the constituent represents the total amount of the substances in the composition unless stated otherwise.

A constituent in the descriptions of exemplary embodiments may be a combination of multiple kinds of particles. If a composition contains a combination of multiple kinds of particles as one of its constituents, the diameter of particles of the constituent is that of the mixture of the multiple kinds of particles present in the composition unless stated otherwise.

As used in the descriptions of exemplary embodiments, the term “(meth)acrylic” includes both acrylic and methacrylic, and “(meth)acrylate” includes both an acrylate and a methacrylate.

In the descriptions of exemplary embodiments, “toner for developing an electrostatic charge image” may be referred to as “toner,” “an electrostatic charge image developer” may be referred to as “a developer,” and “a carrier for developing an electrostatic charge image” may be referred to as “a carrier.”

### Electrostatic Charge Image Developer

An electrostatic charge image developer according to an exemplary embodiment includes a toner A incorporating toner particles and silica particles (A) as an external additive, the toner particles containing a binder resin and resin particles, and the silica particles (A) containing a nitrogen-containing compound containing the element molybdenum; and a carrier B incorporating a core and a coating resin layer, the coating resin layer covering the core and containing inorganic particles, and the ratio N_{Mo}/N_{Si} is 0.035 or greater and 0.45 or less, where N_{Mo} and N_{Si} are measured net intensities for the element molybdenum and the element silicon, respectively, in the silica particles (A) in x-ray fluorescence analysis.

Reducing the viscosity of toner for better fixation at low temperatures makes it difficult for the toner to combine fixation at low temperatures with storage stability, and adding resin particles into the toner particles to harden the toner may help improve storage stability.

A toner made with toner particles containing resin particles, however, tends to suffer the detachment of external additives from the hardened surface of the toner, and the detached external additives can migrate to the carrier, and thereby can reduce the charge to an extent that the defect called “fog” occurs, under stress conditions, such as large-volume printing of a high-density image.

The electrostatic charge image developer according to this exemplary embodiment is made with silica particles (A) containing a nitrogen-containing compound that contains the element molybdenum (external additive) and a carrier B having a coating resin layer that contains inorganic particles so that even if some of the external additive migrates to the carrier, it returns to the toner rather than adhering firmly to the carrier, and this may encourage efficient charging of the toner by the silica particles (A), which is an advantage of the silica particles containing a nitrogen-containing compound that contains the element molybdenum. The possible mechanisms are: the inorganic particles in the coating resin layer of the particles of the carrier harden the carrier resin layer with the filler effect, reducing the physical adhesion of the external additive; the positively charged element nitrogen in the silica particles (A) cancels out excessive negative charge on the base silica particles; the coating resin layer of the particles of the carrier B is charged uniformly because the inorganic particles are present dispersed therein; overall, reduced physical and electrostatic adhesion between the silica particles (A) and the particles of the carrier B synergistically help prevent firm adhesion of the external additive to the carrier.

Presumably through these mechanisms, the toner may lose its charge only to a limited extent, and the electrostatic charge image developer may be able to produce images less fog in consequence.

Incidentally, simply referring to “toner” and “carrier” hereafter means “the toner A” and “the carrier B,” respectively, unless stated otherwise.

Ratio N_{Mo}/N_{Si} for the Silica Particles (A)

In this exemplary embodiment, the ratio N_{Mo}/N_{Si} for the silica particles (A) is 0.035 or greater and 0.45 or less.

The ratio N_{Mo}/N_{Si} may be 0.05 or greater, preferably 0.07 or greater, more preferably 0.10 or greater for fog control reasons.

The ratio N_{Mo}/N_{Si}, furthermore, may be 0.40 or less, preferably 0.35 or less, more preferably 0.30 or less for fog control reasons.

The net intensity for the element molybdenum, N_{Mo}, for the silica particles (A) may be 5 kcps or more and 75 kcps or less, preferably 7 kcps or more and 55 kcps or less, more preferably 8 kcps or more and 50 kcps or less, even more preferably 10 kcps or more and 40 kcps or less for charge distribution narrowing and charge distribution maintenance reasons.

The net intensities for the element molybdenum and the element silicon, N_{Mo} and N_{Si}, for the silica particles are measured as follows.

Approximately 0.5 g of the silica particles is compressed into a 50-mm diameter and 2-mm thick disk by pressing it with a load of 6 t for 60 seconds using a compression molding machine. This disk as a test specimen is analyzed using a scanning x-ray fluorescence spectrometer (XRF-1500, Shimadzu Corporation) under the conditions below to determine the chemical elements therein qualitatively and quantitatively, and the net intensities for the element molybdenum and the element silicon (in kcps, kilo-counts per second) are determined.
Tube voltage: 40 kV
Tube current: 90 mA
Measurement area (spot size): 10 mm diameter
Measurement time: 30 minutes
Anticathode material: Rhodium
   Ratio D_{B}/D_{A} Between the Average Diameter of Primary Particles for the Silica Particles (A), D_{A}, and the Average Diameter of Primary Particles for the Inorganic Particles, D_{B}

The ratio D_{B}/D_{A}, where D_{A} is the average diameter of primary particles for the silica particles (A), and D_{B} is that for the inorganic particles, may be 0.06 or greater and 2.30 or less, preferably 0.025 or greater and 9 or less, more preferably 0.20 or greater and 2.00 or less, even more preferably 0.30 or greater and 1.50 or less for fog control reasons.

The average diameter of primary particles for the silica particles (A), D_{A}, may be 10 nm or more and 120 nm or less, preferably 20 nm or more and 100 nm or less, more preferably 30 nm or more and 90 nm or less, even more preferably 40 nm or more and 80 nm or less for fog control reasons.

The method for measuring the average diameter of primary particles, and the average circularity and the geometric standard deviation by number (both described later), for the silica particles (A) is as follows.

The toner is imaged at a magnification of 40,000 using a scanning electron microscope (SEM) (Hitachi High-Technologies, S-4800) coupled with an energy-dispersive x-ray spectrometer (EDX spectrometer) (HORIBA, Ltd., EMAX Evolution X-Max 80 mm²). A field of view in the image is analyzed by EDX to find 200 silica particles (A) based on the presence of the elements Mo, N, and Si. The figures of the 200 silica particles (A) are analyzed using WinROOF image processing and analysis software (Mitani Corporation). The equivalent circular diameter, area, and circumference of each figure of a primary particle are determined, and the circularity is calculated as 4π×(area of the particle figure)/(circumference of the particle figure)². In the circularity distribution, the circularity at which the cumulative percentage from the smallest circularity is 50% is reported as the average circularity. In the equivalent circular diameter distribution, the equivalent circular diameter at which the cumulative percentage of particles from the smallest diameter is 50% is reported as the average diameter of primary particles. The geometric standard deviation by number is determined as (D84/D16)^{0.5}, where D16 and D84 are the equivalent circular diameters in the equivalent circular diameter distribution at which the cumulative percentage of particles from the smallest diameter is 16% and 84%, respectively.

The average diameter of primary particles for the inorganic particles, D_{B}, may be 5 nm or more and 90 nm or less, preferably 5 nm or more and 70 nm or less, more preferably 5 nm or more and 50 nm or less, even more preferably 8 nm or more and 50 nm or less for fog control reasons.

The average diameter of primary particles for the inorganic particles is measured by observing the surface of the carrier under a scanning microscope and analyzing images of the inorganic particles adhering to the coating layer. Specifically, the carrier is observed under a scanning electron microscope (SEM) (Hitachi High-Technologies Corp., S-4800) coupled with an energy-dispersive x-ray spectrometer (EDX spectrometer) (HORIBA, Ltd., EMAX Evolution X-Max 80 mm²) and imaged at a magnification of 40,000. In the image, a field of view is analyzed by EDX to find the inorganic particles. The SEM observation is performed with an acceleration voltage of 15 kV, an emission current of 20 μA, and a WD of 15 mm, and the EDX analysis is carried out with the same parameters but over a detection time of 60 minutes. Fifty inorganic particles are observed on each particle of the carrier, their images are loaded into an image analyzer (LUZEX III, Nireco Corporation), the longest and shortest diameters of inorganic particles are measured for each carrier particle by analyzing the images of the inorganic particles, and the medians are used to determine the equivalent spherical diameter. This measurement of equivalent spherical diameter is repeated for 100 carrier particles. The equivalent spherical diameter at which the cumulative frequency by volume is 50% (D50v) is reported as the average diameter of primary particles for the inorganic particles.

Ratio D_{B}/D_{C} Between the Average Diameter of Primary Particles for the Resin Particles, D_{C}, and the Average Diameter of Primary Particles for the Inorganic Particles, D_{B}

The ratio D_{B}/D_{C}, where D_{C} is the average diameter of primary particles for the resin particles, and D_{B} is that for the inorganic particles, may be 0.02 or greater and 1.40 or less, preferably 0.05 or greater and 1.20 or less, more preferably 0.10 or greater and 1.10 or less, even more preferably 0.15 or greater and 1.00 or less for fog control reasons.

The average diameter of primary particles for the resin particles, D_{C}, may be 60 nm or more and 300 nm or less, preferably 100 nm or more and 200 nm or less, more preferably 130 nm or more and 170 nm or less for fog control reasons.

The average diameter of primary particles for the resin particles is that measured using a transmission electron microscope (TEM). The transmission electron microscope can be, for example, JEOL Datum Ltd.'s JEM-1010.

A piece of epoxy resin with an embedded toner particle therein is cut into an approximately 0.3-μm thick section using a microtome. The cross-section of the toner particle is imaged at a magnification of 4500 using a transmission electron microscope. On the TEM image, the equivalent circular diameter (nm) of 1,000 randomly selected resin particles is determined, and the arithmetical mean of the determined equivalent circular diameters is reported as the average diameter of primary particles (nm).

Alternatively, the number-average diameter of the resin particles may be the diameter of the resin particles measured by analyzing a liquid dispersion of the particles using a laser-diffraction particle size distribution analyzer (e.g., HORIB A, Ltd., LA-700).

Ratio D_{C}/D_{A} Between the Average Diameter of Primary Particles for the Resin Particles, D_{C}, and the Average Diameter of Primary Particles for the Silica Particles (A), D_{A}

The ratio D_{C}/D_{A}, where D_{C} is the average diameter of primary particles for the resin particles, and D_{A} is that for the silica particles (A), may be 0.5 or greater and 7.0 or less for fog control reasons.

When the ratio D_{C}/D_{A} is 7.0 or less, the silica particles (A) may be less likely to sink into the binder resin as a component of the toner particles. For this reason, the ratio D_{C}/D_{A} may be 6.0 or less, preferably 5.0 or less.

When the ratio D_{C}/D_{A} is 0.5 or greater, too, the silica particles (A) may be less likely to sink into the binder resin as a component of the toner particles. For this reason, the ratio D_{C}/D_{A} may be 0.8 or greater, preferably 1.0 or greater.

### Toner A

The electrostatic charge image developer according to this exemplary embodiment includes a toner A incorporating, as an external additive, silica particles (A) containing a nitrogen-containing compound that contains the element molybdenum.

The toner A, furthermore, may include toner particles containing a binder resin and at least the silica particles (A) attached thereto as an external additive.

The ingredients, structure, and production of the toner used in this exemplary embodiment will now be described in detail.

### Toner Particles

The toner particles contain at least a binder resin and resin particles. The toner particles may contain a coloring agent, a release agent, and other additives.

### Binder Resin

Examples of binder resins include vinyl resins that are homopolymers of monomers such as styrenes (e.g., styrene, para-chlorostyrene, and α-methylstyrene), (meth)acrylates (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (e.g., vinyl methyl ketone, vinyl ethyl ketone, and vinyl isopropenyl ketone), and olefins (e.g., ethylene, propylene, and butadiene) and copolymers of two or more such monomers.

Non-vinyl resins, such as epoxy resins, polyester resins, polyurethane resins, polyamide resins, cellulose resins, polyether resins, and modified rosin, mixtures of any such resin and a vinyl resin, and graft copolymers obtained by polymerizing a vinyl monomer in the presence of any such non-vinyl resin may also be used.

One such binder resin may be used alone, or two or more may be used in combination.

The binder resin may contain a polyester resin.

When the resin particles in the toner particles are styrene (meth)acrylic resin particles, using a polyester resin as a binder resin may make it easier to control the difference between the SP of the resin particles (styrene (meth)acrylic resin particles) and that of the binder resin to a particular range. Certain differences in SP may help the resin particles (styrene (meth)acrylic resin particles) disperse in the toner particles well.

The binder resin may contain a polyester resin having an aliphatic dicarboxylic acid unit (structural unit derived from an aliphatic dicarboxylic acid). Compared with those only having an aromatic dicarboxylic acid, polyester binder resins having an aliphatic dicarboxylic acid unit may help make changes in loss tangent tan δ even smaller by allowing the resin particles to disperse more uniformly therein by virtue of their high flexibility.

The binder resin, furthermore, may contain an amorphous polyester resin having an aliphatic dicarboxylic acid unit and a crystalline polyester resin having an aliphatic dicarboxylic acid unit. A binder resin containing amorphous and crystalline polyester resins may allow the resin particles to disperse more uniformly therein by virtue of the aliphatic dicarboxylic unit that they both have.

Examples of aliphatic dicarboxylic acids that may be used include saturated aliphatic dicarboxylic acids represented by the general formula “HOOC—(CH₂)ₙ—COOH.” n in this general formula may be from 4 to 20, preferably from 4 to 12.

The binder resin may contain a crystalline resin and an amorphous resin.

A crystalline resin is a resin that exhibits a clear endothermic peak rather than stepwise endothermic changes in differential scanning calorimetry (DSC). An amorphous resin is a resin that exhibits stepwise endothermic changes rather than a clear endothermic peak in differential scanning calorimetry (DSC).

Specifically, the term crystalline resin refers to a resin whose endothermic peak as measured at a heating rate of 10° C./min has a full width at half maximum of 10° C. or narrower, whereas the term amorphous resin refers to a resin with which the full width at half maximum is broader than 10° C. or that exhibits no clear endothermic peak in the same situation.

### Crystalline Resin

Examples of crystalline resins include crystalline polyester resins and crystalline vinyl resins (e.g., polyalkylene resins and long-chain alkyl (meth)acrylate resins). Crystalline polyester resins may help ensure mechanical strength and fixation at low temperatures of the toner.

Crystalline Polyester Resin

An example of a crystalline polyester resin is a polycondensate of a polycarboxylic acid and a polyhydric alcohol. The crystalline polyester resin may be a commercially available crystalline polyester resin or may be a synthesized crystalline polyester resin.

Crystalline polyester resins made with linear aliphatic polymerizable monomers form a crystal structure more easily than those made with aromatic polymerizable monomers.

Examples of polycarboxylic acids include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., dibasic acids, such as phthalic acid, isophthalic acid, terephthalic acid, and naphthalene-2,6-dicarboxylic acid), and anhydrides and lower-alkyl (e.g., C1 to C5 alkyl) esters thereof.

A combination of a dicarboxylic acid with a carboxylic acid having three or more carboxylic groups and able to form a crosslinked or branched structure may also be used. Examples of carboxylic acids having three carboxylic groups include aromatic carboxylic acids (e.g., 1,2,3-benzenetricarboxylic acid, 1,2,4-benzenetricarboxylic acid, and 1,2,4-naphthalenetricarboxylic acid) and anhydrides and lower-alkyl (e.g., C1 to C5 alkyl) esters thereof.

A combination of a dicarboxylic acid with a dicarboxylic acid having a sulfonic acid group or ethylenic double bond may also be used.

One polycarboxylic acid may be used alone, or two or more may be used in combination.

Examples of polyhydric alcohols include aliphatic diols (e.g., linear aliphatic diols having a C7 to C20 backbone). Examples of aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Of these, 1,8-octanediol, 1,9-nonanediol, and 1,10-decanediol are preferred.

A combination of a diol with an alcohol having three or more hydroxyl groups and able to form a crosslinked or branched structure may also be used. Examples of alcohols having three or more hydroxyl groups include glycerol, trimethylolethane, trimethylolpropane, and pentaerythritol.

One polyhydric alcohol may be used alone, or two or more may be used in combination.

The polyhydric alcohol may include an aliphatic diol. The percentage of the aliphatic diol to the polyhydric alcohol may be 80 mol % or more, preferably 90 mol % or more.

The melting temperature of the crystalline polyester resin may be 50° C. or above and 100° C. or below, preferably 55° C. or above and 90° C. or below, more preferably 60° C. or above and 85° C. or below.

The melting temperature of the crystalline polyester resin is determined from the DSC curve of the resin, which is obtained by differential scanning calorimetry (DSC), as the “peak melting temperature” described in the methods for determining melting temperatures set forth in JIS K7121-1987 “Testing Methods for Transition Temperatures of Plastics.”

The weight-average molecular weight (Mw) of the crystalline polyester resin may be 6000 or more and 35000 or less.

If the toner particles contain a crystalline resin, the percentage of the crystalline resin in the binder resin may be 4% by mass or more and 50% by mass or less, preferably 6% by mass or more and 30% by mass or less, more preferably 8% by mass or more and 20% by mass or less for fog control reasons.

If the toner particles contain a crystalline polyester resin, the percentage of the crystalline polyester resin in the binder resin may be 4% by mass or more and 50% by mass or less, preferably 6% by mass or more and 30% by mass or less, more preferably 8% by mass or more and 20% by mass or less for fog control reasons.

When the percentage by mass of the crystalline resin or crystalline polyester resin in the binder resin is in these ranges, compared with when lower or higher, (1) the external additive may be less likely to sink into the toner particles, (2) the toner may combine storage stability with good fixation, and (3) variations in the gloss of the fixed image associated with fixing conditions (differences in temperature and pressure) may be reduced.

### Amorphous Resin

Examples of amorphous resins include amorphous polyester resins, amorphous vinyl resins (e.g., styrene-acrylic resins), epoxy resins, polycarbonate resins, and polyurethane resins. Of these, amorphous polyester resins and amorphous vinyl resins (styrene-acrylic resins in particular) are preferred, and amorphous polyester resins are more preferred.

Amorphous Polyester Resin

An example of an amorphous polyester resin is a polycondensate of a polycarboxylic acid and a polyhydric alcohol. The amorphous polyester resin may be a commercially available amorphous polyester resin or may be a synthesized amorphous polyester resin.

Examples of polycarboxylic acids include aliphatic dicarboxylic acids (e.g., oxalic acid, malonic acid, maleic acid, fumaric acid, citraconic acid, itaconic acid, glutaconic acid, succinic acid, alkenylsuccinic acids, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), and anhydrides and lower-alkyl (e.g., C1 to C5 alkyl) esters thereof. Of these, aromatic dicarboxylic acids are preferred.

A combination of a dicarboxylic acid with a carboxylic acid having three or more carboxylic groups and able to form a crosslinked or branched structure may also be used. Examples of carboxylic acids having three or more carboxylic groups include trimellitic acid, pyromellitic acid, and anhydrides and lower-alkyl (e.g., C1 to C5 alkyl) esters thereof.

One polycarboxylic acid may be used alone, or two or more may be used in combination.

Examples of polyhydric alcohols include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., ethylene oxide adducts of bisphenol A and propylene oxide adducts of bisphenol A). Of these, aromatic diols and alicyclic diols are preferred, and aromatic diols are more preferred.

A combination of a diol with a polyhydric alcohol having three or more hydroxyl groups and able to form a crosslinked or branched structure may also be used. Examples of polyhydric alcohols having three or more hydroxyl groups include glycerol, trimethylolpropane, and pentaerythritol.

One polyhydric alcohol may be used alone, or two or more may be used in combination.

The glass transition temperature (Tg) of the amorphous polyester resin may be 50° C. or above and 80° C. or below, preferably 50° C. or above and 65° C. or below.

The glass transition temperature of the amorphous polyester resin is determined from the DSC curve of the resin, which is obtained by differential scanning calorimetry (DSC), more specifically as the “extrapolated initial temperature of glass transition” described in the methods for determining glass transition temperatures set forth in JIS K 7121-1987 “Testing Methods for Transition Temperatures of Plastics.”

The weight-average molecular weight (Mw) of the amorphous polyester resin may be 5000 or more and 1000000 or less, preferably 7000 or more and 500000 or less.

The number-average molecular weight (Mn) of the amorphous polyester resin may be 2000 or more and 100000 or less.

The molecular weight distribution, Mw/Mn, of the amorphous polyester resin may be 1.5 or greater and 100 or less, more preferably 2 or greater and 60 or less.

The weight- and number-average molecular weights of the amorphous polyester resin are measured by gel permeation chromatography (GPC). The GPC measurement of molecular weights is performed using Tosoh's HLC-8120 GPC chromatograph and Tosoh's TSKgel SuperHM-M column (15 cm) with tetrahydrofuran as the eluate. The weight- and number-average molecular weights are calculated by comparing the results of the measurement with a molecular-weight calibration curve constructed using monodisperse polystyrene standards.

The amorphous polyester resin is obtained by a known production method. A specific example is to polymerize the starting monomers at a temperature of 180° C. or above and 230° C. or below, optionally under reduced pressure so that the water and alcohol produced with the condensation will leave.

If any starting monomer is insoluble or not miscible with the others at the reaction temperature, a high-boiling solvent may be added as a solubilizer to make it soluble. The solubilizer, if used, is removed by distillation during the polycondensation. Any monomer not miscible with the others may be condensed with the counterpart acid or alcohol before the polycondensation.

The binder resin content may be 40% by mass or more and 95% by mass or less, preferably 50% by mass or more and 90% by mass or less, more preferably 60% by mass or more and 85% by mass or less of the toner particles as a whole.

### Resin Particles

The toner particles contain resin particles.

Examples of resins from which the resin particles can be formed include polyolefins (e.g., polyethylene and polypropylene), styrene resins (e.g., polystyrene and poly-α-methylstyrene), (meth)acrylic resins (e.g., polymethyl methacrylate and polyacrylonitrile), styrene-(meth)acrylic resins, epoxy resins, polyurethane resins, polyurea resins, polyamide resins, polyamide resins, polycarbonate resins, polyether resins, polyester resins, and copolymers thereof. One such resin may be used alone, or two or more may be used in combination.

The resin forming the resin particles may be a vinyl resin, such as a polyolefin, styrene resin, (meth)acrylic resin, or styrene-(meth)acrylic resin, for fog control reasons, and styrene (meth)acrylic resins are preferred. In other words, the resin particles may be particles of a vinyl resin, preferably resins of a styrene-(meth)acrylic resin, for fog control reasons.

The resin particles may be crosslinked resin particles for fog control reasons. “Crosslinked resin particles” are resin particles containing a resin having a bridge structure between atoms. An example of a crosslinked resin is a crosslinked form of one of the resins listed above.

Examples of crosslinked resin particles include those containing a resin crosslinked by ionic bonds (ionically crosslinked resin particles) and those containing a resin crosslinked by covalent bonds (covalently crosslinked resin particles). Crosslinked resin particles containing a resin crosslinked by covalent bonds are preferred.

The crosslinked resin particles may be crosslinked vinyl resin particles, particles formed from a crosslinked vinyl resin; this may help ensure that slight differences in charge will be distributed adequately on the surface of the toner particles when the binder resin contains a polyester resin.

The crosslinked vinyl resin, furthermore, may be a crosslinked styrene-(meth)acrylic resin for fog control reasons. In other words, the crosslinked resin particles may be crosslinked styrene-(meth)acrylic resin particles for fog control reasons. Using a crosslinked styrene-(meth)acrylic resin as a material for the resin particles may make it easier to obtain resin particles (S) as described later.

An example of a styrene-(meth)acrylic resin is a resin synthesized from a styrene monomer and a (meth)acrylic monomer, both as described below, by radical polymerization.

Examples of styrene monomers include styrene, α-methylstyrene, and vinylnaphthalene; alkylated styrenes, such as 2-methylstyrene, 3-methylstyrene, 4-methylstyrene, 2-ethylstyrene, 3-ethylstyrene, and 4-ethylstyrene; halogenated styrenes, such as 2-chlorostyrene, 3-chlorostyrene, and 4-chlorostyrene; and fluorinated styrenes, such as 4-fluorostyrene and 2,5-difluorostyrene. Styrene and α-methylstyrene are preferred styrene monomers. One styrene monomer may be used alone, or two or more may be used in combination.

Examples of (meth)acrylic monomers include (meth)acrylic acid, methyl (meth)acrylate, ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, 2-carboxypropyl (meth)acrylate, 3-carboxypropyl (meth)acrylate, 4-carboxybutyl (meth)acrylate, (meth)acrylonitrile, and (meth)acrylamide. One (meth)acrylate monomer may be used alone, or two or more may be used in combination.

The (meth)acrylic monomer may be a combination of a lower-alkyl (meth)acrylate and a lower-carboxyalkyl (meth)acrylate.

The “lower-alkyl” in the lower-alkyl (meth)acrylate refers to a C1 to C5 alkyl; the “lower-alkyl” may be a C2 to C4 alkyl, preferably a C3 or C4 alkyl. Examples of lower-alkyl (meth)acrylates include methyl (meth)acrylate, ethyl (meth)acrylate, n-propyl (meth)acrylate, n-butyl (meth)acrylate, n-pentyl (meth)acrylate, isopropyl (meth)acrylate, isobutyl (meth)acrylate, t-butyl (meth)acrylate, isopentyl (meth)acrylate, and neopentyl (meth)acrylate. Ethyl (meth)acrylate, n-propyl (meth)acrylate, and n-butyl (meth)acrylate are preferred, and n-butyl (meth)acrylate is more preferred.

The “lower-carboxyalkyl” in the lower-carboxyalkyl (meth)acrylate refers to a C1 to C5 carboxyalkyl; the “lower-carboxyalkyl” may be a C2 to C4 carboxyalkyl, preferably a C2 or C3 carboxyalkyl. Examples of lower-carboxyalkyl (meth)acrylates include 2-carboxyethyl (meth)acrylate, 2-carboxypropyl (meth)acrylate, 3-carboxypropyl (meth)acrylate, 4-carboxybutyl (meth)acrylate, and 5-carboxypentyl (meth)acrylate. 2-Carboxyethyl (meth)acrylate, 2-carboxypropyl (meth)acrylate, and 3-carboxypropyl (meth)acrylate are preferred, and 2-carboxyethyl (meth)acrylate is more preferred.

A combination of n-butyl (meth)acrylate and 2-carboxyethyl (meth)acrylate is even more preferred.

The percentage by mass of the lower-carboxyalkyl (meth)acrylate to the total amount of the lower-alkyl (meth)acrylate and the lower-carboxyalkyl (meth)acrylate may be 0.1% by mass or more and 2.0% by mass or less, preferably 0.2% by mass or more and 1.0% by mass or less, more preferably 0.4% by mass or more and 0.7% by mass or less.

The ratio between the styrene monomer and the (meth)acrylic monomer in the polymer (by mass, styrene monomer:(meth)acrylic monomer) may be from 20:80 to 80:20, preferably from 30:70 to 70:30, more preferably from 40:60 to 60:40.

As for the crosslinker used to crosslink the resin, examples include aromatic polyvinyl compounds, such as divinylbenzene and divinylnaphthalene; polyvinyl esters of aromatic polycarboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridinedicarboxylate; vinyl esters of unsaturated heterocyclic carboxylic acids, such as vinyl pyromucate, vinyl furancarboxylate, vinyl pyrrole-2-carboxylate, and vinyl thiophenecarboxylate; (meth)acrylates of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylates of branched or substituted polyhydric alcohols, such as neopentyl glycol dimethacrylate and 2-hydroxy-1,3-diacryloxypropane; polyethylene glycol di(meth)acrylates and polypropylene polyethylene glycol di(meth)acrylates; and polyvinyl esters of polycarboxylic acids, such as divinyl succinate, divinyl fumarate, vinyl maleate, divinyl maleate, divinyl diglycolate, vinyl itaconate, divinyl itaconate, divinyl acetonedicarboxylate, divinyl glutarate, divinyl 3,3′-thiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One crosslinker may be used alone, or two or more may be used in combination.

Of these, bifunctional alkyl acrylates having a C6 or longer alkylene chain may be preferred crosslinkers for the resin. In other words, the crosslinked resin particles may have a bifunctional alkyl acrylate as their structural unit, and the number of carbon atoms in the alkylene chain in the bifunctional alkyl acrylate may be six or more.

The use of crosslinked resin particles having, as their structural unit, a bifunctional alkyl acrylate in which the number of carbon atoms in the alkylene chain is six or more may help make more certain that the resulting toner will be a specific toner. When a specific toner is used, variations in gloss may be reduced by limiting the amount of deformation of the toner particles to a particular range even when the toner is fixed under high-pressure conditions. Too large a difference between the elasticity of crosslinked resin particles and that of the binder resin can reduce the effectiveness of the resin particles in limiting changes in loss tangent tan δ. The elasticity of the resin particles, therefore, may be controlled not to be too high. A high crosslink density (i.e., short crosslink-to-crosslink distances) will result in too high elasticity of the resin particles, but when the crosslinker is a bifunctional acrylate having a long alkylene chain, the crosslink density may be low (or the crosslink-to-crosslink distances may be long), and this may help prevent the resin particles from being too elastic. As a result, variations in gloss may be further reduced.

The number of carbon atoms in the alkylene chain in the bifunctional alkyl acrylate may be six or more, preferably six or more and twelve or fewer, more preferably eight or more and twelve or fewer so that the crosslink density will fall within a certain range. More specific examples of bifunctional alkyl acrylates include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate, and it is preferred that the bifunctional alkyl acrylate be 1,10-decanediol diacrylate and/or 1,10-decanediol dimethacrylate.

If the resin particles are a product of polymerization of a composition containing a styrene monomer, a (meth)acrylic monomer, and a crosslinker, the viscoelasticity of the resin particles can be controlled by adjusting the crosslinker content of the composition. Increasing the crosslinker content of the composition tends to increase the storage modulus G′ of the resin particles. The crosslinker content may be 0.3 parts by mass or more and 5.0 parts by mass or less, preferably 0.5 parts by mass or more and 2.5 parts by mass or less, more preferably 1.0 part by mass or more and 2.0 parts by mass or less in a total of 100 parts by mass of the styrene monomer, (meth)acrylic monomer, and crosslinker.

The percentage of the resin particles in the toner particles as a whole may be 2% by mass or more and 30% by mass or less, preferably 5% by mass or more and 25% by mass or less, more preferably 8% by mass or more and 20% by mass or less for fog control reasons.

The percentage of crosslinked vinyl resin particles in the toner particles as a whole may be 2% by mass or more and 30% by mass or less, preferably 5% by mass or more and 25% by mass or less, more preferably 8% by mass or more and 20% by mass or less for fog control reasons.

The percentage of styrene-(meth)acrylic resin particles in the toner particles as a whole may be 2% by mass or more and 30% by mass or less, preferably 5% by mass or more and 25% by mass or less, more preferably 8% by mass or more and 20% by mass or less for fog control reasons.

The percentage of crosslinked styrene-(meth)acrylic resin particles in the toner particles as a whole may be 2% by mass or more and 30% by mass or less, preferably 5% by mass or more and 25% by mass or less, more preferably 8% by mass or more and 20% by mass or less for fog control reasons.

Assuming that the amount of the resin particles is 1, the relative amount of crystalline resins to the resin particles may be 0.2 or greater and 10 or less, preferably 1 or greater and 5 or less. A ratio of the amount of crystalline resins to that of the resin particles in these ranges may improve fixation compared with when the ratio is less than 0.2; toners deficient in ingredients that exhibit low viscosity at 90° C. or above and 150° C. or below and rich in highly elastic resin particles would be lacking in fusibility, but when the crystalline resin-to-resin particles ratio is in the above ranges, such a loss of fusibility may be limited.

A ratio of the amount of crystalline resins to that of the resin particles in these ranges, furthermore, may reduce variations in gloss associated with fixing conditions compared with when the ratio exceeds 10; toners excessively rich in low-viscosity ingredients would greatly deform when heated and pressurized by a fuser, but when the crystalline resin-to-resin particles ratio is in the above ranges, such a great deformation may be less likely.

The relative amount of crystalline resins to crosslinked vinyl resin particles may be 0.2 or greater and 10 or less, preferably 1 or greater and 5 or less, assuming that the amount of the crosslinked vinyl resin particles is 1.

A ratio of the amount of crystalline resins to that of crosslinked vinyl resin particles in these ranges may improve fixation compared with when the ratio is less than 0.2; toners deficient in ingredients that exhibit low viscosity at 90° C. or above and 150° C. or below and rich in highly elastic resin particles would be lacking in fusibility, but when the crystalline resin-to-resin particles ratio is in the above ranges, such a loss of fusibility may be limited.

A ratio of the amount of crystalline resins to that of crosslinked vinyl resin particles in these ranges, furthermore, may reduce variations in gloss associated with fixing conditions compared with when the ratio exceeds 10; toners excessively rich in low-viscosity ingredients would greatly deform when heated and pressurized by a fuser, but when the crystalline resin-to-resin particles ratio is in the above ranges, such a great deformation may be less likely.

The relative amount of crystalline resins to styrene-(meth)acrylic resin particles may be 0.2 or greater and 10 or less, preferably 1 or greater and 5 or less, assuming that the amount of the styrene-(meth)acrylic resin particles is 1. A ratio of the amount of crystalline resins to that of styrene-(meth)acrylic resin particles in these ranges may improve fixation compared with when the ratio is less than 0.2; toners deficient in ingredients that exhibit low viscosity at 90° C. or above and 150° C. or below and rich in highly elastic resin particles would be lacking in fusibility, but when the crystalline resin-to-resin particles ratio is in the above ranges, such a loss of fusibility may be limited. A ratio of the amount of crystalline resins to that of styrene-(meth)acrylic resin particles in these ranges, furthermore, may reduce variations in gloss associated with fixing conditions compared with when the ratio exceeds 10; toners excessively rich in low-viscosity ingredients would greatly deform when heated and pressurized by a fuser, but when the crystalline resin-to-resin particles ratio is in the above ranges, such a great deformation may be less likely.

The relative amount of crystalline resins to crosslinked styrene-(meth)acrylic resin particles may be 0.2 or greater and 10 or less, preferably 1 or greater and 5 or less, assuming that the amount of the crosslinked styrene-(meth)acrylic resin particles is 1. A ratio of the amount of crystalline resins to that of crosslinked styrene-(meth)acrylic resin particles in these ranges may improve fixation compared with when the ratio is less than 0.2; toners deficient in ingredients that exhibit low viscosity at 90° C. or above and 150° C. or below and rich in highly elastic resin particles would be lacking in fusibility, but when the crystalline resin-to-resin particles ratio is in the above ranges, such a loss of fusibility may be limited.

A ratio of the amount of crystalline resins to that of crosslinked styrene-(meth)acrylic resin particles in these ranges, furthermore, may reduce variations in gloss associated with fixing conditions compared with when the ratio exceeds 10; toners excessively rich in low-viscosity ingredients would greatly deform when heated and pressurized by a fuser, but when the crystalline resin-to-resin particles ratio is in the above ranges, such a great deformation may be less likely.

The ratio of the amount of amorphous resins to that of the resin particles may be 1.3 or greater and 45 or less, preferably 3 or greater and 15 or less, assuming that the amount of the resin particles is 1.

The resin particles may be resin particles having a storage modulus G′ at temperatures of 90° C. or above and 150° C. or below of 1×10⁴ Pa or more and 1×10⁶ Pa or less in a dynamic rheological measurement in which the temperature is raised at a rate of 2° C./min. Resin particles having this property are hereinafter referred to as “resin particles (S).”

The above storage modulus G′ of the resin particles (S), which is 1×10⁴ Pa or more and 1×10⁶ Pa or less, may be 1×10⁵ Pa or more and 8×10⁶ Pa or less, preferably 1×10⁵ Pa or more and 6×10⁶ Pa or less.

When the above storage modulus G′ of the resin particles (S) is in these ranges, the fog in the resulting image may be further reduced.

Using resin particles having a storage modulus G′ at temperatures of 90° C. or above and 150° C. or below in the above ranges may limit an excessive increase in the gloss of images fixed under high-temperature and high-pressure conditions compared with when the G′ of the resin particles is smaller. Variations in gloss under different conditions, therefore, may be reduced. The use of resin particles having a storage modulus G′ at temperatures of 90° C. or above and 150° C. or below in the above ranges, furthermore, may make more certain that good fixation will be achieved compared with when the G′ of the resin particles is higher; too high elasticity of the toner particles would affect fixation, but when the G′ of the resin particles is in the above ranges, such a loss of fixation may be limited.

The resin particles (S) may have a loss tangent tan δ at temperatures of 30° C. or above and 150° C. or below of 0.01 or greater and 2.5 or less in a dynamic rheological measurement in which the temperature is raised at a rate of 2° C./min. The resin particles (S) in that case may have a loss tangent tan δ at temperatures of 65° C. or above and 150° C. or below of 0.01 or greater and 1.0 or less, preferably 0.01 or greater and 0.5 or less.

A loss tangent tan δ of the resin particles (S) at temperatures of 30° C. or above and 150° C. or below in the above ranges may (1) make the external additive less likely to sink into the toner particles, (2) allow the toner to combine storage stability with good fixation, and (3) reduce variations in the gloss of the fixed image associated with fixing conditions (differences in temperature and pressure).

A loss tangent tan δ of the resin particles (S) at temperatures of 65° C. or above and 150° C. or below, at which the toner particles are highly deformable, in the above ranges may (1) make the external additive less likely to sink into the toner particles, (2) allow the toner to combine storage stability with good fixation, and (3) reduce variations in the gloss of the fixed image associated with fixing conditions (different temperatures and pressures).

The glass transition temperature Tg of the resin particles, determined by dynamic rheometry, may be 10° C. or above and 45° C. or below. When the glass transition temperature Tg of the resin particles is 10° C. or above and 45° C. or below, the fixation of the toner may be better, and differences in gloss may be smaller between images fixed under low-temperature and low-pressure conditions and those fixed under high-temperature and high-pressure conditions.

The glass transition temperature Tg of the resin particles may be 15° C. or above and 40° C. or below, preferably 20° C. or above and 35° C. or below.

When the glass transition temperature Tg of the resin particles is in these ranges, variations in gloss may be small compared with when the Tg is too low; a great difference between the Tg of the resin particles and that of the binder resin would cause the resin particles to gather and become unevenly distributed inside the toner particles, but when the Tg of the resin particles is in the above ranges, such an uneven distribution of the resin particles may be limited, and the resulting nearly uniform dispersion of the resin particles may make more certain that the resin particles will effectively limit the deformation of the toner particles caused by the pressure applied during fixation. When the glass transition temperature Tg of the resin particles is in these ranges, furthermore, the loss of fixation at low temperatures caused by lowered fusibility of the binder resin may be limited compared with when the Tg is too high.

The storage modulus G′, loss tangent tan δ, and glass transition temperature Tg of the resin particles (S) are determined by the following measurement method.

A sample for measurement is prepared by shaping the resin particles (S) into a disk 2 mm thick and 8 mm in diameter by pressing them. An example of how to isolate the resin particles (S) from the toner particles is to immerse the toner particles in a solvent that dissolves the binder resin but not the resin particles (S), and then collect the resin particles (S).

The sample for measurement is sandwiched between parallel plates 8 mm in diameter, and the resulting test cell is subjected to dynamic rheometry using a rheometer (ARES-G2, TA Instruments) with a gap of 3 mm, a frequency of 1 Hz, strains from 0.1% to 100%, and temperature rises from 10° C. to 150° C. at a rate of 2° C./min. On the storage and loss modulus curves obtained through measurement, the storage modulus G′ and the loss tangent tan δ are determined. The temperature at which the loss tangent tan δ peaks is reported as the glass transition temperature Tg.

The resin particles (S) may be crosslinked resin particles for the control of their storage modulus G′ at temperatures of 90° C. or above and 150° C. or below to the above ranges.

The percentage of the resin particles (S) in the toner particles as a whole may be 2% by mass or more and 30% by mass or less, preferably 5% by mass or more and 25% by mass or less, more preferably 8% by mass or more and 20% by mass or less.

When the percentage by mass of the resin particles (S) is in these ranges, compared with when lower or higher, (1) the external additive may be less likely to sink into the toner particles, (2) the toner may combine storage stability and good fixation, and (3) variations in the gloss of the fixed image associated with fixing conditions (different temperatures and pressures) may be reduced.

### Coloring Agent

Examples of coloring agents include pigments, such as carbon black, chrome yellow, Hansa yellow, benzidine yellow, threne yellow, quinoline yellow, pigment yellow, permanent orange GTR, pyrazolone orange, Vulcan orange, Watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, Calco oil blue, methylene blue chloride, phthalocyanine blue, pigment blue, phthalocyanine green, and malachite green oxalate; dyes, such as acridine, xanthene, azo, benzoquinone, azine, anthraquinone, thioindigo, dioxazine, thiazine, azomethine, indigo, phthalocyanine, aniline black, polymethine, triphenylmethane, diphenylmethane, and thiazole dyes; and inorganic pigments, such as silica.

The coloring agent does not need to be a substance that absorbs light in the visible spectrum. For example, the coloring agent may be a substance that absorbs light in the near-infrared spectrum or may be a fluorescent coloring agent.

Examples of coloring agents that absorb light in the near-infrared spectrum include aminium salt compounds, naphthalocyanine compounds, squarylium compounds, and croconium compounds.

Examples of fluorescent coloring agents include those mentioned in paragraph 0027 of Japanese Unexamined Patent Application Publication No. 2021-127431.

The coloring agent may be a glitter coloring agent. Examples of glitter coloring agents include metal powders, for example of aluminum, brass, bronze, nickel, stainless steel, and zinc; mica coated with titanium oxide or yellow iron oxide; coated flakes of inorganic crystal substrates, such as barium sulfate, sheet silicates, and silicates of sheet aluminum; single-crystal sheets of titanium oxide, basic carbonates, bismuth oxychloride, natural guanine, flake-shaped glass powders, and flake-shaped glass powders with deposited metal thereon.

One coloring agent may be used alone, or two or more may be used in combination.

Surface-treated coloring agents may optionally be used, and a combination of a coloring agent and a dispersant may also be used. It is also possible to use multiple coloring agents in combination.

The coloring agent content may be 1% by mass or more and 30% by mass or less, preferably 3% by mass or more and 15% by mass or less, of the toner particles as a whole.

In this exemplary embodiment, the toner particles may contain a coloring agent or may not. The toner according to this exemplary embodiment may be a toner in which the toner particles contain no coloring agent, or a so-called transparent toner.

Even if the toner particles contain no coloring agent in this exemplary embodiment, the toner according to this exemplary embodiment may offer the advantage of fog control.

### Release Agent

Examples of release agents include hydrocarbon waxes; natural waxes, such as carnauba wax, rice bran wax, and candelilla wax; synthesized or mineral/petroleum waxes, such as montan wax; and ester waxes, such as fatty acid esters and montanates. Other release agents may also be used.

The melting temperature of the release agent may be 50° C. or above and 110° C. or below, preferably 60° C. or above and 100° C. or below.

The melting temperature is determined from the DSC curve of the agent, which is obtained by differential scanning calorimetry (DSC), as the “peak melting temperature” described in the methods for determining melting temperatures set forth in JIS K7121-1987 “Testing Methods for Transition Temperatures of Plastics.”

The release agent content may be 1% by mass or more and 20% by mass or less, preferably 5% by mass or more and 15% by mass or less, of the toner particles as a whole.

### Other Additives

Examples of other additives include known additives, such as magnetic substances, charge control agents, and inorganic powders. Such additives are contained in the toner particles as internal additives.

### Structure, Composition, and Characteristics of the Toner Particles

The toner particles may be single-layer toner particles or may be so-called core-shell toner particles, i.e., toner particles formed by a core (core particle) and a coating layer that covers the core (shell layer).

If the toner particles have a core-shell structure, the resin particles may be contained in the core particle, the shell particle, or both of the core particle and the shell layer, but the resin particles may be contained in both the core particle and the shell layer, preferably in the state of being dispersed with high uniformity, for reduced sinking of the external additive into the toner particles.

Core-shell toner particles have, for example, a core particle containing the binder resin, the resin particles, a coloring agent, and a release agent and a shell layer containing the binder resin and the resin particles.

The volume-average diameter (D50v) of the toner particles may be 2 μm or more and 10 μm or less, preferably 4 μm or more and 8 μm or less.

The average diameter of the toner particles is measured using Coulter Multisizer II (Beckman Coulter) with ISOTON-II as the electrolyte (Beckman Coulter). A sample for measurement weighing 0.5 mg or more and 50 mg or less is put into 2 ml of a 5% by mass aqueous solution of a surfactant (e.g., a sodium alkylbenzene sulfonate), and the resulting mixture is added to 100 ml or more and 150 ml or less of the electrolyte. The electrolyte with the added sample therein is sonicated for 1 minute using a sonicator, and the diameter of particles is measured in the range from 2 μm to 60 μm using Coulter Multisizer II with an aperture size of 100 μm. The number of particles sampled is 50000. Based on the measured particle size distribution, the volume or number distribution is plotted from the smallest diameter, and the particle diameter at which the cumulative percentage is 50% is reported as the volume-average diameter D50v or number-average diameter D50p of the particles.

The average circularity of the toner particles may be 0.94 or greater and 1.00 or less, preferably 0.95 or greater and 0.98 or less.

The average circularity of the toner particles is the average of (equivalent circular circumference)/(circumference), or the average of [(the circumference of a circle having the same projected area as the particle)/(the circumference of the projected image of the particle)].

The instrument used to image the particles is a flow particle-image analyzer (Sysmex Corp. FPIA-3000). The number of toner particles sampled is 3500. If the toner contains an external additive, the toner is dispersed in water containing a surfactant, and the resulting dispersion is sonicated to give toner particles from which the external additive has been detached.

Difference Between the SP of the Resin Particles and that of the Binder Resin

The difference between the SP of the resin particles (SP (S) in this exemplary embodiment) and that of the binder resin (SP (R) in this exemplary embodiment) (SP (S)−SP (R)) may be −0.32 or greater and −0.12 or less, preferably −0.29 or greater and −0.18 or less.

The resin particles may be resin particles (S), and in that case the difference between SP (S), of the resin particles (S), and SP (R), of the binder resin (SP (S)−SP (R)) may be −0.32 or greater and −0.12 or less, preferably −0.29 or greater and −0.18 or less.

If the binder resin is a mixture of resins, the SP of the binder resin that is the most abundant by mass is SP (R).

When the difference (SP (S)−SP (R)) is in the above ranges, compared with when smaller, the compatibility between the binder resin and the resin particles, the two major constituents of the toner particles, may be kept adequate, and this may make more certain that the resin particles will be dispersed in the toner particles nearly uniformly. In that case the toner may tend to have similar viscoelasticity at high temperatures and high strains and at low temperatures and low strains; variations in gloss under different conditions, therefore, may be reduced. In other words, it may be unlikely, compared with when the difference (SP (S)−SP (R)) is smaller, that the resin particles move in the toner particles easily, and some of them aggregate to such an extent that they lose their effects, due to too high compatibility between the binder resin and the resin particles.

A difference (SP (S)−SP (R)) higher than the above ranges would lead to an increase in the overall melt viscosity of the toner because in that case the resin particles and the binder resin would excessively mix or fuse together when the toner melts, but when the difference in SP is in the above ranges, such an increase in the overall melt viscosity of the toner may be limited. This may ensure that good fixation will be achieved because in that case the loss of fixation caused by too high viscoelasticity may be reduced.

SP (S), of the resin particles, may be 9.00 or greater and 9.15 or less, preferably 9.03 or greater and 9.12 or less, more preferably 9.06 or greater and 9.10 or less.

SP (S) of resin particles (S) may be 9.00 or greater and 9.15 or less, preferably 9.03 or greater and 9.12 or less, more preferably 9.06 or greater and 9.10 or less.

SP (S) and SP (R) are solubility parameters in the unit of (cal/cm³)^{1/2} calculated according to Okitsu. The details of the method are described in “the Journal of the Adhesion Society of Japan, vol. 29, no. 5 (1993).”

### Rheology of Ingredients Excluding the Resin Particles (Remainder Component)

The ingredients in the toner particles excluding the resin particles are hereinafter referred to as “the remainder component,” and the temperature at which the storage modulus G′ falls below 1×10⁵ Pa is hereinafter referred to as “the specific elastic modulus temperature.”

The remainder component may have a storage elasticity G′ at temperatures of 30° C. or above and 50° C. or below of 1×10⁸ Pa or more in a dynamic rheological measurement in which the temperature is raised at a rate of 2° C./min, and the specific elastic modulus temperature in the same measurement may be 65° C. or above and 90° C. or below.

A remainder component meeting these may be highly elastic at low temperatures and have low elasticity at 65° C. or above and 90° C. or below. This may lead to good fixation because in that case the toner particles may quickly melt when heated.

The storage modulus G′ at 30° C. or above and 50° C. or below of the remainder component may be 1×10⁸ Pa or more, preferably 1×10⁸ Pa or more and 1×10⁹ Pa or less, more preferably 2×10⁸ Pa or more and 6×10⁸ Pa or less.

When the storage modulus G′ at 30° C. or above and 50° C. or below of the remainder component is in these ranges, compared with when smaller or larger, the toner may combine storage stability and good fixation, and variations in the gloss of the fixed image associated with fixing conditions (different temperatures and pressures) may be reduced.

The specific elastic modulus temperature of the remainder component may be 65° C. or above and 90° C. or below, preferably 68° C. or above and 80° C. or below, more preferably 70° C. or above and 75° C. or below.

When the specific elastic modulus temperature of the remainder component is in these ranges, compared with when lower or higher, the toner may combine storage stability and good fixation, and variations in the gloss of the fixed image associated with fixing conditions (difference in temperature and pressure) may be reduced.

The loss tangent tan δ of the remainder component at its specific elastic modulus temperature may be 0.8 or greater and 1.6 or less, preferably 0.9 or greater and 1.5 or less, more preferably 1.0 or greater and 1.4 or less.

When the loss tangent tan δ of the remainder component at its specific elastic modulus temperature is in these ranges, compared with when smaller or larger, the toner may combine storage stability and good fixation, and variations in the gloss of the fixed image associated with fixing conditions (difference in temperature and pressure) may be reduced.

The elastic modulus G′ and the loss tangent tan δ of the remainder component are determined by the following measurement method.

The remainder component is obtained by removing the resin particles from the toner particles. A sample for measurement is prepared by shaping the remainder component into a tablet using a press machine at room temperature (25° C.±3° C.). The sample for measurement is sandwiched between parallel plates 8 mm in diameter, and the resulting test cell is subjected to dynamic rheometry using a rheometer (ARES-G2, TA Instruments) with a gap of 3 mm, a frequency of 1 Hz, strains from 0.1% to 100%, and temperature rises from 30° C. to 150° C. at a rate of 2° C./min.

On the storage and loss modulus curves obtained through dynamic rheometry, the storage modulus G′ and the loss tangent tan δ are determined.

### Relationship Between the Resin Particles and the Remainder Component

In the following, the storage modulus G′ is that determined through a dynamic rheological measurement in which the temperature is raised at a rate of 2° C./min, and the method for its measurement is as described above.

G′(p90-150) may be 1×10⁴ Pa or more and 1×10⁶ Pa or less, and log G′(t90-150)−log G′(r90-150) may be 1.0 or greater and 4.0 or less at the same time, where G′(p90-150) is the storage modulus G′ of the resin particles at temperatures of 90° C. or above and 150° C. or below, G′(t90-150) is that of the toner particles, and G′(r90-150) is that of the ingredients in the toner particles excluding the resin particles.

log G′(t90-150)−log G′(r90-150), furthermore, may be 1.0 or greater and 3.5 or less, preferably 1.1 or greater and 3.4 or less, more preferably 1.2 or greater and 3.3 or less.

The value of log G′(t90-150)−log G′(r90-150) represents the difference in viscoelasticity between the toner particles with and without the resin particles. Ensuring nearly uniform dispersion and encapsulation of the resin particles in the toner particles may limit the impact of the viscoelasticity of the resin particles on the overall viscoelasticity of the toner particles, and controlling log G′(t90-150)−log G′(r90-150) to the above ranges may allow good fixation to be combined with reduced variations in gloss under different conditions compared with when log G′(t90-150)−log G′(r90-150) is smaller or larger.

The resin particles may be resin particles (S), and in that case Log G′(S)−Log G′(R) may be 1.0 or greater and 4.0 or less, where Log G′(S) is the common logarithm of the storage modulus G′ of the resin particles (S) at temperatures of 90° C. or above and 150° C. or below, and Log G′(R) is the common logarithm of the storage modulus G′ of the remainder component at temperatures of 90° C. or above and 150° C. or below.

Log G′(S)−Log G′(R) may be 1.0 or greater and 3.5 or less, preferably 1.1 or greater and 3.4 or less, more preferably 1.2 or greater and 3.3 or less.

A value of Log G′(S)−Log G′(R) in the above ranges may allow the toner to combine storage stability with good fixation and may reduce variations in the gloss of the fixed image associated with fixing conditions (difference in temperature and pressure) compared with when Log G′(S)−Log G′(R) is smaller or larger.

### Silica Particles (A)

The silica particles (A) contain a nitrogen-containing compound that contains the element molybdenum, and the ratio N_{Mo}/N_{Si} is 0.035 or greater and 0.45 or less, where N_{Mo} and N_{Si} are measured net intensities for the element molybdenum and the element silicon, respectively, in the silica particles (A) in x-ray fluorescence analysis.

“A nitrogen-containing compound that contains the element molybdenum” is hereinafter referred to “a molybdenum- and nitrogen-containing compound.”

The amount of the silica particles (A) as an external additive may be 0.1 parts by mass or more and 3.0 parts by mass or less, preferably 0.1 parts by mass or more and 2.0 parts by mass or less, more preferably 0.1 parts by mass or more and 1.0 part by mass or less per 100 parts by mass of the toner particles.

The silica particles (A) contain a molybdenum- and nitrogen-containing compound. A possible structure of the silica particles (A) will now be described.

A possible form of the silica particles (A) is silica particles including base silica particles, a coating on at least part of the surface of the base silica particles formed by a product of reaction of a silane coupling agent, and a molybdenum- and nitrogen-containing compound adhering to the coating structure formed by a reaction product. This possible form may further include a hydrophobized structure (structure produced by treating the silica particles with a hydrophobizing agent) adhering to the coating structure formed by a reaction product. The silane coupling agent may be at least one selected from the group consisting of monofunctional silane coupling agents, bifunctional silane coupling agents, and trifunctional silane coupling agents, preferably a trifunctional silane coupling agent.

### Base Silica Particles

The base silica particles may be dry silica or may be wet silica.

Examples of variations of dry silica include pyrogenic silica (fumed silica), produced by burning a silane compound; and VMC (vaporized metal combustion) silica, produced by burning a metal silicon powder explosively.

Examples of variations of wet silica include kinds of wet silica produced through neutralization between sodium silicate and a mineral acid (precipitated silica, synthesized and caused to aggregate under alkaline conditions, and silica gel particles, synthesized and caused to aggregate under acidic conditions); colloidal silica, produced by making an acidic silicic acid alkaline and polymerizing it; and sol-gel silica, produced through the hydrolysis of an organic silane compound (e.g., an alkoxysilane). The base silica particles may be sol-gel silica for charge distribution narrowing reasons.

### Product of Reaction of a Silane Coupling Agent

Products of reaction of silane coupling agents (those of trifunctional silane coupling agents in particular) have a porous structure and are compatible with molybdenum- and nitrogen-containing compounds. With such a reaction product, therefore, the amount of the molybdenum- and nitrogen-containing compound in the silica particles (A) may be relatively large as a result of the molybdenum- and nitrogen-containing compound penetrating deeply into the pores.

The surface of the base silica particles is negatively chargeable, and the adhesion of the positively chargeable molybdenum- and nitrogen-containing compound may work to cancel out excessive negative charge on the base silica particles. Since the molybdenum- and nitrogen-containing compound is adhering to the inside of the coating structure formed by a production of reaction of a silane coupling agent (i.e., a porous structure) rather than the outermost surface of the silica particles (A), it may be unlikely that the charge distribution in the silica particles broadens toward positive charge; rather, the compound may allow a narrower charge distribution in the silica particles (A) to be achieved by cancelling out excessive negative charge on the base silica particles.

The silane coupling agent may be a compound containing no N (element nitrogen). An example of a silane coupling agent is a silane coupling agent represented by formula (TA) below.

R¹ₙ−Si(OR²)₄₋ₙ (TA)

In formula (TA), R¹ is a C1 to C20 saturated or unsaturated aliphatic hydrocarbon or C6 to C20 aromatic hydrocarbon group, R² is a halogen atom or alkyl group, and n is 1, 2, or 3. If n is 2 or 3, the multiple R¹s may be groups of the same kind or may be different groups. If n is 1 or 2, the multiple R²s may be groups of the same kind or may be different groups.

Examples of products of reaction of a silane coupling agent include reaction products having, in formula (TA) for example, a OH substituent in place of all or a subset of the OR²s; reaction products having OH substituents in place of OR²s and in which all or a subset of the OH groups have been polycondensed together; and reaction products having OH substituents in place of OR²s and in which all or a subset of the OH substituents have been polycondensed with SiOH groups of the base silica particles.

An aliphatic hydrocarbon group represented by R¹ in formula (TA) may be linear, branched, or cyclic, preferably linear or branched. As for the number of carbon atoms, the aliphatic hydrocarbon group may be C1 to C20, preferably C1 to C18, more preferably C1 to C12, even more preferably C1 to C10. The aliphatic hydrocarbon group may be saturated or unsaturated, but preferably is a saturated aliphatic hydrocarbon group, more preferably an alkyl group. The hydrogen atoms in the aliphatic hydrocarbon group may have been replaced with a halogen atom.

Examples of saturated aliphatic hydrocarbon groups include linear alkyl groups (e.g., the methyl, ethyl, propyl, butyl, pentyl, hexyl, heptyl, octyl, nonyl, decyl, dodecyl, hexadecyl, and icosyl groups), branched alkyl groups (e.g., the isopropyl, isobutyl, isopentyl, neopentyl, 2-ethylhexyl, tertiary butyl, tertiary pentyl, and isopentadecyl groups), and cyclic alkyl groups (e.g., the cyclopropyl, cyclopentyl, cyclohexyl, cycloheptyl, cyclooctyl, tricyclodecyl, norbornyl, and adamantyl groups).

Examples of unsaturated aliphatic hydrocarbon groups include alkenyl groups (e.g., the vinyl (ethenyl), 1-propenyl, 2-propenyl, 2-butenyl, 1-butenyl, 1-hexenyl, 2-dodecenyl, and pentenyl groups) and alkynyl groups (e.g., the ethynyl, 1-propynyl, 2-propynyl, 1-butynyl, 3-hexynyl, and 2-dodecynyl groups).

An aromatic hydrocarbon group represented by R¹ in formula (TA) may be C6 to C20, preferably C6 to C18, more preferably C6 to C12, even more preferably C6 to C10. Examples of aromatic hydrocarbon groups include the phenylene, biphenylene, terphenylene, naphthalene, and anthracene groups. The hydrogen atoms in the aromatic hydrocarbon group may have been replaced with a halogen atom.

A halogen atom represented by R² in formula (TA) can be, for example, a fluorine, chlorine, bromine, or iodine atom, preferably is a chlorine, bromine, or iodine atom.

An alkyl group represented by R² in formula (TA) may be a C1 to C10 alkyl group, preferably a C1 to C8 alkyl group, more preferably a C1 to C4 alkyl group. Examples of C1 to C10 linear alkyl groups include the methyl, ethyl, n-propyl, n-butyl, n-pentyl, n-hexyl, n-heptyl, n-octyl, n-nonyl, and n-decyl groups. Examples of C3 to C10 branched alkyl groups include the isopropyl, isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, and tert-decyl groups. Examples of C3 to C10 cyclic alkyl groups include the cyclopropyl, cyclobutyl, cyclopentyl, cyclohexyl, cycloheptyl, cyclooctyl, cyclononyl, and cyclodecyl groups and polycyclic (e.g., bicyclic, tricyclic, and spirocyclic) alkyl groups formed by such monocyclic alkyl groups linked together. The hydrogen atoms in the alkyl group may have been replaced with a halogen atom.

n in formula (TA) is 1, 2, or 3, preferably 1 or 2, more preferably 1.

The silane coupling agent represented by formula (TA) may be a trifunctional silane coupling agent in which R¹ is a C1 to C20 saturated aliphatic hydrocarbon group, R 2 is a halogen atom or C1 to C10 alkyl group, and n is 1.

Examples of trifunctional silane coupling agents include vinyltrimethoxysilane, vinyltriethoxysilane, methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane, decyltrichlorosilane, and phenyltrichlorosilane (compounds of formula (TA) in which R¹ is an unsubstituted aliphatic or unsubstituted aromatic hydrocarbon group); and 3-glycidoxypropyltrimethoxysilane, γ-methacryloxypropyltrimethoxysilane, γ-mercaptopropyltrimethoxysilane, γ-chloropropyltrimethoxysilane, and γ-glycidyloxypropylmethyldimethoxysilane (compounds of formula (TA) in which R¹ is a substituted aliphatic or substituted aromatic hydrocarbon group). One trifunctional silane coupling agent may be used alone, or two or more may be used in combination.

The trifunctional silane coupling agent may be an alkyltrialkoxysilane, preferably an alkyltrialkoxysilane of formula (TA) in which R¹ is a C1 to C20 (preferably C1 to C15, more preferably C1 to C8, even more preferably C1 to C4, in particular C 1 or C2) alkyl group, and R² is a C1 or C2 alkyl group.

More specifically, the silane coupling agent forming the coating structure on the surface of the base silica particles may be at least one trifunctional silane coupling agent selected from the group consisting of alkyltrimethoxysilanes and alkyltriethoxysilanes having a C1 to C20 alkyl group;
preferably at least one trifunctional silane coupling agent selected from the group consisting of alkyltrimethoxysilanes and alkyltriethoxysilanes having a C1 to C15 alkyl group;
more preferably at least one trifunctional silane coupling agent selected from the group consisting of alkyltrimethoxysilanes and alkyltriethoxysilanes having a C1 to C8 alkyl group;
even more preferably at least one trifunctional silane coupling agent selected from the group consisting of alkyltrimethoxysilanes and alkyltriethoxysilanes having a C1 to C4 alkyl group;
in particular at least one trifunctional silane coupling agent selected from the group consisting of methyltrimethoxysilane, ethyltrimethoxysilane, methyltriethoxysilane, and ethyltriethoxysilane.

The amount of the coating structure formed by a product of reaction of a silane coupling agent may be 5.5% by mass or more and 30% by mass or less, preferably 7% by mass or more and 22% by mass or less, of the silica particles (A) as a whole.

### Molybdenum- and Nitrogen-Containing Compound

The molybdenum- and nitrogen-containing compound is a nitrogen-containing compound that also contains the element molybdenum and is neither ammonia nor a compound that is gas at temperatures of 25° C. or below.

The molybdenum- and nitrogen-containing compound may be adhering to the inside of the coating structure formed by a product of reaction of a silane coupling agent (i.e., the inside of pores in a porous structure). One molybdenum- and nitrogen-containing compound or two or more may be used.

For charge distribution narrowing and charge distribution maintenance reasons, the molybdenum- and nitrogen-containing compound may be at least one selected from the group consisting of quaternary ammonium salts containing the element molybdenum (quaternary ammonium molybdates in particular) and mixtures of a quaternary ammonium salt and a metal oxide containing the element molybdenum. Quaternary ammonium salts containing the element molybdenum may be highly effective in maintaining charge distribution by virtue of the strong bond between the molybdenum-containing anion and the quaternary ammonium cation.

The molybdenum- and nitrogen-containing compound may be a compound represented by formula (1) below.

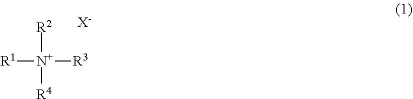

In formula (1), R¹, R², R³, and R⁴ each independently represent a hydrogen atom, alkyl group, aralkyl group, or aryl group, and X⁻ represents a negative ion containing the element molybdenum. At least one of R¹, R², R³, or R⁴, however, represents an alkyl, aralkyl, or aryl group. Two or more of R¹, R², R³, and R⁴ may be linked together to form an aliphatic ring, aromatic ring, or heterocycle. Alkyl, aralkyl, and aryl groups may have a substituent.

An alkyl group represented by R¹ to R⁴ can be, for example, a C1 to C20 linear or C3 to C20 branched alkyl group. Examples of C1 to C20 linear alkyl groups include the methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, and n-hexadecyl groups. Examples of C3 to C20 branched alkyl groups include the isopropyl, isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, and tert-decyl groups.

An alkyl group represented by R¹ to R⁴ may be a C1 to C15 alkyl group, such as a methyl, ethyl, butyl, or tetradecyl group.

An aralkyl group represented by R¹ to R⁴ can be, for example, a C7 to C30 aralkyl group. Examples of C7 to C30 aralkyl groups include the benzyl, phenylethyl, phenylpropyl, 4-phenylbutyl, phenylpentyl, phenylhexyl, phenylheptyl, phenyloctyl, phenylnonyl, naphthylmethyl, naphthylethyl, anthrylmethyl, and phenyl-cyclopentylmethyl groups.

An aralkyl group represented by R¹ to R⁴ may be a C7 to C15 aralkyl group, such as a benzyl, phenylethyl, phenylpropyl, or 4-phenylbutyl group.

An aryl group represented by R¹ to R⁴ can be, for example, a C6 to C20 aryl group. Examples of C6 to C20 aryl groups include the phenyl, pyridyl, and naphthyl groups.

An aryl group represented by R¹ to R⁴ may be a C6 to C10 aryl group, such as a phenyl group.

A ring formed by two or more of R¹, R², R³, and R⁴ linked together can be, for example, a C2 to C20 alicyclic ring or C2 to C20 heterocyclic amine.

R¹, R², R³, and R⁴ may each independently have a substituent. Examples of substituents include a nitrile group, a carbonyl group, an ether group, an amide group, a siloxane group, a silyl group, and a silane-alkoxy group.

R¹, R², R³, and R⁴ may each independently represent a C1 to C16 alkyl group, C7 to C10 aralkyl group, or C6 to C20 aryl group.

The negative ion containing the element molybdenum, represented by X⁻, may be a molybdate ion, preferably a molybdate ion with tetravalent or hexavalent molybdenum, more preferably a molybdate ion with hexavalent molybdenum. Specific examples of molybdate ions include MoO₄²⁻, Mo₂O₇²⁻, Mo₃O₁₀²⁻, Mo₄O₁₃²⁻, Mo₇O₂₄²⁻, and Mo₈O₂₆⁴⁻.

The compound represented by formula (1) may have a total of 18 to 35 carbon atoms, preferably 20 to 32, for charge distribution narrowing and charge distribution maintenance reasons.

Examples of compounds represented by formula (1) are presented below. This exemplary embodiment is not limited to these.

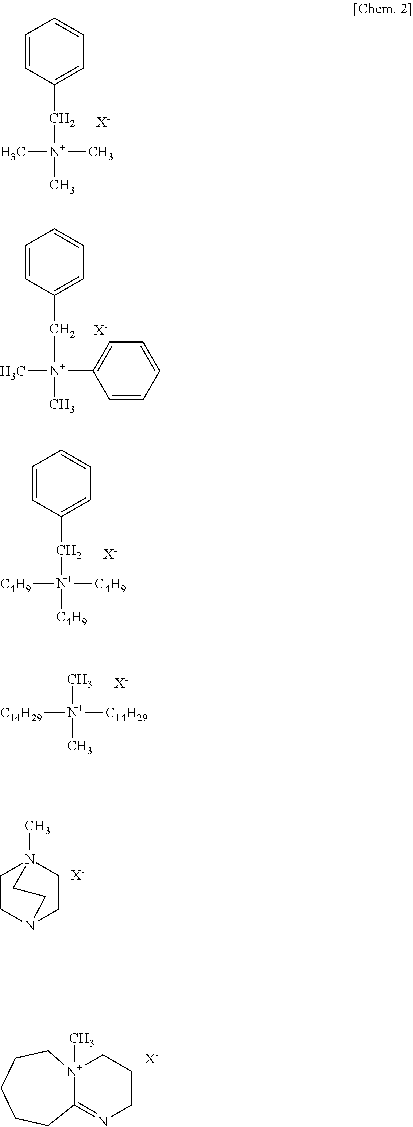

Examples of quaternary ammonium salts containing the element molybdenum include quaternary ammonium molybdates, such as [N⁺(CH)₃(C₁₄C₂₉)₂]₄Mo₈O₂₈⁴⁻, [N⁺(C₄H₉)₂(C₆H₆)₂]₂Mo₂O₇²⁻, [N⁺(CH₃)₂(CH₂C₆H₆)(CH₂)₁₇CH₃]₂MoO₄²⁻, and [N⁺(CH₃)₂(CH₂C₆H₆)(CH₂)₁₅CH₃]₂MoO₄²⁻.

Examples of metal oxides containing the element molybdenum include molybdenum oxides (molybdenum trioxide, molybdenum dioxide, and Mo₉O₂₆), alkali metal molybdates (e.g., lithium molybdate, sodium molybdate, and potassium molybdate), alkaline earth metal molybdates (e.g., magnesium molybdate and calcium molybdate), and complex oxides (e.g., Bi₂O₃·2MoO₃ and γ-Ce₂Mo₃O₁₃)

The silica particles (A) are found to contain a molybdenum- and nitrogen-containing compound when heated in a temperature zone within the range of 300° C. to 600° C. The molybdenum- and nitrogen-containing compound can be detected by heating at 300° C. or above and 600° C. or below in an inert gas; for example, it is detected using a heating-furnace free-fall pyrolysis gas chromatograph-mass spectrometer with He as a carrier gas. Specifically, 0.1 mg or more and 10 mg or less of the silica particles are introduced into the pyrolysis gas chromatograph-mass spectrometer, and the mass spectra for the detected peaks are examined to verify whether a molybdenum- and nitrogen-containing compound is contained. Examples of products of pyrolysis of silica particles containing a molybdenum- and nitrogen-containing compound include primary, secondary, and tertiary amines represented by formula (2) below and aromatic nitrogen compounds. R¹, R², and R³ in formula (2) are synonymous with R¹, R², and R³, respectively, in formula (1). If the molybdenum- and nitrogen-containing compound is a quaternary ammonium salt, pyrolysis at 600° C. eliminates part of its chains, and a tertiary amine is detected.

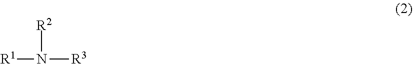

### Molybdenum-Free Nitrogen-Containing Compound

The silica particles (A) may contain a molybdenum-free nitrogen-containing compound (nitrogen-containing compound containing no element molybdenum) inside pores in the product of reaction of a silane coupling agent, with the compound adhering to the pores. The molybdenum-free nitrogen-containing compound can be, for example, at least one selected from the group consisting of quaternary ammonium salts, primary amine compounds, secondary amine compound, tertiary amine compounds, amide compounds, imine compounds, and nitrile compounds. Preferably, the molybdenum-free nitrogen-containing compound is a quaternary ammonium salt.

Specific examples of primary amine compounds include phenethylamine, toluidine, catecholamine, and 2,4,6-trimethylaniline.

Specific examples of secondary amine compounds include dibenzylamine, 2-nitrodiphenylamine, and 4-(2-octylamino)diphenylamine.

Specific examples of tertiary amine compounds include 1,8-bis(dimethylamino)naphthalene, N,N-dibenzyl-2-aminoethanol, and N-benzyl-N-methylethanolamine.

Specific examples of amide compounds include N-cyclohexyl-p-toluenesulfonamide, 4-acetamido-1-benzylpiperidine, and N-hydroxy-3-[1-(phenylthio)methyl-1H-1,2,3-triazol-4-yl]benzamide.

Specific examples of imine compounds include diphenylmethaneimine, 2,3-bis(2,6-diisopropylphenylimino)butane, and N,N′-(ethane-1,2-diylidene)bis(2,4,6-trimethylaniline).

Specific examples of nitrile compounds include 3-indoleacetonitrile, 4-[(4-chloro-2-pyrimidinyl)amino]benzonitrile, and 4-bromo-2,2-diphenylbutyronitrile.

An example of a quaternary ammonium salt is a compound represented by formula (AM) below. One compound represented by formula (AM) or two or more may be used.

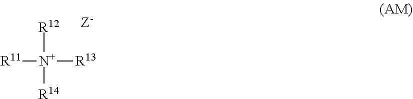

In formula (AM), R¹¹, R¹², R¹³, and R¹⁴ each independently represent a hydrogen atom, alkyl group, aralkyl group, or aryl group, and Z⁻ represents a negative ion. At least one of R¹¹, R¹², R¹³, or R¹⁴, however, represents an alkyl, aralkyl, or aryl group. Two or more of R¹¹, R¹², R¹³, and R¹⁴ may be linked together to form an aliphatic ring, aromatic ring, or heterocycle. Alkyl, aralkyl, and aryl groups may have a substituent.

An alkyl group represented by R¹¹ to R¹⁴ can be, for example, a C1 to C20 linear or C3 to C20 branched alkyl group. Examples of C1 to C20 linear alkyl groups include the methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, and n-hexadecyl groups. Examples of C3 to C20 branched alkyl groups include the isopropyl, isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, and tert-decyl groups.

An alkyl group represented by R¹¹ to R¹⁴ may be a C1 to C15 alkyl group, such as a methyl, ethyl, butyl, or tetradecyl group.

An aralkyl group represented by R¹¹ to R¹⁴ can be, for example, a C7 to C30 aralkyl group. Examples of C7 to C30 aralkyl groups include the benzyl, phenylethyl, phenylpropyl, 4-phenylbutyl, phenylpentyl, phenylhexyl, phenylheptyl, phenyloctyl, phenylnonyl, naphthylmethyl, naphthylethyl, anthrylmethyl, and phenyl-cyclopentylmethyl groups.

An aralkyl group represented by R¹¹ to R¹⁴ may be a C7 to C15 aralkyl group, such as a benzyl, phenylethyl, phenylpropyl, or 4-phenylbutyl group.

An aryl group represented by R¹¹ to R¹⁴ can be, for example, a C6 to C20 aryl group. Examples of C6 to C20 aryl groups include the phenyl, pyridyl, and naphthyl groups.

An aryl group represented by R¹¹ to R¹⁴ may be a C6 to C10 aryl group, such as a phenyl group.

A ring formed by two or more of R¹¹, R¹², R¹³, and R¹⁴ linked together can be, for example, a C2 to C20 alicyclic ring or C2 to C20 heterocyclic amine.

R¹¹, R¹², R¹³, and R¹⁴ may each independently have a substituent. Examples of substituents include a nitrile group, a carbonyl group, an ether group, an amide group, a siloxane group, a silyl group, and a silane-alkoxy group.

R¹¹, R¹², R¹³, and R¹⁴ may each independently represent a C1 to C16 alkyl group, C7 to C10 aralkyl group, or C6 to C20 aryl group.

The negative ion, represented by Z⁻, may be an organic or inorganic negative ion.

Examples of organic negative ions include polyfluoroalkylsulfonate ions, polyfluoroalkylcarboxylate ions, the tetraphenylborate ion, aromatic carboxylate ions, and aromatic sulfonate ions (e.g., the 1-naphthol-4-sulfonate ion).

Examples of inorganic negative ions include OH⁻, F⁻, Fe(CN)₆³⁻, Cl⁻, Br⁻, NO₂⁻, NO₃⁻, CO₃²⁻, PO₄³⁻, and SO₄²⁻.

The compound represented by formula (AM) may have a total of 18 to 35 carbon atoms, preferably 20 to 32, for charge distribution narrowing and charge distribution maintenance reasons.

Examples of compounds represented by formula (AM) are presented below. This exemplary embodiment is not limited to these.

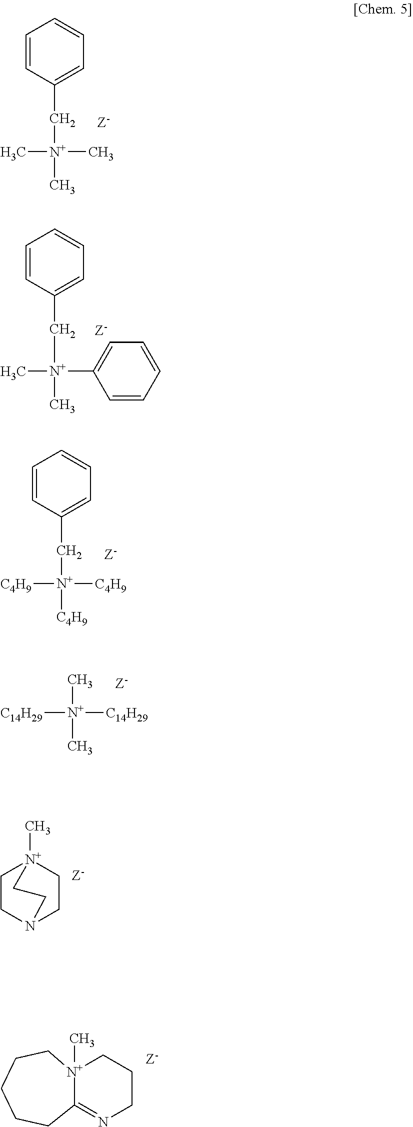

For charge distribution narrowing and charge distribution maintenance reasons, the total amount of molybdenum-containing and molybdenum-free nitrogen-containing compounds in the silica particles (A) may be 0.005 or more and 0.50 or less, preferably 0.008 or more and 0.45 or less, more preferably 0.015 or more and 0.20 or less, even more preferably 0.018 or more and 0.10 or less as a ratio by mass of the element nitrogen to the element silicon, N/Si.

This ratio by mass N/Si in the silica particles (A) is determined by analyzing a sample of the particles using an oxygen/nitrogen analyzer (e.g., HORIBA EMGA-920) with an integration time of 45 seconds and calculating the proportion of the mass of N atoms to that of Si atoms (N/Si). Prior to the analysis, ammonia and other impurities are removed from the sample by vacuum drying at 100° C. for 24 hours or longer.

The total amount X of molybdenum-containing and molybdenum-free nitrogen-containing compounds extracted from the silica particles (A) into an ammonia/methanol mixture may be 0.1% by mass or more in 100% by mass of the silica particles. It is possible that Y/X<0.3 at the same time, where X is the total amount of molybdenum-containing and molybdenum-free nitrogen-containing compounds extracted from the silica particles (A) into an ammonia/methanol mixture, and Y is the total amount of molybdenum-containing and molybdenum-free nitrogen-containing compounds extracted from the silica particles (A) into water (% by mass in 100% by mass of the silica particles, as with X).

This relation indicates that the nitrogen-containing compound in the silica particles (A) is sparingly soluble in water, or does not adsorb much water in the air. When this relation holds, therefore, the silica particles (A) may be superior in the narrowness and maintenance of charge distribution.

Amount X may be 0.25% by mass or more in 100% by mass of the silica particles. As for the upper limit, amount X is 6.5% by mass or less for example. The ratio Y/X between amounts X and Y may be 0.

Amounts X and Y are measured by the following method.

The silica particles are analyzed on a thermogravimetric analyzer-mass spectrometer (e.g., NETZSCH Japan K.K.'s gas chromatograph-mass spectrometer) at 400° C., and the percentage by mass of compounds containing a C1 or longer hydrocarbon and a nitrogen atom covalently bound thereto is measured and integrated (W1).

One part by mass of the silica particles is added to 30 parts by mass of an ammonia/methanol solution (Sigma-Aldrich; ammonia/methanol ratio by mass=1/5.2) having a temperature of 25° C., the resulting mixture is sonicated for 30 minutes, and then the silica powder is isolated from the extractant. The isolated silica particles are dried in a vacuum dryer at 100° C. for 24 hours, and the percentage by mass of compounds containing a C1 or longer hydrocarbon and a nitrogen atom covalently bound thereto is measured on the thermogravimetric analyzer-mass spectrometer at 400° C. and integrated (W2).

One part by mass of the silica particles is added to 30 parts by mass of water having a temperature of 25° C., the resulting mixture is sonicated for 30 minutes, and then the silica particles are isolated from the extractant. The isolated silica particles are dried in a vacuum dryer at 100° C. for 24 hours, and the percentage by mass of compounds containing a C1 or longer hydrocarbon and a nitrogen atom covalently bound thereto is measured on the thermogravimetric analyzer-mass spectrometer at 400° C. and integrated (W3).

From W1 and W2, amount X, =W1−W2, is calculated.

From W1 and W3, amount Y, =W1−W3, is calculated.

### Hydrophobized Structure

The silica particles (A) may have a hydrophobized structure (structure produced by treating the silica particles with a hydrophobizing agent) adhering to the coating structure formed by a product of reaction of a silane coupling agent.

The hydrophobizing agent is, for example, an organosilicon compound. Examples of organosilicon compounds include the following.

Alkoxysilane or halosilane compounds having a lower alkyl group, such as methyltrimethoxysilane, dimethyldimethoxysilane, trimethylchlorosilane, and trimethylmethoxysilane.

Alkoxysilane compounds having a vinyl group, such as vinyltrimethoxysilane and vinyltriethoxysilane.

Alkoxysilane compounds having an epoxy group, such as 2-(3,4-epoxycyclohexyl)ethyltrimethoxysilane, 3-glycidoxypropylmethyldimethoxysilane, 3-glycidoxypropyltrimethoxy silane, 3-glycidoxypropylmethyldiethoxysilane, and 3-glycidoxypropyltriethoxysilane.

Alkoxysilane compounds having a styryl group, such as p-styryltrimethoxysilane and p-styryltriethoxysilane.

Alkoxysilane compounds having an aminoalkyl group, such as N-2-(aminoethyl)-3-aminopropylmethyldimethoxysilane, N-2-(aminoethyl)-3-aminopropyltrimethoxysilane, 3-aminopropyltrimethoxy silane, 3-aminopropyltriethoxy silane, 3-triethoxy silyl-N-(1,3-dimethyl-butylidene)propylamine, and N-phenyl-3-aminopropyltrimethoxysilane.

Alkoxysilane compounds having an isocyanatoalkyl group, such as 3-isocyanatopropyltrimethoxysilane and 3-isocyanatopropyltriethoxysilane.

Silazane compounds, such as hexamethyldisilazane and tetramethyldisilazane.

The silica particles (A) may have characteristics as described below for charge distribution narrowing and charge distribution maintenance reasons.

### Average Circularity and Geometric Standard Deviation by Number

The average circularity of the silica particles (A) may be 0.60 or greater and 0.96 or less, preferably 0.65 or greater and 0.94 or less, more preferably 0.70 or greater and 0.92 or less, even more preferably 0.75 or greater and 0.90 or less.

The silica particles (A) may be monodisperse in terms of circularity, with their primary particles having a circularity distribution with one peak at a circularity greater than 0.88.

The geometric standard deviation by number of the silica particles (A) may be 1.1 or greater and 2.0 or less, preferably 1.15 or greater and 1.6 or less.

### Degree of Hydrophobization

The degree of hydrophobization of the silica particles (A) may be 10% or more and 60% or less, preferably 20% or more and 55% or less, more preferably 28% or more and 53% or less.

The method for measuring the degree of hydrophobization of the silica particles is as follows.

A 0.2% by mass sample of the silica particles is put into 50 ml of deionized water, methanol is added dropwise from a burette with stirring on a magnetic stirrer, and the percentage by mass of methanol in the methanol-water mixture at the endpoint, i.e., at complete precipitation of the sample, is determined as the degree of hydrophobization.

### Volume Resistivity

The volume resistivity R of the silica particles (A) may be 1.0×10⁷ Ω·cm or more and 1.0×10^{12.5} Ω·cm or less, preferably 1.0×10^{7.5} Ω·cm or more and 1.0×10¹² Ω·cm or less, more preferably 1.0×10⁸ Ω·cm or more and 1.0×10^{11.5} Ω·cm or less, even more preferably 1.0×10⁹ Ω·cm or more and 1.0×10¹¹ Ω·cm or less. The volume resistivity R of the silica particles (A) can be adjusted by changing the amount of the molybdenum- and nitrogen-containing compound.

The ratio Ra/Rb, where Ra and Rb are the volume resistivity of the silica particles (A) before and after firing at 350° C., respectively, may be 0.01 or greater and 0.8 or less, preferably 0.015 or greater and 0.6 or less.

The volume resistivity Ra of the silica particles (A) before firing at 350° C. (synonymous with the above volume resistivity R) may be 1.0×10⁷ Ω·cm or more and 1.0×10^{12.5} Ω·cm or less, preferably 1.0×10^{7.5} Ω·cm or more and 1.0×10¹² Ω·cm or less, more preferably 1.0×10⁸ Ω·cm or more and 1.0×10^{11.5} Ω·cm or less, even more preferably 1.0×10⁹ Ω·cm or more and 1.0×10¹¹ Ω·cm or less.

The firing at 350° C. is to heat the particles to 350° C. at a rate of 10° C./min, hold at 350° C. for 3 hours, and cool to room temperature (25° C.) at a rate of 10° C./min, all in a nitrogen environment.

The volume resistivity of the silica particles (A) is measured in an environment at a temperature of 20° C. and a relative humidity of 50% as follows.

The silica particles (A) are placed on the surface of a round test piece fitted with a 20-cm² plate electrode, approximately to a thickness of 1 mm or more and 3 mm or less, to form a layer of silica particles. A 20-cm² plate electrode is placed on the layer of silica particles to sandwich the layer with the other electrode, and the upper electrode is pressed down with a pressure of 0.4 MPa to eliminate spaces between silica particles. The thickness L (cm) of the layer of silica particles is measured. A Nyquist plot in the frequency range from 10⁻³ Hz to 10⁶ Hz is obtained using an impedance analyzer (Solartron Analytical) connected to the two electrodes above and below the layer of silica particles. The bulk resistance R (Ω) is determined by fitting the data to an equivalent circuit assuming the presence of the three components of resistance: bulk resistance, particle-to-particle interfacial resistance, and electrode contact resistance. From the bulk resistance R (Ω) and the thickness L (cm) of the layer of silica particles, the volume resistivity ρ (Ω·cm) of the silica particles is determined according to the equation ρ=R/L.

### OH Group Content

The OH group content of the silica particles (A) may be 0.05 groups/nm² or more and 6 groups/nm² or less, preferably 0.1 groups/nm² or more and 5.5 groups/nm² or less, more preferably 0.15 groups/nm² or more and 5 groups/nm² or less, even more preferably 0.2 groups/nm² or more and 4 groups/nm² or less, still more preferably 0.2 groups/nm² or more and 3 groups/nm² or less.

The OH group content of the silica particles is measured by the Sears method as follows.

A 1.5-g sample of the silica particles is added to a mixture of 50 g of water and 50 g of ethanol, and the resulting mixture is stirred using an ultrasonic homogenizer for 2 minutes to give a liquid dispersion. In a 25° C. environment, 1.0 g of a 0.1 mol/L aqueous solution of hydrochloric acid is added dropwise with stirring to yield a test solution. The test solution is set into an automatic titrator, a potentiometric titration is performed with a 0.01 mol/L aqueous solution of sodium hydroxide, and the derivative of the titration curve is determined. Of the volumes of the 0.01 mol/L aqueous solution of sodium hydroxide at the inflection points at which the derivative of the titration curve is 1.8 or greater, the largest one is defined as E.

The density of silanol groups ρ (groups/nm²) on the surface of the silica particles is calculated according to the equation below, and the calculated density is reported as the OH group content of the silica particles.

ρ=((0.01×E−0.1)×NA/1000)/(M×S_{BET}×10¹⁸)

E, the largest of the volumes of the 0.01 mol/L aqueous solution of sodium hydroxide at the inflection points at which the derivative of the titration curve is 1.8 or greater; NA, the Avogadro constant; M, the amount of the silica particles (1.5 g); S_{BET}, the BET specific surface area (m²/g) of the silica particles as measured by three-point nitrogen adsorption (relative pressure at equilibrium, 0.3).

### Pore Diameter

A pore size distribution curve of the silica particles (A) in nitrogen gas adsorption may have a first peak in the pore diameter range from 0.01 nm to 2 nm and a second peak in the pore diameter range from 1.5 nm to 50 nm, preferably has the second peak in the pore diameter range from 2 nm to 50 nm, more preferably has the second peak in the pore diameter range from 2 nm to 40 nm, even more preferably has the second peak in the pore diameter range from 2 nm to 30 nm.

The presence of first and second peaks in these ranges may narrow charge distribution because in that case the molybdenum- and nitrogen-containing compound may penetrate deeply into the pores in the coating structure.

The method for determining the pore size distribution curve in nitrogen gas adsorption is as follows.

The silica particles are cooled to the temperature of liquid nitrogen (−196° C.), nitrogen gas is introduced, and the amount of adsorbed nitrogen gas is determined by the volumetric or gravimetric method. An adsorption isotherm is created by gradually increasing the pressure of the introduced nitrogen gas and plotting the amount of adsorbed nitrogen gas at different equilibrium pressures. The adsorption isotherm is transformed into a pore size distribution curve according to the formula in the BJH method, with frequency on the vertical axis and pore diameter on the horizontal axis. The resulting pore size distribution curve is transformed into a cumulative distribution of pore volume, with volume on the vertical axis and pore diameter on the horizontal axis, and the pore diameters at which the distribution curve peaks are determined.

The silica particles (A) may be in any of forms (A) and (B) below for charge distribution narrowing and charge distribution maintenance reasons.
Form (A): The ratio B/A, where A and B are the volumes of pores having a diameter of 1 nm or more and 50 nm or less determined from pore size distribution curves in nitrogen gas adsorption of the silica particles (A) before and after firing at 350° C., respectively, is 1.2 or greater and 5 or less, and B is 0.2 cm³/g or more and 3 cm³/g or less.

“The volume A of pores having a diameter of 1 nm or more and 50 nm or less determined from a pore size distribution curve in nitrogen gas adsorption before firing at 350° C.” is hereinafter referred to as “pore volume A before firing at 350° C.,” and “the volume B of pores having a diameter of 1 nm or more and 50 nm or less determined from a pore size distribution curve in nitrogen gas adsorption after firing at 350° C.” is hereinafter referred to as “pore volume B after firing at 350° C.”

The firing at 350° C. is to heat the particles to 350° C. at a rate of 10° C./min, hold at 350° C. for 3 hours, and cool to room temperature (25° C.) at a rate of 10° C./min, all in a nitrogen environment.

The method for measuring the pore volume is as follows.

The silica particles are cooled to the temperature of liquid nitrogen (−196° C.), nitrogen gas is introduced, and the amount of adsorbed nitrogen gas is determined by the volumetric or gravimetric method. An adsorption isotherm is created by gradually increasing the pressure of the introduced nitrogen gas and plotting the amount of adsorbed nitrogen gas at different equilibrium pressures. The adsorption isotherm is transformed into a pore size distribution curve according to the formula in the BJH method, with frequency on the vertical axis and pore diameter on the horizontal axis. The resulting pore size distribution curve is transformed into a cumulative distribution of pore volume, with volume on the vertical axis and pore diameter on the horizontal axis. The total volume of pores in the pore diameter range from 1 nm to 50 nm is determined from the resulting cumulative distribution of pore volume and reported as “the volume of pores having a diameter of 1 nm or more and 50 nm or less.”

The ratio B/A between the pore volume A before firing at 350° C. and the pore volume B after firing at 350° C. may be 1.2 or greater and 5 or less, preferably 1.4 or greater and 3 or less, more preferably 1.4 or greater and 2.5 or less.

The pore volume B after firing at 350° C. may be 0.2 cm³/g or more and 3 cm³/g or less, preferably 0.3 cm³/g or more and 1.8 cm³/g or less, more preferably 0.6 cm³/g or more and 1.5 cm³/g or less.

Form (A) is a form in which a sufficient amount of nitrogen-containing compound has been adsorbed in at least a subset of pores in the silica particles.
Form (B): In a ²⁹Si solid-state nuclear magnetic resonance (NMR) spectrum obtained by cross polarization/magic-angle spinning (CP/MAS) (hereinafter referred to as “the Si—CP/MAS NMR spectrum”), the ratio C/D is 0.10 or greater and 0.75 or less, where C is the integral of signals observed in the chemical shift range from −50 ppm to −75 ppm, and D is that of signals observed in the chemical shift range from −90 ppm to −120 ppm.

The Si—CP/MAS NMR spectrum is obtained by performing nuclear magnetic resonance spectroscopy under the following conditions.
Spectrometer: AVANCE 300 (Bruker)
Resonance frequency: 59.6 MHz
Nucleus measured: ²⁹Si
Measurement method: CP MAS (with Bruker's default pulse sequence cp.av)
Delay time: 4 seconds
Contact time: 8 milliseconds
Number of scans: 2048
Measurement temperature: Room temperature (25° C. as measured)
Observed center frequency: −3975.72 Hz
MAS rotation: 7.0 mm-6 kHz
Reference material: Hexamethylcyclotrisiloxane

The ratio C/D may be 0.10 or greater and 0.75 or less, preferably 0.12 or greater and 0.45 or less, more preferably 0.15 or more and 0.40 or less.

When the integral of all signals in the Si—CP/MAS NMR spectrum is defined as 100%, the percentage of the integral C of signals observed in the chemical shift range from −50 ppm to −75 ppm (signal ratio) may be 5% or more, preferably 7% or more. As for the lower limit, the percentage of signal integral C is, for example, 60% or less.

Form (B) is a form in which the silica particles have, at least on part of their surface, a low-density coating structure onto which a sufficient amount of nitrogen-containing compound can be adsorbed. This low-density coating structure is, for example, a coating structure formed by a product of reaction of a silane coupling agent (a trifunctional silane coupling agent in particular), such as a layer of SiO_{2/3}CH₃.

### Method for Producing the Silica Particles (A)

An example of a method for producing the silica particles (A) includes a first step, in which a coating structure of a product of reaction of a silane coupling agent is formed on at least part of the surface of base silica particles, and a second step, in which a molybdenum- and nitrogen-containing compound is attached to the coating structure. This production method may further include a third step, in which base silica particles having the coating structure are hydrophobized, after or within the second step. These steps will now be described in detail.

### Base Silica Particles

The base silica particles are prepared through, for example, step (i) or (ii) below.
Step (i), an alcohol-containing solvent and base silica particles are mixed together to give a liquid suspension of base silica particles.
Step (ii), base silica particles are formed by the sol-gel method to give a liquid suspension of the base silica particles.

The base silica particles used in step (i) may be dry silica or may be wet silica. Specific examples include sol-gel silica, water-borne colloidal silica, alcoholic silica, fumed silica, and fused silica.

The alcohol-containing solvent used in step (i) may be an alcohol alone or a mixture of an alcohol and a non-alcoholic solvent. Examples of alcohols include lower alcohols, such as methanol, ethanol, n-propanol, isopropanol, and butanol. Examples of non-alcoholic solvents include water; ketones, such as acetone, methyl ethyl ketone, and methyl isobutyl ketone; cellosolves, such as methyl cellosolve, ethyl cellosolve, butyl cellosolve, and cellosolve acetate; and ethers, such as dioxanes and tetrahydrofuran. If the solvent is a mixture, the percentage of the alcohol may be 80% by mass or more, preferably 85% by mass or more.

Step (ii) may be a sol-gel process including an alkaline catalyst solution preparation step, in which an alkaline catalyst solution is prepared as a solution of an alkaline catalyst in an alcohol-containing solvent, and a base silica particle formation step, in which a tetraalkoxysilane and an alkaline catalyst are fed into the alkaline catalyst solution to induce the formation of base silica particles.

The alkaline catalyst solution preparation step may be a step in which an alcohol-containing solvent is prepared and mixed with an alkaline catalyst to give an alkaline catalyst solution.

The alcohol-containing solvent may be an alcohol alone or a mixture of an alcohol and a non-alcoholic solvent. Examples of alcohols include lower alcohols, such as methanol, ethanol, n-propanol, isopropanol, and butanol. Examples of non-alcoholic solvents include water; ketones, such as acetone, methyl ethyl ketone, and methyl isobutyl ketone; cellosolves, such as methyl cellosolve, ethyl cellosolve, butyl cellosolve, and cellosolve acetate; and ethers, such as dioxanes and tetrahydrofuran. If the solvent is a mixture, the percentage of the alcohol may be 80% by mass or more, preferably 85% by mass or more.

The alkaline catalyst is a catalyst for accelerating the reactions of the tetraalkoxysilane (hydrolysis and condensation); it can be, for example, a basic catalyst such as ammonia, urea, or a monoamine, preferably ammonia.

The concentration of the alkaline catalyst in the alkaline catalyst solution may be 0.5 mol/L or more and 1.5 mol/L or less, preferably 0.6 mol/L or more and 1.2 mol/L or less, more preferably 0.65 mol/L or more and 1.1 mol/L or less.

The base silica particle formation step is a step in which a tetraalkoxysilane and an alkaline catalyst are separately fed into the alkaline catalyst solution, and the tetraalkoxysilane is allowed to react (hydrolyze and condense) in the alkaline catalyst solution to produce base silica particles.

In the base silica particle formation step, core particles form through reactions of the tetraalkoxysilane soon after the tetraalkoxysilane is fed (core particle formation stage), then these core particles grow (core particle growth stage), and the base silica particles form as a result.

The tetraalkoxysilane can be, for example, tetramethoxysilane, tetraethoxysilane, tetrapropoxysilane, or tetrabutoxysilane. Preferably, the tetraalkoxysilane is tetramethoxysilane or tetraethoxysilane for the control of the reaction rate or for uniformity in the shape of the resulting base silica particles.

The alkaline catalyst fed into the alkaline catalyst solution can be, for example, a basic catalyst such as ammonia, urea, or a monoamine, preferably ammonia. The alkaline catalyst fed together with the tetraalkoxysilane may be the same as or may be different from the alkaline catalyst that has already been contained in the alkaline catalyst solution, but preferably, the two alkaline catalysts are of the same type.

As for the feeding method for the feeding of each of the tetraalkoxysilane and the alkaline catalyst into the alkaline catalyst solution, the materials may be fed continuously or may be fed intermittently.

In the base silica particle formation step, the temperature of the alkaline catalyst solution (at the feeding of the materials thereinto) may be 5° C. or above and 50° C. or below, preferably 15° C. or above and 45° C. or below.

### First Step

The first step is, for example, a step in which a silane coupling agent is added to a liquid suspension of base silica particles, and the silane coupling agent is allowed to react on the surface of the base silica particles to produce a coating structure formed by the product of reaction of the silane coupling agent.

The reaction of the silane coupling agent is carried out by, for example, adding the silane coupling agent to the liquid suspension of base silica particles and then heating the suspension while stirring it. Specifically, for example, the suspension is heated to 40° C. or above and 70° C. or below, the silane coupling agent is added, and the resulting mixture is stirred. The duration of stirring may be 10 minutes or more and 24 hours or less, preferably 60 minutes or more and 420 minutes or less, more preferably 80 minutes or more and 300 minutes or less.

### Second Step

The second step may be a step in which a molybdenum- and nitrogen-containing compound is attached to pores in the coating structure formed by a product of reaction of a silane coupling agent.

In the second step, for example, a molybdenum- and nitrogen-containing compound is added to the liquid suspension of base silica particles after a complete reaction of the silane coupling agent, and the resulting mixture is stirred with its temperature kept in the range of 20° C. to 50° C. The molybdenum- and nitrogen-containing compound may be added to the suspension of silica particles as a solution of the compound in an alcohol. The alcohol may be the same as or may be different from that in the suspension of base silica particles, but preferably the two alcohols are of the same type. In the alcohol solution of the molybdenum- and nitrogen-containing compound, the concentration of the molybdenum- and nitrogen-containing compound may be 0.05% by mass or more and 10% by mass or less, preferably 0.1% by mass or more and 6% by mass or less.

### Third Step

The third step is a step in which a hydrophobized structure is attached to the coating structure formed by a product of reaction of a silane coupling agent. The third step is a hydrophobizing step performed after or during the second step. A hydrophobized layer is formed through a reaction between functional groups of a hydrophobizing agent and/or a reaction between a functional group of a hydrophobizing agent and OH groups of the base silica particles.

In the third step, for example, a molybdenum- and nitrogen-containing compound is added to the liquid suspension of base silica particles after a complete reaction of the silane coupling agent, and then a hydrophobizing agent is added. The suspension may be stirred and heated during this. For example, the suspension is heated to 40° C. or above and 70° C. or below, the hydrophobizing agent is added, and the resulting mixture is stirred. The duration of stirring may be 10 minutes or more and 24 hours or less, preferably 20 minutes or more and 120 minutes or less, more preferably 20 minutes or more and 90 minutes or less.

### Drying Step

After the second or third step is performed or while the second or third step is performed, a drying step in which the solvent is removed from the liquid suspension may be carried out. Examples of drying methods include thermal drying, spray drying, and supercritical drying.

Spray drying can be performed by known methods using a spray dryer (rotary disk, nozzle, etc.). For example, the suspension of silica particles is sprayed into a stream of hot air at a rate of 0.2 liters/hour or more and 1 liter/hour or less. The temperature of the hot air may be 70° C. or above and 400° C. or below at the inlet of the spray dryer and may be 40° C. or above and 120° C. or below at the outlet. Preferably, the temperature of the hot air at the inlet is 100° C. or above and 300° C. or below. The concentration of silica particles in the suspension of silica particles may be 10% by mass or more and 30% by mass or less.

In supercritical drying, the substance used as the supercritical fluid can be, for example, carbon dioxide, water, methanol, ethanol, or acetone. The supercritical fluid may be supercritical carbon dioxide for treatment efficiency reasons and for the control of the formation of coarse particles. A specific example of an operation performed in a step in which supercritical carbon dioxide is used is as follows.

The suspension is put into an airtight reaction vessel, liquid carbon dioxide is then introduced, and then the airtight reaction vessel is heated while the pressure inside the airtight reaction vessel is increased using a high-pressure pump to make the carbon dioxide in the airtight reaction vessel supercritical. Then liquid carbon dioxide is allowed to flow into the airtight reaction vessel, and the supercritical carbon dioxide is allowed to flow out of the airtight reaction vessel so that the supercritical carbon dioxide will pass through the suspension in the airtight reaction vessel. While the supercritical carbon dioxide passes through the suspension, the solvent dissolves in the supercritical carbon dioxide and is removed together with the supercritical carbon dioxide flowing out of the airtight reaction vessel. The temperature and pressure inside the airtight reaction vessel are a temperature and a pressure at which carbon dioxide turns supercritical. Since the critical point of carbon dioxide is 31.1° C. and 7.38 MPa, the temperature and pressure inside the airtight reaction vessel are set to, for example, 40° C. or above and 200° C. or below and 10 MPa or more and 30 MPa or less, respectively. The flow rate of the supercritical fluid into the airtight reaction vessel may be 80 mL/sec or more and 240 mL/sec or less.

The resulting silica particles may be disintegrated or screened so that coarse particles and aggregates will be removed. The disintegration is carried out using, for example, a dry mill, such as a jet mill, vibration mill, ball mill, or pin mill. The screening is carried out using, for example, a vibration sieve or air-jet sieve.

### Other External Additives

Besides the silica particles (A), the toner used in this exemplary embodiment may include other external additives added thereto. Examples of such external additives include inorganic particles, such as silica particles other than the silica particles (A) and particles of strontium titanate, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄; hydrophobized inorganic particles produced by treating the surface of such inorganic particles with a hydrophobizing agent; and resin particles, such as particles of polystyrene, polymethyl methacrylate, and melamine resin. Examples of silica particles other than the silica particles (A) include hydrophobic silica particles, which are produced by treating the surface of silica particles, such as particles of sol-gel, water-borne colloidal, alcoholic, fumed, or fused silica, with a hydrophobizing agent (e.g., hexamethyldisilazane, a silane coupling agent, a titanate coupling agent, an aluminum coupling agent, or silicone oil).

Of these external additives, it is preferred to use silica particles other than the silica particles (A) or strontium titanate together with the silica particles (A).

### Structure and Characteristics of the Toner

### Viscoelasticity of the Toner

For the toner used in this exemplary embodiment, each of D1(90), D50(90), D1(150), and D50(150) may be 0.5 or greater and 2.5 or less;
D50(150)−D1(150) may be less than 1.5; and
D50(90)−D1(90) may be less than 1.0,
   where D1(90) is the loss tangent tan δ of the toner measured in dynamic rheometry at a temperature of 90° C. and a strain of 1%, D50(90) is that at a temperature of 90° C. and a strain of 50%, D1(150) is that at a temperature of 150° C. and a strain of 1%, and D50(150) is that at a temperature of 150° C. and a strain of 50%.

The D50(150)−D1(150) of the toner may be less than 1.5, preferably 1.2 or less, more preferably 1.0 or less. A D50(150)−D1(150) in these ranges may reduce variations in gloss under different conditions compared with when D50(150)−D1(150) is greater than these ranges. Smaller D50(150)−D1(150) values are better for reducing variations in gloss under different conditions.

There is no particular lower limit to D50(150)−D1(150).

The D50(90)−D1(90) of the toner may be less than 1.0, preferably less than 0.5, more preferably 0.4 or less, even more preferably 0.3 or less. A D50(90)−D1(90) in these ranges may reduce variations in gloss under different conditions compared with when D50(90)−D1(90) is greater than these ranges. Smaller D50(90)−D1(90) values are better for reducing variations in gloss under different conditions.

There is no particular lower limit to D50(90)−D1(90).

The D1(90), D50(90), D1(150), and D50(150) of the toner are determined by the following measurement method.

A sample for measurement is prepared by shaping the toner into a tablet using a press machine at room temperature (25° C.±3° C.). The sample for measurement is sandwiched between parallel plates 8 mm in diameter, and the resulting test cell is subjected to dynamic rheometry using a rheometer (ARES-G2, TA Instruments) with a gap of 3 mm, a frequency of 1 Hz, and a strain of 1% or 50% at a temperature of 90° C. or 150° C.; the storage and loss modulus curves are obtained, the loss tangent tan δ is determined.

In this context, a strain of 1% in dynamic rheometry means changing the height of the sample (i.e., the gap) by 1%. In other words, a strain of 1% is a slight induced change and corresponds to a toner-fixing step in which the fuser pressure is low. A strain of 50%, by contrast, corresponds to a toner-fixing step in which the fuser pressure is high. A temperature of 90° C. and a strain of 1% correspond to low-temperature and low-pressure fixing conditions, a temperature of 150° C. and a strain of 50% correspond to high-temperature and high-pressure fixing conditions, and the loss tangents tan δ correspond to the amounts of deformation of the toner under the respective sets of fixing conditions. The inventors believe that controlling the differences between the loss tangent tan δ at a strain of 1% and that at a strain of 50% to particular ranges may help limit the amount of deformation of the toner to a particular range, and therefore help reduce variations in gloss, even if the fuser pressure is varied.

This measurement method determines loss tangent tan δ under sets of conditions as combinations of high (150° C.) and low (90° C.) temperatures with high (50%) and low (1%) strains. The measurement temperatures are 150° C. and 90° C. because the sample would exhibit little viscoelasticity at too low temperatures.

Having such dynamic viscoelasticity characteristics, the toner used in this exemplary embodiment may be unlikely to experience the sinking of an external additive into toner particles even if exposed to high mechanical stress in a high-temperature and high-humidity environment. The toner used in this exemplary embodiment, therefore, may be better in flowability by virtue of having such dynamic viscoelasticity characteristics.

Owing to such dynamic viscoelasticity characteristics, furthermore, the toner used in this exemplary embodiment may be fixed well, and the fixed images may vary little in gloss under low-temperature and low-pressure conditions and high-temperature and high-pressure conditions. A possible reason for this is as follows.

In general, toners that melt well when heated are fixed well. When images are formed using a toner that melts well when heated, however, variations in the gloss of the fixed images associated with fixing conditions can be great.

Toners having dynamic viscoelasticity characteristics according to this exemplary embodiment, by contrast, may experience little change in loss tangent as strain changes, at both 90° C. and 150° C. By virtue of the similarity between the viscoelasticity of the toner under high-temperature and high-strain conditions and that under low-temperature and low-strain conditions, the inventors believe, the variations in the gloss of the fixed image associated with fixing conditions may be small.

In this exemplary embodiment, furthermore, all of D1(90), D50(90), D1(150), and D50(150) are 0.5 or greater; by virtue of this, the toner may melt well in response to the heat applied during fixation and, therefore, may be fixed well, compared with when any is less than 0.5.

D1(90), D50(90), D1(150), and D50(150) may each be 0.5 or greater and 2.5 or less, preferably 0.5 or greater and 2.0 or less, more preferably 0.6 or greater and 1.8 or less. D1(90), D50(90), D1(150), and D50(150) in these ranges may allow good fixation to be achieved compared with when any is smaller than these ranges, and may reduce variations in gloss compared with when any is greater than these ranges.

D50(150)−D1(150) may be less than 1.5, preferably 1.2 or less, more preferably 1.0 or less. A D50(150)−D1(150) in these ranges may reduce variations in gloss compared with when D50(150)−D1(150) is greater than these ranges. Smaller D50(150)−D1(150) values are better for reducing variations in gloss. There is no particular lower limit to D50(150)−D1(150).

D50(90)−D1(90) may be less than 1.0, preferably less than 0.5, more preferably 0.4 or less. A D50(90)−D1(90) in these ranges may reduce variations in gloss compared with when D50(90)−D1(90) is greater than these ranges. Smaller D50(90)−D1(90) values are better for reducing variations in gloss. There is no particular lower limit to D50(90)−D1(90).

The toner used in this exemplary embodiment may have a storage elasticity G′ of 1×10⁸ Pa or more at temperatures of 30° C. or above and 50° C. or below in a dynamic rheological measurement in which the temperature is raised at a rate of 2° C./min, and the temperature at which the storage modulus G′ of the toner falls below 1×10⁵ Pa in the same measurement may be 65° C. or above and 90° C. or below. A toner having such characteristics may have a high elasticity at low temperatures and have a low elasticity at 65° C. or above and 90° C. or below. A toner having such characteristics may melt well when heated and, therefore, may be fixed well, compared with when its storage modulus G′ falls below 1×10⁵ Pa at a temperature higher than 90° C.

For the toner used in this exemplary embodiment, the storage elasticity G′ at 30° C. or above and 50° C. or below in a dynamic rheological measurement in which the temperature is raised at a rate of 2° C./min may be 1×10⁸ Pa or more, preferably 1×10⁸ Pa or more and 1×10⁹ Pa or less, more preferably 2×10⁸ Pa or more and 6×10⁸ Pa or less. A toner having such a characteristic may combine storage stability and good fixation.

For the toner used in this exemplary embodiment, the temperature at which its storage modulus G′ falls below 1×10⁵ Pa in a dynamic rheological measurement in which the temperature is raised at a rate of 2° C./min may be 65° C. or above and 90° C. or below, preferably 70° C. or above and 87° C. or below, more preferably 75° C. or above and 84° C. or below. A toner having such a characteristic may combine storage stability and good fixation.

The storage modulus G′ of the toner and the temperature at which the storage modulus G′ of the toner falls below 1×10⁵ Pa are determined by the following measurement method.

A sample for measurement is prepared by shaping the toner into a tablet using a press machine at room temperature (25° C.±3° C.). The sample for measurement is sandwiched between parallel plates 8 mm in diameter, and the resulting test cell is subjected to dynamic rheometry using a rheometer (ARES-G2, TA Instruments) with a gap of 3 mm, a frequency of 1 Hz, strains from 0.1% to 100%, and temperature rises from 30° C. to 150° C. at a rate of 2° C./min. On the storage and loss modulus curves obtained through dynamic rheometry, the storage modulus G′ and the temperature at which the storage modulus G′ falls below 1×10⁵ Pa are determined.

These viscoelasticity characteristics can be controlled by changing the resin particles contained in the toner particles and their degree of dispersion. For example, the presence of the resin particles (e.g., resin particles (S)) evenly near the surface of the toner particles and near the center of the toner particles may allow the above viscoelasticity characteristics to be achieved.

Incidentally, for the resin particles to be encapsulated in the toner particles, the compatibility between the resin particles and the binder resin may be high. Examples of specific methods for increasing the compatibility of the resin particles with the binder resin include controlling the SP and using a surfactant as a dispersant for the resin particles. The use of resin particles highly compatible with the binder resin, however, can reduce dispersibility because in that case the resin particles, which are particles of an organic polymer rather than inorganic fillers, carbon black, or metal particles, tend to dissolve in the binder resin.

Using resin particles of low compatibility with the binder resin, on the other hand, can cause the resin particles to be forced out to the surface or outside of the toner particles; the resin particles are not encapsulated in the toner particles well.

Using resin particles moderately compatible with the binder resin, which are intermediate between highly compatible resin particles and low-compatibility ones, leads to some degree of encapsulation of the resin particles in the toner particles, but it has been difficult to place such resin particles evenly in the toner particles; whatever the process used to produce the toner is (emulsion aggregation, kneading and milling, etc.), the resin particles, formed from the same material and therefore highly compatible with one another, can remain in contact with each other once touching, and this can make the distribution of the resin particles uneven. One possible cause of the persistent contact between resin particles is that chains of the polymer component of the resin particles become entangled with one another at the contact between the particles.

Using crosslinked resin particles as the resin particles may allow the resin particles to be placed evenly in the toner particles; in that case the entanglement between polymer chains may be limited, and, therefore, it may be less likely that the resin particles remain in contact with each other.

The toner used in this exemplary embodiment may experience little change in loss tangent for a given change in strain when the number-average molecular weight of the tetrahydrofuran-soluble component of the toner particles is 5,000 or more and 15,000 or less; the toner in that case may be fixed well, even though it is a highly-viscoelasticity toner with limited deformation. Specifically, if the number-average molecular weight of the tetrahydrofuran-soluble component were too small, the toner particles would deform greatly under high-temperature and high-pressure fixing conditions, and therefore variations in gloss would be great, due to the predominance of low-molecular-weight components in the toner particles; compared with that case, variations in gloss may be limited by virtue of the number-average molecular weight of the tetrahydrofuran-soluble component being in the above range. If the number-average molecular weight of the tetrahydrofuran-soluble component were too large, furthermore, the toner particles would deform only to a limited extent, but the toner would be difficult to fix well at low temperatures due to the predominance of high-molecular-weight components in the toner particles; compared with that case, difficulty fixing the toner at low temperatures may be limited by virtue of the number-average molecular weight of the tetrahydrofuran-soluble component being in the above range. The number-average molecular weight of the tetrahydrofuran-soluble component may be 7,000 or more and 10,000 or less. The tetrahydrofuran-soluble component may be hereinafter referred to as “the THF-soluble component.”

This number-average molecular weight of the THF-soluble component of the toner particles is determined using two “HLC-8120 GPC, SC-8020 (Tosoh Corporation, 6.0 mm ID×15 cm)” columns and tetrahydrofuran (THF) as the eluate with a prepared sample of the THF-soluble component of the toner particles.

Specifically, the sample is prepared by dissolving 0.5 mg of the toner particles of interest in 1 g of THF, dispersing the particles by sonication, and adjusting the concentration to 0.5% by mass.

A measurement is made using an RI detector under the conditions of a sample concentration of 0.5% by mass, a flow rate of 0.6 ml/min, a sample injection volume of 10 μl, and a measurement temperature of 40° C.

The calibration curve is constructed using the following ten of Tosoh Corporation's “TSK standard polystyrene standard samples”: “A-500,” “F-1,” “F-10,” “F-80,” “F-380,” “A-2500,” “F-4,” “F-40,” “F-128,” and “F-700.”

If the toner contains an external additive besides the toner particles, the external additive is released, for example by dispersing the toner in a 0.2% by mass aqueous solution of polyoxyethylene(10) octylphenyl ether to a concentration of 10% by mass and sonicating the resulting dispersion (frequency, 20 kHz; power, 30 W) for 60 minutes while keeping the dispersion at temperatures of 30° C. or below. Filtering out the toner particles from the sonicated dispersion and washing them gives toner particles from which the external additive has been detached.

### Method for Producing the Toner

The toner used in this exemplary embodiment is obtained by producing the toner particles and then attaching the external additive to the toner particles.

The toner particles may be produced by a dry process (e.g., kneading and milling) or by a wet process (e.g., aggregation and coalescence, suspension polymerization, or dissolution and suspension). Any known dry or wet process may be used. Aggregation and coalescence, in particular, may be used to produce the toner particles.

Specifically, if the toner particles are produced by, for example, aggregation and coalescence, the toner particles are produced through:
a step of preparing resin particle dispersion (1), which is a liquid dispersion of resin particles (1), or resin particles to serve as the binder resin, and resin particle dispersion (2), which is a liquid dispersion of resin particles (2), or resin particles to serve as the resin particles (resin particle dispersion preparation step);
a step of forming aggregates by causing resin particles (1) and (2) (and optionally other particles) to aggregate in a mixture of resin particle dispersions (1) and (2) (and optionally other liquid dispersions of particles) (aggregate formation step); and
a step of forming toner particles by heating the liquid dispersion of aggregates, or the aggregate dispersion, to cause the aggregates to fuse and coalesce together (fusion and coalescence step).

The details of the individual steps will now be described. The following description is about a method for obtaining toner particles containing coloring and release agents, but the use of coloring and release agents is optional. Naturally, other additives, other than coloring and release agents, may also be used.

### Resin Particle Dispersion Preparation Step

Resin particle dispersion (1) is prepared by, for example, dispersing resin particles (1) in a dispersion medium with a surfactant.

An example of a dispersion medium used in resin particle dispersion (1) is an aqueous medium.

Examples of aqueous media include types of water, such as distilled water and deionized water, and alcohols. One such medium may be used alone, or two or more may be used in combination.

Examples of surfactants include anionic surfactants, such as salts of sulfates, salts of sulfonic acid, esters of phosphoric acid, and soap surfactants; cationic surfactants, such as amine salts and quaternary ammonium salts; and nonionic surfactants, such as polyethylene glycol surfactants, ethylene oxide adducts of alkylphenols, and polyhydric alcohols. In particular, anionic and cationic surfactants are typical examples. Nonionic surfactants may be used in combination with an anionic or cationic surfactant. One surfactant may be used alone, or two or more may be used in combination.

In preparing resin particle dispersion (1), examples of methods for dispersing resin particles (1) in the dispersion medium include common dispersion methods, such as a rotary-shear homogenizer and a ball mill, sand mill, Dyno-Mill, and other medium mills. Certain types of resin particles (1) may be dispersed in the dispersion medium by phase inversion emulsification. Phase inversion emulsification is a method for dispersing particles of a resin in an aqueous medium in which the resin to be dispersed is dissolved in a hydrophobic organic solvent in which the resin is soluble, the organic continuous phase (phase) is neutralized by adding a base, and then the aqueous medium (W phase) is put into the solution to invert the phases from W/O into O/W.

The volume-average diameter of resin particles (1), or the resin particles to be dispersed in resin particle dispersion (1), may be 0.01 μm or more and 1 μm or less for example, preferably 0.08 μm or more and 0.8 μm or less, more preferably 0.1 μm or more and 0.6 μm or less.

The volume-average diameter of resin particles (1) is measured using a particle size distribution obtained through measurement with a laser-diffraction particle size distribution analyzer (e.g., HORIBA LA-700); the distribution obtained is divided into segments by particle size (channels), the cumulative volume distribution is plotted starting from the smallest diameter, and the particle diameter at which the cumulative percentage is 50% of all particles is reported as the volume-average diameter D50v of the particles. The volume-average diameter of particles in the other liquid dispersions is also measured likewise.

The amount of resin particles (1) in resin particle dispersion (1) may be 5% by mass or more and 50% by mass or less, preferably 10% by mass or more and 40% by mass or less.

In the same manner as resin particle dispersion (1), a coloring agent particle dispersion, which is a liquid dispersion of particles of a coloring agent, and a release agent particle dispersion, which is a liquid dispersion of particles of a release agent, for example, are also prepared. That is, what is described about the volume-average diameter of particles, dispersion medium, the dispersing method, and the amount of particles in relation to resin particle dispersion (1) also applies to the particles of a coloring agent dispersed in the coloring agent particle dispersion and the particles of a release agent dispersed in the release agent particle dispersion.

The method for preparing resin particle dispersion (2) is a known method, such as emulsion polymerization, melt blending with a Banbury mixer or kneader, suspension polymerization, or spray drying. Emulsion polymerization is preferred.

A styrene monomer and a (meth)acrylic monomer may be polymerized by emulsion polymerization in the presence of a crosslinker so that the storage modulus G′ and loss tangent tan δ of the resin particles will be in a particular range. The emulsion polymerization may be performed in multiple stages.

The method for preparing resin particle dispersion (2) may include:
a step of obtaining an emulsion containing a monomer, a crosslinker, a surfactant, and water (emulsion preparation step);
a step of polymerizing the monomer by adding a polymerization initiator to the emulsion and then heating the emulsion (first emulsion polymerization step); and
a step of adding another emulsion containing a monomer and a crosslinker to the reaction solution resulting from the first emulsion polymerization step and then heating the mixture to polymerize the monomer (second emulsion polymerization step).

Emulsion Preparation Step

A monomer, a crosslinker, a surfactant, and water may be emulsified using an emulsifier to give an emulsion. Examples of emulsifiers include rotary stirrers having propeller, anchor, paddle, or turbine stirring blades; stationary mixers, such as a static mixer; rotor-stator emulsifiers, such as a homogenizer and CLEARMIX; mill emulsifiers, which have a milling capability; high-pressure emulsifiers, such as a Manton-Gaulin pressure emulsifier; high-pressure nozzle emulsifiers, which cause cavitation under high pressure; high-pressure impact emulsifiers, which cause liquids to collide with each other under high pressure, such as Microfluidizer; ultrasonic emulsifiers, which cause cavitation by sonication; and membrane emulsifiers, which homogenize materials by passing them through pores.

The monomer may be a styrene monomer and a (meth)acrylic monomer. The crosslinker is selected from the compounds already mentioned as examples of crosslinkers.

Examples of surfactants include anionic surfactants, such as salts of sulfates, salts of sulfonic acid, esters of phosphoric acid, and soap surfactants; cationic surfactants, such as amine salts and quaternary ammonium salts; and nonionic surfactants, such as polyethylene glycol surfactants, ethylene oxide adducts of alkylphenols, and polyhydric alcohols. Nonionic surfactants may be used in combination with an anionic or cationic surfactant. Anionic surfactants are preferred. One surfactant may be used alone, or two or more may be used in combination.

The emulsion may contain a chain transfer agent. An example of a chain transfer agent is a compound having a thiol component. Specific examples include alkyl mercaptans, such as hexyl mercaptan, heptyl mercaptan, octyl mercaptan, nonyl mercaptan, decyl mercaptan, and dodecyl mercaptan.

The ratio by mass between the styrene monomer and the (meth)acrylic monomer (styrene monomer/(meth)acrylic monomer) in the emulsion may be 0.2 or greater and 1.1 or less so that the storage modulus G′ and loss tangent tan δ of the resin particles will be in a particular range. The percentage of the crosslinker in the emulsion as a whole may be 0.5% by mass or more and 3% by mass or less so that the storage modulus G′ and loss tangent tan δ of the resin particles will be in a particular range.

First Emulsion Polymerization Step

In this step, a polymerization initiator is added to the emulsion, and then the emulsion is heated so that the monomer will be polymerized.

The polymerization initiator may be ammonium persulfate. The amount of the polymerization initiator may be adjusted to control the viscoelasticity of the resin particles. For example, reducing the amount of the polymerization initiator may make more certain that the resulting resin particles will have a high storage modulus G′.

During the polymerization of the monomer, the emulsion containing a polymerization initiator (reaction solution) may be stirred with a stirrer. An example of a stirrer is a rotary stirrer having propeller, anchor, paddle, or turbine stirring blades.

Second Emulsion Polymerization Step

In this step, another emulsion containing a monomer is added to the reaction solution resulting from the first emulsion polymerization step, and then the mixture is heated so that the monomer will be polymerized. The emulsion added in this step may be obtained by emulsifying a monomer, a surfactant, and water with an emulsifier. As in the first emulsion polymerization step, the reaction solution may be stirred during the polymerization.

The time spent adding the monomer-containing emulsion may be adjusted to control the viscoelasticity of the resin particles. For example, extending the time spent adding the monomer-containing emulsion may make more certain that the resulting resin particles will have a high storage modulus G′. The time spent adding the monomer-containing emulsion can be, for example, 2 hours or more and 5 hours or less.

The temperature of the reaction solution while being stirred may be adjusted to control the viscoelasticity of the resin particles. For example, lowering the temperature of the reaction solution while being stirred may make more certain that the resulting resin particles will have a high storage modulus G′. The temperature of the reaction solution while being stirred can be, for example, 55° C. or above and 75° C. or below.

### Aggregate Formation Step

Then resin particle dispersions (1) and (2), the coloring agent particle dispersion, and the release agent particle dispersion are mixed together. In the resulting dispersion mixture, resin particles (1) and (2), the coloring agent particles, and the release agent particles are allowed to aggregate (heteroaggregation) to produce aggregates having a diameter close to the intended diameter of the finished toner particles.

A specific example of a method for this is to add a flocculant to the dispersion mixture, adjust the pH of the mixture to an acidic level (e.g., 2 or higher and 5 or lower) at the same time, optionally add a dispersion stabilizer, and then heat the mixture to a temperature near the glass transition temperature of resin particles (1) (a specific example being a temperature higher than or equal to the glass transition temperature of resin particles (1) minus 30° C. but not higher than the glass transition temperature of resin particles (1) minus 10° C.) to cause the particles dispersed in the mixture to combine into aggregates. In the aggregate formation step, for example, the flocculant may be added to the dispersion mixture at room temperature (e.g., 25° C.) with stirring with a rotary-shear homogenizer, the pH of the mixture may be adjusted to an acidic level (e.g., 2 or higher and 5 or lower), and then the mixture may be heated optionally with an added dispersion stabilizer therein.

The temperature of the dispersion mixture at the addition of the flocculant thereto may be adjusted to control the dispersion state of resin particles in the finished toner particles. For example, lowering the temperature of the dispersion mixture may lead to better dispersibility of the resin particles. The temperature of the dispersion mixture can be, for example, 5° C. or above and 40° C. or below.

The rate of stirring after the addition of the flocculant may be adjusted to control the dispersion state of resin particles in the finished toner particles. For example, increasing the rate of stirring after the addition of the flocculant may lead to better dispersibility of the resin particles.

The flocculant can be, for example, a surfactant having the opposite polarity to the surfactant contained in the dispersion mixture, an inorganic metal salt, or a divalent or higher-valency metal complex. Using a metal complex as a flocculant may improve charging characteristics because in that case the amount of surfactant used may be smaller.

Optionally, an additive that forms a complex or otherwise binds with metal ions derived from the flocculant may be used. An example is a chelating agent.

Examples of inorganic metal salts include metal salts such as calcium chloride, calcium nitrate, barium chloride, magnesium chloride, zinc chloride, aluminum chloride, and aluminum sulfate; and polymers of inorganic metal salts, such as polyaluminum chloride, polyaluminum hydroxide, and calcium polysulfide.

The chelating agent may be a water-soluble chelating agent. Examples of chelating agents include oxycarboxylic acids, such as tartaric acid, citric acid, and gluconic acid; and aminocarboxylic acids, such as iminodiacetic acid (IDA), nitrilotriacetic acid (NTA), and ethylenediaminetetraacetic acid (EDTA).

The amount of the chelating agent may be 0.01 parts by mass or more and 5.0 parts by mass or less, preferably 0.1 parts by mass or more and less than 3.0 parts by mass, per 100 parts by mass of the resin particles.

### Fusion and Coalescence Step

Then the resulting liquid dispersion of aggregates, or the aggregate dispersion, is heated, for example to a temperature equal to or higher than the glass transition temperature of resin particles (1) (e.g., the glass transition temperature of resin particles (1) plus 10° C. to 30° C.), to cause the aggregates to fuse and coalesce into toner particles.

Through these steps, toner particles are obtained.

After the aggregate dispersion is obtained, the toner particles may be produced through a step of forming second aggregates by mixing resin particle dispersions (1) and (2) into the aggregate dispersion and causing resin particles (1) and (2) to combine together on the surface of the aggregates and a step of heating the resulting liquid dispersion of second aggregates, or the second aggregate dispersion, to cause the second aggregates to fuse and coalesce into core-shell toner particles.

In the step of forming second aggregates, resin particle dispersions (1) and (2) may be added in divided portions. This may allow toner particles to be obtained in which resin particles are highly uniformly dispersed in both the core particles and the shell layer.

After the end of the fusion and coalescence step, the toner particles in the liquid dispersion are subjected to known washing, solid-liquid separation, and drying steps to give dry toner particles. The washing step may include a sufficient degree of displacement washing with deionized water for chargeability reasons. The solid-liquid separation step may include suction filtration or pressure filtration, for example, for productivity reasons. The drying step may include lyophilization, flash drying, fluidized drying, or vibrating fluidized drying, for example, for productivity reasons.

Then the toner used in this exemplary embodiment is produced, for example by adding the external additive to the resulting dry toner particles and mixing them together. The mixing may be carried out using, for example, a V-blender, Henschel mixer, or Lödige mixer. Optionally, coarse particles in the toner may be removed, for example using a vibrating sieve or air-jet sieve.

### Carrier B

The electrostatic charge image developer according to this exemplary embodiment

contains a carrier B having a core and a coating resin layer that covers the core and contains inorganic particles.

The surface roughness Ra1 of the carrier B may be more than 0.1 μm and less than 0.9 μm, preferably 0.11 μm or more and less than 0.85 μm, more preferably 0.12 μm or more and 0.8 μm or less for further reduced unevenness in image density.

The surface roughness Ra of the carrier B can be controlled by any method, but examples include adjusting the surface roughness Ra of the core; adjusting the thickness of the coating resin layer; and adjusting the rate, temperature, and time of stirring when the resin to form the coating resin layer, the core, the inorganic particles, and optionally a solvent are mixed together and stirred in producing the carrier.

In this exemplary embodiment, the measurement of the surface roughness Ra of the carrier is carried out by the following method. The method for measuring the Ra (arithmetical mean roughness) of the carrier surface is a method in which the surface of 2,000 carrier particles is observed at a magnification of 1,000 times using a color 3D surface profiler/microscope (VK9700, Keyence Corporation) and is implemented according to JIS B0601 (1994). Specifically, the Ra of the carrier surface is determined by converting the microscopically observed 3D profile of the carrier surface into a roughness profile, totaling up the absolute distance from the measured height of the roughness profile to the average height, and then finding the average. In determining the Ra of the carrier surface, the sampling length is 10 μm, and the cut-off is 0.08 mm.

### Core

The carrier B incorporates a core.

The core can be any magnetic material; a known material used as a core of a carrier is employed.

The core can be, for example, a magnetic powder in particulate form (magnetic particles); a porous magnetic powder impregnated with a resin, or resin-impregnated magnetic particles; or a resin containing a magnetic powder dispersed therein, or magnetic powder-dispersed resin particles.

The magnetic powder can be, for example, particles of a magnetic metal, such as iron, nickel, or cobalt; or a powder of a magnetic oxide, such as ferrite or magnetite, preferably is a powder of a magnetic oxide. One type of magnetic particles may be used alone, or two types or more may be used in combination.

Examples of resins that can be used in the core include polyethylene, polypropylene, polystyrene, polyvinyl acetate, polyvinyl alcohol, polyvinyl butyral, polyvinyl chloride, polyvinyl ethers, polyvinyl ketones, vinyl chloride-vinyl acetate copolymers, styrene-acrylic acid copolymers, straight silicone, having organosiloxane bonds therein, and its modified forms, fluoropolymers, polyesters, polycarbonates, phenolic resins, and epoxy resins. One such resin may be used alone, or two or more may be used in combination. The resin as a component of the core may contain additives, such as electrically conductive particles. Examples of electrically conductive particles include particles of metals, such as gold, silver, and copper, and particles of carbon black, titanium oxide, zinc oxide, tin oxide, barium sulfate, aluminum borate, potassium titanate, etc.

Preferably, the core is a magnetic powder in particulate form, i.e., magnetic particles.

The surface roughness Ra of the core may be 0.5 μm or more and 1.5 μm or less, preferably 0.6 μm or more and 1.2 μm or less, more preferably 0.7 μm or more and 1.0 μm or less.

The surface roughness Ra of the core can be controlled to these ranges by any method, but an example is to produce the core using a wet ball mill and mill the raw material for the core or its fired form to a particular particle size.

The surface roughness Ra of the core is measured in the same manner as the surface roughness Ra of the carrier, described above.

The volume-average diameter of the magnetic particles may be, for example, 20 μm or more and 50 μm or less.

### Coating Resin Layer

The coating resin layer contains inorganic particles.

The coating resin layer is a resin layer that covers the core.

For the coating resin layer, relation (1) holds, where D is the volume-average diameter (μm) of the inorganic particles, and T is the thickness (μm) of the coating resin layer; relation (1-2), preferably relation (1-3), may hold for further reduced fogging on the finished image.

0.005≤D/T≤0.24 (1)

0.005≤D/T≤0.15 (1-2)

0.007≤D/T≤0.05 (1-3)

Any method can be used to ensure that relations (1), (1-2), and (1-3) hold for the coating resin layer, but examples include changing the resin forming the coating resin layer; and adjusting the diameter of the inorganic particles.

### Resin

Examples of resins that can be used in the coating resin layer include styrene-acrylic acid copolymers; polyolefin resins, such as polyethylene and polypropylene; polyvinyl or polyvinylidene resins, such as polystyrene, acrylic resins, polyacrylonitrile, polyvinyl acetate, polyvinyl alcohol, polyvinyl butyral, polyvinyl chloride, polyvinylcarbazole, polyvinyl ethers, and polyvinyl ketones; vinyl chloride-vinyl acetate copolymers; straight silicone resins, formed by organosiloxane bonds, and their modified forms; fluoropolymers, such as polytetrafluoroethylene, polyvinyl fluoride, polyvinylidene fluoride, and polychlorotrifluoroethylene; polyesters; polyurethanes; polycarbonates; amino resins, such as urea-formaldehyde resins; and epoxy resins.

The coating resin layer may contain a (meth)acrylic resin having a ring structure, preferably an alicyclic (meth)acrylic resin, for fog control reasons.

The monomer component of the alicyclic (meth)acrylic resin may be a lower-alkyl (meth)acrylate (e.g., an alkyl (meth)acrylate having a C1 to C9 alkyl group), and specific examples include methyl (meth)acrylate, ethyl (meth)acrylate, propyl (meth)acrylate, butyl (meth)acrylate, hexyl (meth)acrylate, cyclohexyl (meth)acrylate, 2-ethylhexyl (meth)acrylate, and 2-(dimethylamino)ethyl (meth)acrylate.

For further reduced unevenness in image density, the monomer component of the alicyclic (meth)acrylic resin may include at least one selected from the group consisting of methyl (meth)acrylate, cyclohexyl (meth)acrylate, and 2-(dimethylamino)ethyl methacrylate in particular, preferably at least one of methyl (meth)acrylate or cyclohexyl (meth)acrylate. The monomer component of the alicyclic acrylic resin may be one monomer or may be a combination of two or more monomers.

Alicyclic (meth)acrylic resins may protect their polarized carbon-oxygen bonds from the impact of water with steric hindrance by the alicyclic functional group. The monomer component may be cyclohexyl (meth)acrylate because it may help reduce the impact of water associated with changes in the environment.

The cyclohexyl (meth)acrylate content of the alicyclic (meth)acrylic resin may be 75 mol % or more and 100 mol % or less, preferably 90 mol % or more and 100 mol % or less, more preferably 95 mol % or more and 100 mol % or less.

The percentage of the alicyclic (meth)acrylic resin to all resins in the coating resin layer may be 80% by mass or more, preferably 90% by mass or more, more preferably 95% by mass or more.

### Inorganic Particles

Examples of inorganic particles include particles of silica, alumina, titanium dioxide (titania), barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, calcium carbonate, silicon carbide, and silicon nitride. For further reduced unevenness in image density, the inorganic particles may be one or more types of particles selected from the group consisting of silica, alumina, and titanium oxide particles in particular, preferably silica particles. The silica particles may be fumed silica particles.

The inorganic particles may include inorganic particles hydrophobized with a hydrophobizing agent, preferably hydrophobized silica particles.

Examples of hydrophobizing agents include known surface treatment agents, specifically silane coupling agents and silicone oils.

Examples of silane coupling agents include hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, γ-methacryloxypropyltrimethoxysilane, and vinyltriacetoxysilane.

Examples of silicone oils include dimethylpolysiloxane, methyl hydrogen polysiloxane, and methylphenylpolysiloxane.

The hydrophobizing agent may be at least one of hexamethyldisilazane (HMDS) or dimethylpolysiloxane (PDMS) in particular, preferably HMDS.

The inorganic particle content may be 3% by mass or more and 70% by mass or less, preferably 10% by mass or more and 60% by mass or less, more preferably 10% by mass or more and 50% by mass or less, even more preferably 20% by mass or more and 40% by mass or less of the total mass of the coating resin layer for fog control reasons.

Examples of methods for forming the coating resin layer on the surface of the core include wet and dry processes. Wet processes are processes in which the resin to form the coating resin layer is dissolved or dispersed in a solvent. Dry processes are processes in which no such solvent is used.

Examples of wet processes include dipping, in which the core is dipped into a resin solution for the formation of the coating resin layer; spraying, in which a resin solution for the formation of the coating resin layer is sprayed onto the surface of the core; fluidized bed coating, in which a resin solution for the formation of the coating resin layer is sprayed onto a core floated in a fluidized bed; and kneader-coater coating, in which the core and a resin solution for the formation of the coating resin layer are mixed together in a kneader-coater, followed by the removal of the solvent.

The resin solution for the formation of the coating resin layer used in wet processes is prepared by dissolving or dispersing the resin and other ingredients in a solvent. The solvent can be any solvent that dissolves the resin or allows the resin to disperse therein, and examples include aromatic hydrocarbons, such as toluene and xylene; ketones, such as acetone and methyl ethyl ketone; and ethers, such as tetrahydrofuran and dioxane.

An example of a dry process is to form the coating resin layer by heating a dry mixture of the core and the resin for the formation of the coating resin layer. Specifically, for example, the coating resin layer is formed by mixing the core and the resin for the formation of the coating resin layer together in a gas phase and melting the mixture by heating.

The average thickness T (μm) of the coating resin layer may be 0.1 μm or more and 10 μm or less, preferably 0.2 μm or more and 5 μm or less, more preferably 0.3 μm or more and 3 μm or less.

The average thickness T of the coating resin layer is measured as follows. The carrier is embedded in a piece of epoxy resin or similar medium, and the resulting structure is sliced, for example with a diamond knife. The resulting slice is observed under an imager, such as a transmission electron microscope (TEM), and the cross-section of multiple carrier particles is imaged. On the cross-sectional images of the carrier particles, the thickness of the coating resin layer is measured at 20 points, and the average is used.

The electrostatic charge image developer according to this exemplary embodiment is prepared by mixing the toner A and the carrier B in certain proportions. The mix ratio (by mass) between the toner A and the carrier B (toner:carrier) may be from 1:100 to 30:100, preferably from 3:100 to 20:100.

### Image Forming Apparatus and Image Forming Method

An image forming apparatus and an image forming method according to exemplary embodiments will now be described.

An image forming apparatus according to an exemplary embodiment includes an image carrier; a charging component that charges the surface of the image carrier; an electrostatic charge image creating component that creates an electrostatic charge image on the charged surface of the image carrier; a developing component that contains an electrostatic charge image developer and develops, using the electrostatic charge image developer, the electrostatic charge image on the surface of the image carrier to form a toner image; a transfer component that transfers the toner image on the surface of the image carrier to the surface of a recording medium; and a fixing component that fixes the toner image on the surface of the recording medium. The electrostatic charge image developer is an electrostatic charge image developer according to the above exemplary embodiment.

The image forming apparatus according to this exemplary embodiment implements an image forming method that includes a charging step, in which the surface of an image carrier is charged; an electrostatic charge image creation step, in which an electrostatic charge image is created on the charged surface of the image carrier; a development step, in which the electrostatic charge image on the surface of the image carrier is developed into a toner image using an electrostatic charge image developer according to the above exemplary embodiment; a transfer step, in which the toner image on the surface of the image carrier is transferred to the surface of a recording medium; and a fixation step, in which the toner image on the surface of the recording medium is fixed (image forming method according to an exemplary embodiment).

The structure of the image forming apparatus according to this exemplary embodiment can be applied to known types of image forming apparatuses, including a direct-transfer image forming apparatus, which forms a toner image on the surface of an image carrier and transfers it directly to a recording medium; an intermediate-transfer image forming apparatus, which forms a toner image on the surface of an image carrier, transfers it to the surface of an intermediate transfer body (first transfer), and then transfers the toner image on the surface of the intermediate transfer body to the surface of a recording medium (second transfer); an image forming apparatus having a cleaning component that cleans the surface of the image carrier between the transfer of the toner image and charging; and an image forming apparatus having a static eliminator that removes static electricity from the surface of the image carrier by irradiating the surface with antistatic light between the transfer of the toner image and charging.

If an image forming apparatus according to this exemplary embodiment is of intermediate-transfer type, its transfer component includes, for example, an intermediate transfer body, the surface of which is for a toner image to be transferred to; a first transfer component, which transfers the toner image formed on the surface of the image carrier to the surface of the intermediate transfer body (first transfer); and a second transfer component, which transfers the toner image on the surface of the intermediate transfer body to the surface of a recording medium (second transfer).

Part of the image forming apparatus according to this exemplary embodiment, such as a portion including the developing component, may have a cartridge structure, a structure that allows the part to be detached from and attached to the image forming apparatus (or may be a process cartridge). An example of a process cartridge is a process cartridge that contains an electrostatic charge image developer according to the above exemplary embodiment and includes the developing component.

An example of an image forming apparatus according to this exemplary embodiment will now be presented; the apparatus, however, is not limited to the example below. Some of its structural elements will be described with reference to a drawing.

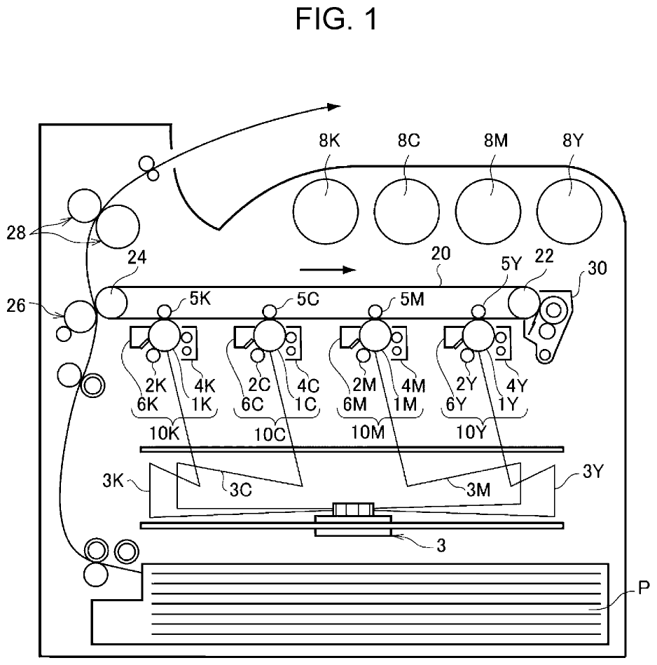

FIG. 1 is a schematic diagram illustrating the structure of an image forming apparatus according to this exemplary embodiment.

The image forming apparatus illustrated in FIG. 1 includes first to fourth electrophotographic image forming units 10Y, 10M, 10C, and 10K (image forming component), which produce images in the colors of yellow (Y), magenta (M), cyan (C), and black (K), respectively, based on color-separated image data. These image forming units (hereinafter also referred to simply as “units”) 10Y, 10M, 10C, and 10K are arranged in a horizontal row with a predetermined distance therebetween. The units 10Y, 10M, 10C, and 10K may be process cartridges; the units may be detachable from and attachable to the image forming apparatus.

Above the units 10Y, 10M, 10C, and 10K, an intermediate transfer belt (example of an intermediate transfer body) 20 extends through each unit. The intermediate transfer belt 20 is wound over a drive roller 22 and a support roller 24 and runs in the direction from the first unit 10Y toward the fourth unit 10K. The support roller 24 is urged by a spring or similar mechanism, not illustrated in the drawing, away from the drive roller 22 to place tension on the intermediate transfer belt 20 wound over the two rollers. The surface of the intermediate transfer belt 20 closer to image carriers is provided with an intermediate transfer medium cleaner 30 facing the drive roller 22.

Developing devices (example of a developing component) 4Y, 4M, 4C, and 4K in the units 10Y, 10M, 10C, and 10K are supplied with yellow, magenta, cyan, and black toners, respectively, contained in toner cartridges 8Y, 8M, 8C, and 8K.

The first to fourth units 10Y, 10M, 10C, and 10K are equivalent in structure and operation; in the following, therefore, the first unit 10Y, located upstream of the others in the direction of running of the intermediate transfer belt 20 and configured to produce a yellow image, will be described on behalf of the four.

The first unit 10Y has a photoreceptor 1Y that acts as an image carrier. Around the photoreceptor 1Y are a charging roller (example of a charging component) 2Y, which charges the surface of the photoreceptor 1Y to a predetermined potential; an exposure device (example of an electrostatic charge image creating component) 3, which irradiates the charged surface with a laser beam 3Y generated based on a color-separated image signal to create an electrostatic charge image there; a developing device (example of a developing component) 4Y, which supplies charged toner to the electrostatic charge image to develop the electrostatic charge image; a first transfer roller (example of a first transfer component) 5Y, which transfers the developed toner image to the intermediate transfer belt 20; and a photoreceptor cleaner (example of a cleaning component) 6Y, which removes residual toner off the surface of the photoreceptor 1Y after the first transfer, arranged in this order.

The first transfer roller 5Y is inside the intermediate transfer belt 20 and is positioned to face the photoreceptor 1Y. The first transfer roller 5Y, 5M, 5C, or 5K in each unit is connected to a bias power supply (not illustrated), which applies a first transfer bias to the roller. Each bias power supply is controlled by a controller, not illustrated in the drawing, to change the value of the transfer bias applied by the bias power supply to the corresponding first transfer roller.

The operation in the formation of a yellow image at the first unit 10Y will now be described.

First, before the operation, the surface of the photoreceptor 1Y is charged by the charging roller 2Y to a potential of −600 V to −800 V.

The photoreceptor 1Y includes an electrically conductive substrate (e.g., having a volume resistivity at 20° C. of 1×10⁻⁶ Ω·cm or less) and a photosensitive layer placed thereon. This photosensitive layer has high electrical resistance (the resistance of a typical resin) in its normal state, but once it is irradiated with a laser beam, the resistivity of the irradiated portion changes. Thus, a laser beam 3Y is emitted from the exposure device 3 onto the charged surface of the photoreceptor 1Y according to image data for yellow sent from a controller, not illustrated in the drawing. As a result, an electrostatic charge image of a yellow image pattern is created on the surface of the photoreceptor 1Y.

The electrostatic charge image is an image created on the surface of the photoreceptor 1Y by electrical charging and is a so-called negative latent image; it is created as a result of the charge on the surface of the photoreceptor 1Y flowing away in the irradiated portion of the photosensitive layer in response to a resistivity decrease caused by the exposure to the laser beam 3Y while staying in the portion not irradiated with the laser beam 3Y.

The electrostatic charge image created on the photoreceptor 1Y rotates to a predetermined development point as the photoreceptor 1Y runs. At this development point, the electrostatic charge image on the photoreceptor 1Y is developed into a toner image, or visualized, by the developing device 4Y.

Inside the developing device 4Y is an electrostatic charge image developer that contains, for example, at least yellow toner and a carrier. The yellow toner is on a developer roller (example of a developer carrier) and has been triboelectrically charged with the same polarity as the charge on the photoreceptor 1Y (negative) through stirring inside the developing device 4Y. As the surface of the photoreceptor 1Y passes through the developing device 4Y, the yellow toner electrostatically adheres to the uncharged, latent-image area of the surface of the photoreceptor 1Y, and the latent image is developed by the yellow toner. The photoreceptor 1Y, now having a yellow toner image thereon, continues running at a predetermined speed, and the toner image developed thereon is transported to a predetermined first transfer point.

After the transport of the yellow toner image on the photoreceptor 1Y to the first transfer point, a first transfer bias is applied to the first transfer roller 5Y, and an electrostatic force acts on the toner image in the direction from the photoreceptor 1Y toward the first transfer roller 5Y to cause the toner image to be transferred from the photoreceptor 1Y to the intermediate transfer belt 20. The applied transfer bias has the (+) polarity, opposite the polarity of the toner (−), and its amount has been controlled, for example to +10 μA for the first unit 10Y, by a controller (not illustrated).

Residual toner on the photoreceptor 1Y is removed and collected at the photoreceptor cleaner 6Y.

The first transfer biases applied to the first transfer rollers 5M, 5C, and 5K in the second, third, and fourth units 10M, 10C, and 10K have also been controlled in the same manner as that for the first unit 10Y.

The intermediate transfer belt 20 to which a yellow toner image has been transferred at the first unit 10Y in this manner is then transported through the second to fourth units 10M, 10C, and 10K sequentially; as a result, toner images in the respective colors are overlaid to complete multilayer transfer.

The intermediate transfer belt 20 that has passed through the first to fourth units and thereby completed multilayer transfer of toner images in four colors then reaches a second transfer section, which is a section formed by the intermediate transfer belt 20, the support roller 24, which touches the inner surface of the intermediate transfer belt 20, and a second transfer roller (example of a second transfer component) 26, which is located by the image-carrying surface of the intermediate transfer belt 20. Recording paper (example of a recording medium) P is fed to the point of contact between the second transfer roller 26 and the intermediate transfer belt 20 in a timed manner by a feeding mechanism, and a second transfer bias is applied to the support roller 24. The applied transfer bias has the (−) polarity, the same as the polarity of the toner (−), and an electrostatic force acts on the toner image in the direction from the intermediate transfer belt 20 toward the recording paper P to cause the toner image to be transferred from the intermediate transfer belt 20 to the recording paper P. The amount of the second transfer bias is determined according to resistance detected by a resistance detector (not illustrated) configured to detect the electrical resistance of the second transfer section and has been controlled.

After that, the recording paper P is delivered to the point of pressure contact (nip) between a pair of fixing rollers at a fixing device (example of a fixing component) 28, and the toner image is fixed on the recording paper P there to give a fixed image.

The recording paper P to which the toner image is transferred can be, for example, ordinary printing paper for copiers, printers, etc., of electrophotographic type. Besides recording paper P, OHP sheets, for example, are also examples of recording media that may be used.

The use of recording paper P having a smooth surface may help further improve the smoothness of the surface of the fixed image; for example, coated paper, which is paper with a resin or other coating on its surface, or art paper for printing may be used.

The recording paper P with a completely fixed color image thereon is transported to an ejection section to finish the operation of forming a color image.

### Process Cartridge and Toner Cartridge

A process cartridge according to an exemplary embodiment will now be described.

A process cartridge according to this exemplary embodiment is a process cartridge attachable to and detachable from an image forming apparatus and includes a developing component that contains an electrostatic charge image developer according to the above exemplary embodiment and develops, using the electrostatic charge image developer, an electrostatic charge image created on the surface of an image carrier to form a toner image.

The structure of the process cartridge according to this exemplary embodiment does not need to be as described above; the process cartridge may include the developing component and optionally at least one selected from other components, such as an image carrier, a charging component, an electrostatic charge image creating component, and a transfer component.

An example of a process cartridge according to this exemplary embodiment will now be presented; the cartridge, however, is not limited to the example below. Some of its structural elements will be described with reference to a drawing.

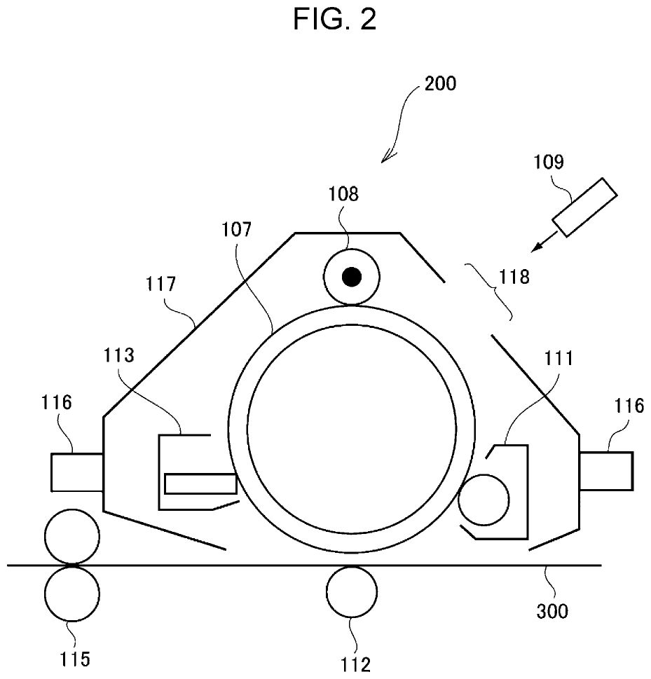

FIG. 2 is a schematic diagram illustrating the structure of a process cartridge according to this exemplary embodiment.

The process cartridge 200 illustrated in FIG. 2 is a cartridge containing, for example, a photoreceptor 107 (example of an image carrier) and a charging roller 108 (example of a charging component), a developing device 111 (example of a developing component), and a photoreceptor cleaner 113 (example of a cleaning component) arranged around the photoreceptor 107, all held together in a housing 117 having attachment rails 116 and an opening 118 for exposure to light.

FIG. 2 also illustrates an exposure device (example of an electrostatic charge image creating component) 109, a transfer device (example of a transfer component) 112, a fixing device (example of a fixing component) 115, and recording paper (example of a recording medium) 300.

A toner cartridge used in an exemplary embodiment will now be described.

A toner cartridge used in this exemplary embodiment is a toner cartridge that contains toner used in the above exemplary embodiment and is attachable to and detachable from an image forming apparatus. A toner cartridge is a cartridge that contains replenishment toner to be supplied to a developing component placed inside an image forming apparatus.

The image forming apparatus illustrated in FIG. 1 includes toner cartridges 8Y, 8M, 8C, and 8K detachable from and attachable to it, and the developing devices 4Y, 4M, 4C, and 4K are connected to their corresponding toner cartridges (or the toner cartridges for their respective colors) by toner supply tubing, not illustrated in the drawing. When there is little toner remaining in a toner cartridge, this toner cartridge is replaced.

### EXAMPLES

Exemplary embodiments of the present disclosure will now be described in detail by examples; exemplary embodiments of the present disclosure, however, are not limited to these examples.

In the following description, “parts” and “%” are by mass unless stated otherwise.

The procedures described below, such as synthesis, treatment, and production, are carried out at room temperature (25° C.±3° C.) unless stated otherwise.

### Preparation of Particle Dispersions

### Preparation of Amorphous Resin Particle Dispersion (1-1)

Terephthalic acid: 28 parts
Fumaric acid: 164 parts
Adipic acid: 10 parts
A 2-mole ethylene oxide adduct of bisphenol A: 26 parts
A 2-mole propylene oxide adduct of bisphenol A: 542 parts

These ingredients are loaded into a reaction vessel having a stirring device, a nitrogen inlet tube, a temperature sensor, and a rectifying column, the temperature is raised to 190° C. over 1 hour, and 1.2 parts of dibutyl tin oxide is added to 100 parts of the ingredients. The temperature is raised to 240° C. over 6 hours while the water produced is removed by distillation, the temperature is maintained at 240° C. for 3 hours of continued dehydration condensation, and then the reaction product is cooled.

The molten product is transferred to Cavitron CD1010 (Eurotec) at a speed of 100 g per minute. At the same time, a separately prepared 0.37% aqueous ammonia is transferred to Cavitron CD1010 at a speed of 0.1 liters per minute while heated to 120° C. in a heat exchanger. Cavitron CD1010 is operated at a rotor frequency of 60 Hz and a pressure of 5 kg/cm², giving a liquid dispersion in which particles of an amorphous polyester resin have been dispersed, the volume-average diameter of the particles being 169 nm. The solids content of this resin particle dispersion is adjusted to 20% with deionized water, and the product is amorphous resin particle dispersion (1-1). The SP (R) of the amorphous polyester resin is 9.41.

### Preparation of Amorphous Resin Particle Dispersion (1-2)

Styrene: 72 parts
n-butyl acrylate: 27 parts
2-Carboxyethyl acrylic acid: 1.3 parts
Dodecanethiol: 2 parts

These materials are mixed until dissolution, and the resulting solution is dispersed in a solution of 1.2 parts of an anionic surfactant (TaycaPower, Tayca Corporation) in 100 parts of deionized water in a flask to give an emulsion. Then a solution of 6 parts of ammonium persulfate in 50 parts of deionized water is put into the flask with stirring over 20 minutes. After nitrogen purging, the flask is heated in an oil bath with stirring until a temperature of the contents of 75° C. and maintained at 75° C. for 4 hours for continued emulsion polymerization. This gives a liquid dispersion in which particles of an amorphous styrene-acrylic resin have been dispersed, the volume-average diameter of the particles being 160 nm and the weight-average molecular weight of the resin being 56,000. The solids content of this resin particle dispersion is adjusted to 31.4% with deionized water, and the product is amorphous resin particle dispersion (1-2). The SP (R) of the amorphous styrene-acrylic resin is 9.14.

### Preparation of Amorphous Resin Particle Dispersion (1-3)

Terephthalic acid: 28 parts
Fumaric acid: 174 parts
A 2-mole ethylene oxide adduct of bisphenol A: 26 parts
A 2-mole propylene oxide adduct of bisphenol A: 542 parts

These ingredients are loaded into a reaction vessel having a stirring device, a nitrogen inlet tube, a temperature sensor, and a rectifying column, the temperature is raised to 190° C. over 1 hour, and 1.2 parts of dibutyl tin oxide is added to 100 parts of the ingredients. The temperature is raised to 240° C. over 6 hours while the water produced is removed by distillation, the temperature is maintained at 240° C. for 3 hours of continued dehydration condensation, and then the reaction product is cooled.

The molten product is transferred to Cavitron CD1010 (Eurotec) at a speed of 100 g per minute. At the same time, a separately prepared 0.37% by mass aqueous ammonia is transferred to Cavitron CD1010 at a speed of 0.1 liters per minute while heated to 120° C. in a heat exchanger. Cavitron CD1010 is operated at a rotor frequency of 60 Hz and a pressure of 5 kg/cm², giving a liquid dispersion in which particles of an amorphous polyester resin have been dispersed, the volume-average diameter of the particles being 175 nm. The solids content of this resin particle dispersion is adjusted to 20% by mass with deionized water, and the product is amorphous resin particle dispersion (1-3).

The SP (R) of the amorphous polyester resin is 9.43.

### Preparation of Crystalline Resin Particle Dispersion (1-4)

1,10-Dodecanedioic acid: 225 parts
1,6-Hexanediol: 143 parts

These ingredients are loaded into a reaction vessel having a stirring device, a nitrogen inlet tube, a temperature sensor, and a rectifying column, the temperature is raised to 160° C. over 1 hour, and 0.8 parts of dibutyl tin oxide is added. The temperature is raised to 180° C. over 6 hours while the water produced is removed by distillation, and the temperature is maintained at 180° C. for 5 hours of continued dehydration condensation. Then the temperature is increased gradually to 230° C. under reduced pressure, and the solution is stirred for 2 hours at 230° C. Then the reaction product is cooled, solid-liquid separation is carried out, and the solids are dried to give a crystalline polyester resin.
Crystalline polyester resin: 100 parts
Methyl ethyl ketone: 40 parts
Isopropyl alcohol: 30 parts
A 10% aqueous solution of ammonia: 6 parts

These ingredients are loaded into a jacketed reaction vessel having a condenser, a thermometer, a water dispenser, and an anchor blade and mixed together by stirring at 100 rpm with the liquid temperature maintained at 80° C. using a circulating water bath so that the resin will dissolve. Then the circulating water bath is set to 50° C., and a total of 400 parts of deionized water kept at 50° C. is added dropwise at a speed of 7 parts/minute to give an emulsion. The emulsion, 576 parts, and 500 parts of deionized water are put into a recovery flask, and this recovery flask is attached to an evaporator having a vacuum control unit, with a trap between the flask and the evaporator. The solvent is removed by rotating the recovery flask in a water bath at 60° C. and reducing the pressure to 7 kPa, with care taken to prevent bumping. The volume-average diameter of resin particles in the resulting liquid dispersion is 185 nm. Deionized water is added to make the solids content 22.1%; the product is crystalline resin particle dispersion (1-4).

### Preparation of Resin Particle Dispersion (2-1)

Styrene: 47.9 parts
n-butyl acrylate: 51.8 parts
2-Carboxyethyl acrylate: 0.3 parts
1,10-Decanediol diacrylate: 1.65 parts
An anionic surfactant (Dow Chemical, Dowfax 2A1): 0.8 parts

These ingredients are put into a flask, mixed until dissolution, and dispersed with 60 parts of deionized water to give an emulsion. One part of the emulsion is added to a solution of 1.3 parts of an anionic surfactant (Dow Chemical, Dowfax 2A1) in 90 parts of deionized water, and then a solution of 5.4 parts of ammonium persulfate in 10 parts of deionized water is added. Then the rest of the emulsion is added over 180 minutes. The inside of the flask is purged with nitrogen, and the solution temperature is raised to 65° C. in an oil bath while the solution inside the flask is stirred. Then the stirring is continued for 500 minutes with the solution temperature kept at 65° C. so that emulsion polymerization will occur. After completed stirring, the solids content is adjusted to 24.5% with deionized water; the product is resin particle dispersion (2-1).

### Preparation of Resin Particle Dispersions (2-2) to (2-14), (2-C1), and (2-C2)

Resin particle dispersions (2-2) to (2-14), (2-C1), and (2-C2) are obtained in the same manner as resin particle dispersion (2-1), except that the following are changed as in Table 1: the amounts of styrene, n-butyl acrylate, acrylic acid, and 2-carboxyethyl (meth)acrylate, the total amount of the anionic surfactant, the amount of the crosslinker, the crosslinker used (type of crosslinker in the table), the amount of ammonium peroxide, the temperature to which the solution is heated in an oil bath (polymerization temperature in the table), the time over which the rest of the emulsion is added (time of addition in the table), and the duration of emulsion polymerization after heating (retention time in the table).

Table 1 also includes the number of carbon atoms in the alkylene group in the crosslinker added (carbons in the table).

TABLE 1

| | Ingredients | | | | | | | | | | | |
|---|---|---|---|---|---|---|---|---|---|---|---|---|
| | | | | 2- | | Crosslinker | | | Formula | | | |
| | | | | Carbox- | Anionic | | | Carbons in | | Polymer- | | |
| Resin | | n-butyl | Acrylic | yethyl | surfac- | | Type of | the alkyl | Ammonium | ization | Time of | Retention |
| particle | Styrene | acrylate | acid | acrylate | tant | Amount | crosslinker | moiety | persulfate | temperature | addition | time |
| dispersion | Parts | Parts | Parts | Parts | Parts | Parts | — | — | Parts | ° C. | Minutes | Minutes |
| (2-1) | 47.9 | 51.8 | 0 | 0.30 | 2.10 | 1.65 | 1,10- | 10 | 5.4 | 65 | 180 | 500 |
| | | | | | | | Decanediol | | | | | |
| | | | | | | | diacrylate | | | | | |
| (2-2) | 54.5 | 44.6 | 0 | 0.84 | 1.26 | 1.65 | 1,10- | 10 | 5.4 | 65 | 180 | 500 |
| | | | | | | | Decanediol | | | | | |
| | | | | | | | diacrylate | | | | | |
| (2-3) | 34.8 | 64.1 | 0 | 0.84 | 1.26 | 1.65 | 1,10- | 10 | 5.4 | 65 | 180 | 500 |
| | | | | | | | Decanediol | | | | | |
| | | | | | | | diacrylate | | | | | |
| (2-4) | 47.9 | 51.8 | 0 | 0.30 | 2.50 | 1.65 | 1,10- | 10 | 11.2 | 75 | 180 | 350 |
| | | | | | | | Decanediol | | | | | |
| | | | | | | | diacrylate | | | | | |
| (2-5) | 47.9 | 51.8 | 0 | 0.30 | 2.30 | 3.10 | 1,10- | 10 | 6.1 | 65 | 180 | 500 |
| | | | | | | | Decanediol | | | | | |
| | | | | | | | diacrylate | | | | | |
| (2-6) | 47.9 | 51.8 | 0 | 0.30 | 1.20 | 1.65 | 1,10- | 10 | 5.4 | 65 | 180 | 500 |
| | | | | | | | Decanediol | | | | | |
| | | | | | | | diacrylate | | | | | |
| (2-7) | 47.9 | 51.8 | 0 | 0.30 | 2.90 | 1.65 | 1,10- | 10 | 5.4 | 65 | 180 | 500 |
| | | | | | | | Decanediol | | | | | |
| | | | | | | | diacrylate | | | | | |
| (2-8) | 47.9 | 51.8 | 0 | 0.30 | 1.00 | 1.65 | 1,10- | 10 | 5.4 | 65 | 180 | 500 |
| | | | | | | | Decanediol | | | | | |
| | | | | | | | diacrylate | | | | | |
| (2-9) | 47.9 | 51.8 | 0 | 0.30 | 3.10 | 1.65 | 1,10- | 10 | 5.4 | 65 | 180 | 500 |
| | | | | | | | Decanediol | | | | | |
| | | | | | | | diacrylate | | | | | |
| (2-10) | 46.8 | 48.9 | 2 | 0.30 | 2.10 | 1.65 | 1,10- | 10 | 5.4 | 65 | 180 | 500 |
| | | | | | | | Decanediol | | | | | |
| | | | | | | | diacrylate | | | | | |
| (2-11) | 47.9 | 51.8 | 0 | 0.84 | 1.26 | 1.65 | 1,6- | 6 | 5.4 | 65 | 180 | 500 |
| | | | | | | | Hexanediol | | | | | |
| | | | | | | | diacrylate | | | | | |
| (2-12) | 47.9 | 51.8 | 0 | 0.84 | 1.26 | 1.65 | 1,4- | 4 | 5.4 | 65 | 180 | 500 |
| | | | | | | | Butanediol | | | | | |
| | | | | | | | diacrylate | | | | | |
| (2-C1) | 53.8 | 45.9 | 0 | 0.30 | 2.10 | 0.36 | 1,10- | 10 | 11 | 75 | 120 | 300 |
| | | | | | | | Decanediol | | | | | |
| | | | | | | | diacrylate | | | | | |
| (2-C2) | 42.9 | 56.8 | 0 | 0.30 | 1.80 | 0.67 | 1,10- | 10 | 5.7 | 60 | 240 | 700 |
| | | | | | | | Decanediol | | | | | |
| | | | | | | | diacrylate | | | | | |
| (2-13) | 56.8 | 42.6 | 0 | 0.84 | 1.26 | 1.65 | 1,10- | 10 | 5.4 | 65 | 180 | 500 |
| | | | | | | | Decanediol | | | | | |
| | | | | | | | diacrylate | | | | | |
| (2-14) | 30.8 | 69.1 | 0 | 0.84 | 1.26 | 1.65 | 1,10- | 10 | 5.4 | 65 | 180 | 500 |
| | | | | | | | Decanediol | | | | | |
| | | | | | | | diacrylate | | | | | |

For the resin particles in the resulting resin particle dispersions, the following parameters as determined by the methods described above are presented in Table 2: glass transition temperature Tg (“Tg” in the table), minimum and maximum storage moduli at 90° C. or above and 150° C. or below G′(p90-150) (“G′ (min) at 90° C. to 150° C.” and “G′ (max) at 90° C. to 150° C.,” respectively, in the table), minimum and maximum loss tangents tan δ at temperatures of 30° C. or above and 150° C. or below (“tan δ (min)” and “tan δ (max),” respectively, in the table), and minimum and maximum loss tangents tan δ at temperatures of 65° C. or above and 150° C. or below (“Min. tan δ at 65° C. to 150° C.” and “Max. tan δ at 65° C. to 150° C.,” respectively, in the table), all of which are determined by dynamic rheometry, the number-average diameter (“Number-average size” in the table), and SP (S).

TABLE 2

| | Glass | G′ | G′ | | | Min. | Max. | | |
|---|---|---|---|---|---|---|---|---|---|
| | transition | (min) at | (max) at | | | tanδ at | tanδ at | Number- | |
| Resin | temperature | 90° C. to | 90° C. to | tanδ | tanδ | 65° C. to | 65° C. to | average | |
| particle | Tg | 150° C. | 150° C. | (min) | (max) | 150° C. | 150° C. | size | SP (S) |
| dispersion | ° C. | Pa | Pa | — | — | — | — | nm | (cal/cm³)^{1/2} |
| (2-1) | 32.1 | 2.6 × 10⁵ | 5.1 × 10⁵ | 0.028 | 2.35 | 0.028 | 0.203 | 153 | 9.07 |
| (2-2) | 44.3 | 3.8 × 10⁵ | 5.9 × 10⁵ | 0.028 | 2.41 | 0.028 | 0.411 | 163 | 9.09 |
| (2-3) | 12.5 | 3.3 × 10⁵ | 5.7 × 10⁵ | 0.029 | 2.49 | 0.029 | 0.237 | 159 | 9.01 |
| (2-4) | 29.8 | 2.7 × 10⁵ | 6.1 × 10⁵ | 0.043 | 2.45 | 0.043 | 0.401 | 112 | 9.07 |
| (2-5) | 23.7 | 3.1 × 10⁵ | 5.8 × 10⁵ | 0.014 | 2.37 | 0.014 | 0.189 | 135 | 9.07 |
| (2-6) | 32.4 | 2.8 × 10⁵ | 5.9 × 10⁵ | 0.031 | 2.29 | 0.031 | 0.245 | 291 | 9.07 |
| (2-7) | 32.1 | 2.7 × 10⁵ | 6.2 × 10⁵ | 0.033 | 2.31 | 0.033 | 0.239 | 64 | 9.07 |
| (2-8) | 32.5 | 3.0 × 10⁵ | 7.1 × 10⁵ | 0.029 | 2.32 | 0.029 | 0.226 | 305 | 9.07 |
| (2-9) | 32.8 | 3.0 × 10⁵ | 7.1 × 10⁵ | 0.034 | 2.36 | 0.034 | 0.228 | 57 | 9.07 |
| (2-10) | 31.5 | 2.7 × 10⁵ | 7.2 × 10⁵ | 0.031 | 2.39 | 0.031 | 0.214 | 162 | 9.13 |
| (2-11) | 34.1 | 3.6 × 10⁵ | 5.8 × 10⁵ | 0.029 | 2.25 | 0.028 | 0.197 | 165 | 9.07 |
| (2-12) | 35.2 | 4.6 × 10⁵ | 6.6 × 10⁵ | 0.021 | 2.29 | 0.021 | 0.189 | 159 | 9.07 |
| (2-C1) | 39.8 | 2.9 × 10⁵ | 6.9 × 10⁵ | 0.026 | 2.45 | 0.026 | 0.221 | 165 | 9.10 |
| (2-C2) | 22.6 | 3.4 × 10⁵ | 6.3 × 10⁵ | 0.090 | 2.32 | 0.033 | 0.631 | 190 | 9.09 |
| (2-13) | 46.5 | 4.8 × 10⁵ | 6.8 × 10⁵ | 0.026 | 2.36 | 0.028 | 0.513 | 154 | 9.12 |
| (2-14) | 9.4 | 3.3 × 10⁵ | 5.8 × 10⁵ | 0.031 | 2.38 | 0.027 | 0.226 | 171 | 8.98 |

### Preparation of Coloring Agent Particle Dispersion (1)

A cyan pigment (Pigment Blue 15:3, Dainichiseika Color & Chemicals Mfg. Co., Ltd.): 98 parts
An anionic surfactant (TaycaPower, Tayca Corporation): 2 parts
Deionized water: 420 parts

These ingredients are mixed together and dispersed for 10 minutes using a homogenizer (IKA ULTRA-TURRAX); the product is coloring agent particle dispersion (1), in which the volume-average diameter of particles is 164 nm, and the solids content is 21.1%.

### Preparation of Release Agent Particle Dispersion (1)

A synthetic wax (FNP92, Nippon Seiro Co., Ltd.): 50 parts
An anionic surfactant (TaycaPower, Tayca Corporation): 1 part
Deionized water: 200 parts

These ingredients are mixed together, heated to 130° C., fully dispersed using a homogenizer (ULTRA-TURRAX T50, IKA), and then further dispersed using a pressure-pump homogenizer. When the volume-average diameter of particles reaches 200 nm, the dispersion is collected; the product is release agent particle dispersion (1), the solids content of which is 20%.

### Production of Toner Particles

### Production of Toner Particles 1

Amorphous resin particle dispersion (1-1): 169 parts
Crystalline resin particle dispersion (1-4): 53 parts
Resin particle dispersion (2-1): 33 parts
Coloring agent dispersion (1): 33 parts
Release agent dispersion (1): 25 parts
An anionic surfactant (Dow Chemical, Dowfax 2A1): 4.8 parts

These ingredients, conditioned to a liquid temperature of 10° C. beforehand, are put into a cylindrical stainless-steel vessel and mixed together by 2 minutes of dispersion under shear at 4,000 rpm using a homogenizer (IKA, ULTRA-TURRAX T50). Then 1.75 parts of a 10% solution of aluminum sulfate in sulfuric acid as a flocculant is slowly added dropwise, and the mixture is dispersed for 10 minutes at a homogenizer speed of 10,000 rpm; the product is a stock dispersion.

The stock dispersion is transferred to a reaction vessel having a twin-paddle stirring blade and a thermometer, heating in a heating mantle is started with stirring at a speed of 550 rpm, the temperature of the dispersion is raised to 40° C., the pH of the stock dispersion is controlled to the range of 2.2 to 3.5 with 0.3 M (=mol/L) nitric acid and a 1 M aqueous solution of sodium hydroxide, and the temperature and the pH are maintained for approximately 2 hours so that aggregates will grow. Another liquid dispersion prepared by mixing 21 parts of amorphous resin particle dispersion (1-1) and 8 parts of resin particle dispersion (2-1) together is added, and the resulting mixture is maintained for 60 minutes so that resin particles will adhere to the surface of the aggregates. Then the temperature of the dispersion is raised to 53° C., another 21 parts of amorphous resin particle dispersion (1-1) is added, and the resulting mixture is maintained for 60 minutes so that resin particles will further adhere to the surface of the aggregates.

While the size and shape of the aggregates are examined using an optical microscope and a particle size analyzer, a group of aggregates is sorted out. Then the pH is adjusted to 7.8 with a 5% aqueous solution of sodium hydroxide, and the dispersion is maintained for 15 minutes. Then the pH is increased to 8.0 with a 5% aqueous solution of sodium hydroxide, and then the temperature of the dispersion is raised to 85° C. Two hours after the fusion of aggregates is observed under a microscope, the heating is stopped, and the dispersion is cooled at a rate of 1.0° C./min. Solid-liquid separation is carried out through a 20-μm mesh, washing in water is repeated, and then the residue is dried in a vacuum drier; the product is toner particles 1. The volume-average diameter of toner particles 1 is 5.3 μm.

### Production of Toner Particles 2 to 9, 29 to 32, C1, and C2

Toner particles 2 to 9, toner particles 29 to 32, and toner particles C1 and C2 are obtained in the same manner as toner 1, except that instead of resin particle dispersion (2-1), the resin particle dispersion indicated in Table 3 is used in an amount that will make the percentage of resin particles in the toner particles as a whole as in Table 3.

### Production of Toner Particles 10 to 13

Toner particles 10 to 13 are obtained in the same manner as toner particles 1, except that resin particle dispersion (2-1) is used in an amount that will make the percentage of resin particles in the toner particles as a whole as in Table 3 and that the amount of crystalline resin particle dispersion (1-4) is adjusted so that the percentage of the crystalline resin in the entire binder resin will be as in Table 3.

### Production of Toner Particles 14

Toner particles 14 are obtained in the same manner as toner particles 1, except that resin particle dispersion (2-1) is replaced with the resin particle dispersion indicated in Table 3 and that the amount of crystalline resin particle dispersion (1-4) is adjusted so that the percentage of the crystalline resin in the entire binder resin will be as in Table 3.

### Production of Toner Particles 15 and 28

Toner particles 15 and 28 are obtained in the same manner as toner particles 1, except that instead of amorphous resin particle dispersion (1-1), the amorphous resin particle dispersion indicated in Table 3 is used in the amount indicated in Table 3.

### Production of Toner Particles 16

Toner particles 16 are obtained in the same manner as in toner particles 1, except that the homogenizer speed is changed from 10,000 rpm to 5,000 rpm.

### Production of Toner Particles 17

Toner particles 17 are obtained in the same manner as toner particles 1, except that the amount of crystalline resin particle dispersion (1-4) is adjusted so that the percentage of the crystalline resin in the entire binder resin will be as in Table 3.

### Production of Toner Particles 18

Toner particles 18 are obtained in the same manner as toner particles 1, except that resin particle dispersion (2-1) is used in an amount that will make the percentage of resin particles in the toner particles as a whole as in Table 3 and that the amount of crystalline resin particle dispersion (1-4) is adjusted so that the percentage of the crystalline resin in the entire binder resin will be as in Table 3.

### Production of Toner Particles 19

Toner particles 19 are obtained in the same manner as toner particles 1, except that the pH at which aggregates are fused is changed from 8.0 to 9.0.

### Production of Toner Particles 20

Toner particles 20 are obtained in the same manner as toner particles 1, except that the pH at which aggregates are fused is changed from 8.0 to 5.5.

### Production of Toner Particles 21

Toner particles 21 are obtained in the same manner as toner particles 1, except that resin particle dispersion (2-1) is used in an amount that will make the percentage of resin particles in the toner particles as a whole as in Table 3 and that the pH at which aggregates are fused is changed from 8.0 to 9.5.

### Production of Toner Particles 22

Toner particles 22 are obtained in the same manner as toner particles 1, except that resin particle dispersion (2-1) is used in an amount that will make the percentage of resin particles in the toner particles as a whole as in Table 3, that the amount of resin particles (2-1) is changed from 10 to 19, and that the pH at which aggregates are fused is changed from 8.0 to 6.0.

### Production of Toner Particles 23 to 27

Toner particles 23 to 27 are obtained in the same manner as toner particles 1, except that instead of resin particle dispersion (2-1), the resin particle dispersion indicated in Table 3 is used in an amount that will make the percentage of resin particles in the toner particles as a whole as in Table 3 and that the amount of crystalline resin particle dispersion (1-4) is adjusted so that the percentage of the crystalline resin in the entire binder resin will be as in Table 3.

### Production of Toner Particles C3

Amorphous resin particle dispersion (1-1): 169 parts
Resin particle dispersion (2-1): 33 parts
Crystalline resin particle dispersion (1-4): 53 parts
Release agent dispersion (1): 25 parts
Coloring agent dispersion (1): 33 parts
An anionic surfactant (Dow Chemical, Dowfax 2A1): 4.8 parts

These raw materials, conditioned to a liquid temperature of 30° C. beforehand, are put into a cylindrical stainless-steel vessel and mixed together by 2 minutes of dispersion under shear at 4,000 rpm using a homogenizer (IKA, ULTRA-TURRAX T50).

Then 1.75 parts of a 10% solution of aluminum sulfate in sulfuric acid as a flocculant is slowly added dropwise, and the mixture is dispersed for 3 minutes at a homogenizer speed of 4,000 rpm; the product is a stock dispersion.

Then the stock dispersion is transferred to a polymerization pot having a stirring device with a twin-paddle stirring blade and a thermometer, heating in a heating mantle is started at a stirring speed of 550 rpm, and aggregates are allowed to grow at 40° C. During this, the pH of the stock dispersion is controlled to the range of 2.2 to 3.5 with 0.3 M nitric acid and a 1 M aqueous solution of sodium hydroxide. The dispersion is maintained in this pH range for approximately 2 hours so that aggregates will form.

Then another liquid dispersion prepared by mixing 21 parts of amorphous resin particle dispersion (1-1) and 8 parts of resin particle dispersion (2-1) together is added, and the resulting mixture is maintained for 60 minutes so that particles of a binder resin and resin particles will adhere to the surface of the aggregates. Then the temperature is raised to 53° C., another 21 parts of amorphous resin particle dispersion (1-1) is added, and the resulting mixture is maintained for 60 minutes so that particles of a binder resin will adhere to the surface of the aggregates.

While the size and shape of the aggregates are examined using an optical microscope and Multisizer 3, a group of aggregates is sorted out. Then the pH is adjusted to 7.8 with a 5% aqueous solution of sodium hydroxide, and the dispersion is maintained for 15 minutes.

Then the pH is increased to 8.0 for the fusion of the aggregates, and then the temperature is raised to 85° C. Two hours after the fusion of aggregates is observed under a microscope, the heating is stopped, and the dispersion is cooled at a cooling rate of 1.0° C./min. Then the dispersion is sieved through a 20-μm mesh, and washing in water is repeated, and then the residue is dried in a vacuum dryer; the product is toner particles C3.

### Production of Toner Particles C4

Amorphous resin particle dispersion (1-1): 169 parts
Resin particle dispersion (2-1): 41 parts
Crystalline resin particle dispersion (1-4): 53 parts
Release agent dispersion (1): 25 parts
Coloring agent dispersion (1): 33 parts
An anionic surfactant (Dow Chemical, Dowfax 2A1): 4.8 parts

These raw materials, conditioned to a liquid temperature of 30° C. beforehand, are put into a 3-L cylindrical stainless-steel vessel and mixed together by 2 minutes of dispersion under shear at 4,000 rpm using a homogenizer (IKA, ULTRA-TURRAX T50).

Then 1.75 parts of a 10% solution of aluminum sulfate in sulfuric acid as a flocculant is slowly added dropwise, and the mixture is dispersed for 3 minutes at a homogenizer speed of 4,000 rpm; the product is a stock dispersion.

Then the stock dispersion is transferred to a polymerization pot having a stirring device with a twin-paddle stirring blade and a thermometer, heating in a heating mantle is started at a stirring speed of 550 rpm, and aggregates are allowed to grow at 40° C. During this, the pH of the stock dispersion is controlled to the range of 2.2 to 3.5 with 0.3 M nitric acid and a 1 M aqueous solution of sodium hydroxide. The dispersion is maintained in this pH range for approximately 2 hours so that aggregates will form.

Then 42 parts of amorphous resin particle dispersion (1-1) is added, and the resulting mixture is maintained for 60 minutes so that particles of a binder resin will adhere to the surface of the aggregates.

While the size and shape of the aggregates are examined using an optical microscope and Multisizer 3, a group of aggregates is sorted out. Then the pH is adjusted to 7.8 with a 5% aqueous solution of sodium hydroxide, and the dispersion is maintained for 15 minutes.

Then the pH is increased to 8.0 for the fusion of the aggregates, and then the temperature is raised to 85° C. Two hours after the fusion of aggregates is observed under a microscope, the heating is stopped, and the dispersion is cooled at a cooling rate of 1.0° C./min. Then the dispersion is sieved through a 20-μm mesh, washing in water is repeated, and then the residue is dried in a vacuum dryer; the product is toner particles C4.

### Production of Toner Particles C5

Amorphous resin particle dispersion (1-1): 169 parts
Crystalline resin particle dispersion (1-4): 53 parts
Release agent dispersion (1): 25 parts
Coloring agent dispersion (1): 33 parts
An anionic surfactant (Dow Chemical, Dowfax 2A1): 4.8 parts

These raw materials, conditioned to a liquid temperature of 30° C. beforehand, are put into a 3-L cylindrical stainless-steel vessel and mixed together by 2 minutes of dispersion under shear at 4,000 rpm using a homogenizer (IKA, ULTRA-TURRAX T50).

Then 1.75 parts of a 10% solution of aluminum sulfate in sulfuric acid as a flocculant is slowly added dropwise, and the mixture is dispersed for 3 minutes at a homogenizer speed of 4,000 rpm; the product is a stock dispersion.

Then the stock dispersion is transferred to a polymerization pot having a stirring device with a twin-paddle stirring blade and a thermometer, heating in a heating mantle is started at a stirring speed of 550 rpm, and aggregates are allowed to grow at 40° C. During this, the pH of the stock dispersion is controlled to the range of 2.2 to 3.5 with 0.3 M nitric acid and a 1 M aqueous solution of sodium hydroxide. The dispersion is maintained in this pH range for approximately 2 hours so that aggregates will form.

Then another liquid dispersion prepared by mixing 42 parts of amorphous resin particle dispersion (1-1) and 41 parts of resin particle dispersion (2-1) together is added in two stages, half in the first stage and the rest in the second, and the resulting mixture is maintained for 60 minutes so that particles of a binder resin and resin particles will adhere to the surface of the aggregates.

While the size and shape of the aggregates are examined using an optical microscope and Multisizer 3, a group of aggregates is sorted out. Then the pH is adjusted to 7.8 with a 5% aqueous solution of sodium hydroxide, and the dispersion is maintained for 15 minutes.

Then the pH is increased to 8.0 for the fusion of the aggregates, and then the temperature is raised to 85° C. Two hours after the fusion of aggregates is observed under a microscope, the heating is stopped, and the dispersion is cooled at a cooling rate of 1.0° C./min. Then the dispersion is sieved through a 20-μm mesh, washing in water is repeated, and then the residue is dried in a vacuum dryer; the product is toner particles C5.

### Production of Toner Particles C6

Toner particles C6 are obtained in the same manner as toner particles 1, except that resin particle dispersion (2-1) is not added.

### Production of Toner Particles C7

Toner particles C7 are obtained in the same manner as toner particles 1, except that the pH at which aggregates are fused is changed from 8.0 to 6.5, that a raised temperature is changed from 85° C. to 75° C., and that 5.2 parts of an anionic surfactant (Dow Chemical, Dowfax 2A1) is added when the temperature reaches 75° C.

### Production of Toner Particles C8

Toner particles C8 are obtained in the same manner as toner particles 1, except that the pH at which aggregates are fused is changed from 8.0 to 10.0 and that a raised temperature is changed from 85° C. to 95° C.

For the resulting toners, the following parameters are presented in Table 3: the resin particle dispersion used (“Particles/Type” in the table), the percentage of resin particles in the toner particles as a whole (“Particles/Percentage (%)” in the table), the percentage of the crystalline resin in the entire binder resin (“Crystalline resin/Percentage (%)” in the table), and the amorphous resin particle dispersion used (“Amorphous resin/Type” in the table).

For the resulting toners, furthermore, the following parameters are presented in Table 4: the ratio of the amount of the crystalline resin to that of resin particles (“Crystalline resin-to-resin particles ratio” in the table) and the ratio of the amount of the amorphous resin to the amount of resin particles (“Amorphous resin-to-resin particles ratio” in the table).

Table 4 also includes the storage modulus G′ at temperatures of 30° C. or above and 50° C. or below of the remainder component (“G′ (Pa) at 30° C. to 50° C.” in the table), the specific elastic modulus temperature of the remainder component (“SEM temp. (° C.)” in the table), and the loss tangent tan δ of the remainder component at the specific elastic modulus temperature (“tan δ at SEM temp.” in the table), all as determined by the methods described above.

Table 4 also presents the number-average molecular weight of the THF-soluble component of the resulting toner particles (“Mn” in the table), the difference (SP (S)−SP (R)) (“Difference in SP” in the table), and the diameter of the toner particles, all as determined by the methods described above.

TABLE 3

| | Resin particles | | Crystalline resin | |
|---|---|---|---|---|
| Toner | | Percentage | Percentage | Amorphous resin |
| particles | Type | (% by mass) | (% by mass) | Type |
| 1 | (2-1) | 10 | 15 | (1-1) |
| 2 | (2-2) | 10 | 15 | (1-1) |
| 3 | (2-3) | 10 | 15 | (1-1) |
| 4 | (2-4) | 10 | 15 | (1-1) |
| 5 | (2-5) | 10 | 15 | (1-1) |
| 6 | (2-6) | 10 | 15 | (1-1) |
| 7 | (2-7) | 10 | 15 | (1-1) |
| 8 | (2-8) | 10 | 15 | (1-1) |
| 9 | (2-9) | 10 | 15 | (1-1) |
| 10 | (2-1) | 29 | 15 | (1-1) |
| 11 | (2-1) | 2 | 15 | (1-1) |
| 12 | (2-1) | 4 | 49 | (1-1) |
| 13 | (2-1) | 10 | 4 | (1-1) |
| 14 | (2-10) | 10 | 0 | (1-1) |
| 15 | (2-1) | 10 | 15 | (1-2) |
| 16 | (2-1) | 10 | 15 | (1-1) |
| 17 | (2-1) | 10 | 5 | (1-1) |
| 18 | (2-1) | 15 | 23 | (1-1) |
| 19 | (2-1) | 10 | 15 | (1-1) |
| 20 | (2-1) | 10 | 15 | (1-1) |
| 21 | (2-1) | 3 | 15 | (1-1) |
| 22 | (2-1) | 19 | 15 | (1-1) |
| 23 | (2-3) | 5 | 25 | (1-1) |
| 24 | (2-1) | 1 | 15 | (1-1) |
| 25 | (2-1) | 31 | 15 | (1-1) |
| 26 | (2-2) | 10 | 4 | (1-1) |
| 27 | (2-10) | 10 | 49 | (1-1) |
| 28 | (2-1) | 10 | 15 | (1-3) |
| 29 | (2-11) | 10 | 15 | (1-1) |
| 30 | (2-12) | 10 | 15 | (1-1) |
| 31 | (2-13) | 10 | 15 | (1-1) |
| 32 | (2-14) | 10 | 15 | (1-1) |
| C1 | (2-C1) | 10 | 15 | (1-1) |
| C2 | (2-C2) | 10 | 15 | (1-1) |
| C3 | (2-1) | 10 | 15 | (1-1) |
| C4 | (2-1) | 10 | 15 | (1-1) |
| C5 | (2-1) | 10 | 15 | (1-1) |
| C6 | — | 0 | 15 | (1-1) |
| C7 | (2-1) | 10 | 15 | (1-1) |
| C8 | (2-1) | 10 | 15 | (1-1) |

TABLE 4

| | | | Remainder component | | | | |
|---|---|---|---|---|---|---|---|
| | Crystalline | Amorphous | G′ (Pa) at | SEM | tanδ at | | |
| Toner | resin-to-resin | resin-to-resin | 30° C. to | temp. | SEM | | Difference |
| particles | particles ratio | particles ratio | 50° C. | (° C.) | temp. | Mn | in SP |
| 1 | 1.35 | 7.65 | 3.0 × 10⁸-5.3 × 10⁸ | 72 | 1.40 | 8891 | −0.26 |
| 2 | 1.35 | 7.65 | 3.0 × 10⁸-5.3 × 10⁸ | 72 | 1.40 | 8351 | −0.26 |
| 3 | 1.35 | 7.65 | 3.0 × 10⁸-5.3 × 10⁸ | 72 | 1.40 | 8931 | −0.26 |
| 4 | 1.35 | 7.65 | 3.0 × 10⁸-5.3 × 10⁸ | 72 | 1.40 | 9021 | −0.28 |
| 5 | 1.35 | 7.65 | 3.0 × 10⁸-5.3 × 10⁸ | 72 | 1.40 | 10751 | −0.28 |
| 6 | 1.35 | 7.65 | 3.0 × 10⁸-5.3 × 10⁸ | 72 | 1.40 | 7370 | −0.28 |
| 7 | 1.35 | 7.65 | 3.0 × 10⁸-5.3 × 10⁸ | 72 | 1.40 | 9511 | −0.28 |
| 8 | 1.35 | 7.65 | 3.0 × 10⁸-5.3 × 10⁸ | 72 | 1.40 | 9617 | −0.28 |
| 9 | 1.35 | 7.65 | 3.0 × 10⁸-5.3 × 10⁸ | 72 | 1.40 | 7404 | −0.28 |
| 10 | 0.37 | 2.08 | 3.0 × 10⁸-5.3 × 10⁸ | 72 | 1.40 | 8436 | −0.26 |
| 11 | 7.35 | 41.65 | 3.0 × 10⁸-5.3 × 10⁸ | 72 | 1.40 | 11166 | −0.26 |
| 12 | 11.76 | 12.24 | 9.1 × 10⁷-2.3 × 10⁸ | 69 | 1.52 | 8192 | −0.13 |
| 13 | 0.36 | 8.64 | 3.8 × 10⁸-6.0 × 10⁸ | 77 | 1.21 | 9224 | −0.30 |
| 14 | 0.00 | 9.00 | 5.5 × 10⁸-7.0 × 10⁸ | 86 | 1.55 | 9683 | −0.28 |
| 15 | 1.35 | 7.65 | 4.3 × 10⁸-6.1 × 10⁸ | 81 | 1.51 | 8942 | −0.18 |
| 16 | 1.35 | 7.65 | 3.0 × 10⁸-5.3 × 10⁸ | 72 | 1.40 | 9834 | −0.26 |
| 17 | 0.45 | 8.55 | 3.7 × 10⁸-5.9 × 10⁸ | 90 | 1.24 | 8805 | −0.30 |
| 18 | 1.30 | 4.36 | 1.2 × 10⁸-4.5 × 10⁸ | 68 | 1.43 | 7608 | −0.23 |
| 19 | 1.35 | 7.65 | 3.0 × 10⁸-5.3 × 10⁸ | 71 | 1.57 | 7786 | −0.26 |
| 20 | 1.35 | 7.65 | 3.0 × 10⁸-5.3 × 10⁸ | 76 | 0.85 | 9421 | −0.26 |
| 21 | 4.85 | 27.48 | 3.0 × 10⁸-5.3 × 10⁸ | 71 | 1.51 | 9207 | −0.26 |
| 22 | 0.64 | 3.62 | 3.0 × 10⁸-5.3 × 10⁸ | 75 | 0.92 | 7815 | −0.26 |
| 23 | 4.75 | 14.25 | 3.0 × 10⁸-5.3 × 10⁸ | 72 | 1.40 | 7780 | −0.24 |
| C1 | 1.35 | 7.65 | 3.0 × 10⁸-5.3 × 10⁸ | 72 | 1.40 | 7400 | −0.25 |
| C2 | 1.35 | 7.65 | 3.0 × 10⁸-5.3 × 10⁸ | 72 | 1.40 | 7892 | −0.26 |
| C3 | 1.35 | 7.65 | 3.0 × 10⁸-5.3 × 10⁸ | 72 | 1.40 | 8858 | −0.26 |
| C4 | 1.35 | 7.65 | 3.0 × 10⁸-5.3 × 10⁸ | 72 | 1.40 | 8209 | −0.26 |
| C5 | 1.35 | 7.65 | 3.0 × 10⁸-5.3 × 10⁸ | 72 | 1.40 | 8429 | −0.26 |
| C6 | — | — | 3.0 × 10⁸-5.3 × 10⁸ | 72 | 1.40 | 9015 | — |
| C7 | 1.35 | 7.65 | 3.0 × 10⁸-5.3 × 10⁸ | 72 | 1.40 | 16892 | −0.26 |
| C8 | 1.35 | 7.65 | 3.0 × 10⁸-5.3 × 10⁸ | 72 | 1.40 | 4239 | −0.26 |
| 24 | 14.85 | 84.15 | 3.0 × 10⁸-5.3 × 10⁸ | 72 | 1.40 | 7624 | −0.26 |
| 25 | 0.33 | 1.89 | 3.0 × 10⁸-5.3 × 10⁸ | 72 | 1.40 | 9673 | −0.26 |
| 26 | 0.36 | 8.64 | 3.0 × 10⁸-5.3 × 10⁸ | 72 | 1.40 | 7743 | −0.32 |
| 27 | 4.41 | 4.59 | 3.0 × 10⁸-5.3 × 10⁸ | 72 | 1.40 | 8596 | −0.09 |
| 28 | 1.35 | 7.65 | 3.4 × 10⁸-5.5 × 10⁸ | 71 | 1.42 | 9201 | −0.22 |
| 29 | 1.35 | 7.65 | 3.0 × 10⁸-5.3 × 10⁸ | 72 | 1.40 | 8657 | −0.26 |
| 30 | 1.35 | 7.65 | 3.0 × 10⁸-5.3 × 10⁸ | 72 | 1.40 | 9524 | −0.26 |
| 31 | 1.35 | 7.65 | 3.0 × 10⁸-5.3 × 10⁸ | 72 | 1.40 | 7923 | −0.26 |
| 32 | 1.35 | 7.65 | 3.0 × 10⁸-5.3 × 10⁸ | 72 | 1.40 | 10262 | −0.26 |

### Production of Silica Particles (A)

### Preparation of an Alkaline Catalyst Solution

Methanol and aqueous ammonia are put into a glass reaction vessel having a metal stirring bar, a dripping nozzle, and a thermometer, with their amount and concentration being as in Table 5, and mixed together by stirring to give an alkaline catalyst solution.

### Formation of Base Silica Particles by a Sol-Gel Process

The temperature of the alkaline catalyst solution is adjusted to 40° C., and the alkaline catalyst solution is purged with nitrogen. While the alkaline catalyst solution is stirred at a constant solution temperature of 40° C., tetramethoxysilane (TMOS), its amount being as in Table 5, and 124 parts of aqueous ammonia with a catalyst (NH₃) concentration of 7.9% are added dropwise together; this gives a liquid suspension of base silica particles.

### Addition of a Silane Coupling Agent

While the base silica particle suspension is stirred at a constant suspension temperature of 40° C., methyltrimethoxysilane (MTMS), its amount being as in Table 5, is added. After the addition of the MTMS, the suspension is further stirred for 120 minutes so that the MTMS will react and that the product of the reaction will cover at least part of the surface of the base silica particles.

### Addition of a Molybdenum- and Nitrogen-Containing Compound

An alcohol solution is prepared in which a molybdenum- and nitrogen-containing compound, its amount being as in Table 5, has been diluted with butanol. This alcohol solution is added to the base silica particle suspension in which the silane coupling agent has reacted, and the resulting mixture is stirred for 100 minutes at a constant mixture temperature of 30° C. The amount of the alcohol solution is an amount that will make the number of parts of the molybdenum- and nitrogen-containing compound per 100 parts by mass, on a solids basis, of the base silica particle suspension as in Table 5.

The “TP-415” in Table 5 is a quaternary ammonium molybdate (Hodogaya Chemical).

### Drying

The liquid suspension to which the molybdenum- and nitrogen-containing compound has been added is transferred to a reactor for drying. While the suspension is stirred, liquid carbon dioxide is poured into the reactor, the inside of the reactor is heated and pressurized to 150° C. and 15 MPa, respectively, and the suspension is further stirred at these temperature and pressure so that the carbon dioxide will be maintained supercritical. The solvent is removed over 120 minutes by allowing carbon dioxide to flow into and out of the reactor at a flow rate of 5 L/min; the product is silica particles (A). Different types of silica particles, (A1) to (A13), are prepared by adjusting the amounts of aqueous ammonia, the silane coupling agent, and the molybdenum- and nitrogen-containing compound.

### X-Ray Fluorescence Analysis

The silica particles (A) are subjected to x-ray fluorescence analysis as in the measurement method described above, and the ratio of net intensities N_{Mo}/N_{Si}, where N_{Mo} is the net intensity for the element molybdenum and N_{Si} is that for the element silicon, is calculated.

The average diameter of primary particles and the ratio of net intensities for silica particles (A1) to (A13) are presented in Table 5.

TABLE 5

| | | | | | | | | Silica | | |
|---|---|---|---|---|---|---|---|---|---|---|
| | Formation of base | | | | | | | particles | | |
| Silica | silica particles | | | | Surface | Molybdenum- and nitrogen- | | Average | | |
| particles | | Aqueous | Ammonia | | coating | containing compound | | diameter | | |
| (A) | Methanol | ammonia | concentration | TMOS | MTMS | Substance | Amount | of primary | | |
| Name | Parts by | Parts by | % by | Parts by | Parts by | name | Parts by | particles | N_{Mo} | N_{Mo}/N_{Si} |
| — | mass | mass | mass | mass | mass | — | mass | nm | kcps | — |
| (A9) | 950 | 166 | 9.6 | 1000 | 10 | TP-415 | 0.5 | 61 | 6 | 0.030 |
| (A1) | 950 | 166 | 9.6 | 1000 | 22 | TP-415 | 1 | 61 | 8 | 0.035 |
| (A2) | 950 | 166 | 9.6 | 1000 | 30 | TP-415 | 4 | 61 | 22 | 0.10 |
| (A3) | 950 | 166 | 9.6 | 1000 | 50 | Ditetrakis(dibutyldibenzyl- | 5 | 62 | 31 | 0.18 |
| | | | | | | ammonium) | | | | |
| | | | | | | molybdate | | | | |
| (A4) | 950 | 166 | 9.6 | 1000 | 170 | TP-415 | 20 | 62 | 58 | 0.25 |
| (A5) | 950 | 166 | 9.6 | 1000 | 180 | TP-415 | 30 | 62 | 65 | 0.30 |
| (A6) | 950 | 166 | 9.6 | 1000 | 190 | TP-415 | 45 | 62 | 74 | 0.35 |
| (A7) | 950 | 166 | 9.6 | 1000 | 230 | TP-415 | 50 | 62 | 86 | 0.40 |
| (A8) | 950 | 166 | 9.6 | 1000 | 240 | TP-415 | 50 | 62 | 94 | 0.45 |
| (A10) | 950 | 166 | 9.6 | 1000 | 250 | TP-415 | 50 | 62 | 97 | 0.50 |
| (A11) | 950 | 220 | 9.1 | 1000 | 50 | TP-415 | 4 | 80 | 24 | 0.12 |
| (A12) | 950 | 160 | 9.4 | 1000 | 175 | TP-415 | 25 | 50 | 59 | 0.25 |
| (A13) | 950 | 150 | 9.2 | 1000 | 180 | TP-415 | 30 | 40 | 60 | 0.25 |

### Production of Toners (1) to (57) and (C1)

One hundred (100) parts of the toner particles indicated in Table 6 and the silica particles (A) indicated in Table 6, their amount being as in Table 6, are mixed together in a Henschel mixer, and the resulting mixture is sieved through a vibrating sieve with a 45-μm mesh; the products are toners (1) to (57) and (C1).

For the resulting toners, the following parameters are presented in Table 7: D1(90), D50(90), D1(150), D50(150), D50(150)−D1(150) (“Difference (150)” in the table), D50(90)−D1(90) (“Difference (90)” in the table), storage modulus G′ at temperatures of 30° C. or above and 50° C. or below (“G′ (Pa) at 30° C. to 50° C.” in the table), the specific elastic modulus temperature (“SEM temp. (° C.)” in the table), and log G′(t90-150)−log G′(r90-150) (“Difference in viscoelasticity” in the table), all as determined by the methods described above.

TABLE 6

| Toner | Toner particles | | | Silica particles (A) | | |
|---|---|---|---|---|---|---|
| (with an | | | Average diameter of primary | | | Parts per 100 |
| external | | Resin | particles D_{C} (nm) | | Average diameter of | parts of the |
| additive) | Type | particles | for the resin particles | Type | primary particles D_{A} (nm) | toner particles |
| (1) | 1 | (2-1) | 153 | (A4) | 62 | 0.8 |
| (2) | 2 | (2-2) | 163 | (A4) | 62 | 0.8 |
| (3) | 3 | (2-3) | 159 | (A4) | 62 | 0.8 |
| (4) | 4 | (2-4) | 112 | (A4) | 62 | 0.8 |
| (5) | 5 | (2-5) | 135 | (A4) | 62 | 0.8 |
| (6) | 6 | (2-6) | 291 | (A4) | 62 | 0.8 |
| (7) | 7 | (2-7) | 64 | (A4) | 62 | 0.8 |
| (8) | 8 | (2-8) | 305 | (A4) | 62 | 0.8 |
| (9) | 9 | (2-9) | 57 | (A4) | 62 | 0.8 |
| (10) | 10 | (2-1) | 153 | (A4) | 62 | 0.8 |
| (11) | 11 | (2-1) | 153 | (A4) | 62 | 0.8 |
| (12) | 12 | (2-1) | 153 | (A4) | 62 | 0.8 |
| (13) | 13 | (2-1) | 153 | (A4) | 62 | 0.8 |
| (14) | 14 | (2-10) | 153 | (A4) | 62 | 0.8 |
| (15) | 15 | (2-1) | 153 | (A4) | 62 | 0.8 |
| (16) | 16 | (2-1) | 153 | (A4) | 62 | 0.8 |
| (17) | 17 | (2-1) | 153 | (A4) | 62 | 0.8 |
| (18) | 18 | (2-1) | 153 | (A4) | 62 | 0.8 |
| (19) | 19 | (2-1) | 153 | (A4) | 62 | 0.8 |
| (20) | 20 | (2-1) | 153 | (A4) | 62 | 0.8 |
| (21) | 21 | (2-1) | 153 | (A4) | 62 | 0.8 |
| (22) | 22 | (2-1) | 153 | (A4) | 62 | 0.8 |
| (23) | 23 | (2-3) | 159 | (A4) | 62 | 0.8 |
| (24) | C1 | (2-C1) | 165 | (A4) | 62 | 0.8 |
| (25) | C2 | (2-C2) | 190 | (A4) | 62 | 0.8 |
| (26) | C3 | (2-1) | 153 | (A4) | 62 | 0.8 |
| (27) | C4 | (2-1) | 153 | (A4) | 62 | 0.8 |
| (28) | C5 | (2-1) | 153 | (A4) | 62 | 0.8 |
| (29) | C7 | (2-1) | 153 | (A4) | 62 | 0.8 |
| (30) | C8 | (2-1) | 153 | (A4) | 62 | 0.8 |
| (31) | 24 | (2-1) | 153 | (A4) | 62 | 0.8 |
| (32) | 25 | (2-1) | 153 | (A4) | 62 | 0.8 |
| (33) | 26 | (2-2) | 163 | (A4) | 62 | 0.8 |
| (34) | 27 | (2-10) | 162 | (A4) | 62 | 0.8 |
| (35) | 28 | (2-1) | 153 | (A4) | 62 | 0.8 |
| (36) | 29 | (2-11) | 165 | (A4) | 62 | 0.8 |
| (37) | 30 | (2-12) | 159 | (A4) | 62 | 0.8 |
| (38) | 31 | (2-13) | 154 | (A4) | 62 | 0.8 |
| (39) | 32 | (2-14) | 171 | (A4) | 62 | 0.8 |
| (40) | 1 | (2-1) | 153 | (A1) | 61 | 0.8 |
| (41) | 1 | (2-1) | 153 | (A2) | 61 | 0.8 |
| (42) | 1 | (2-1) | 153 | (A3) | 62 | 0.8 |
| (43) | 1 | (2-1) | 153 | (A5) | 62 | 0.8 |
| (44) | 1 | (2-1) | 153 | (A6) | 62 | 0.8 |
| (45) | 1 | (2-1) | 153 | (A7) | 62 | 0.8 |
| (46) | 1 | (2-1) | 153 | (A8) | 62 | 0.8 |
| (47) | 1 | (2-1) | 153 | (A11) | 80 | 0.8 |
| (48) | 1 | (2-1) | 153 | (A12) | 50 | 0.8 |
| (49) | 1 | (2-1) | 153 | (A13) | 40 | 0.8 |
| (50) | 1 | (2-1) | 153 | (A4) | 62 | 0.4 |
| (51) | 1 | (2-1) | 153 | (A4) | 62 | 0.5 |
| (52) | 1 | (2-1) | 153 | (A4) | 62 | 0.7 |
| (53) | 1 | (2-1) | 153 | (A4) | 62 | 1.0 |
| (54) | 1 | (2-1) | 153 | (A4) | 62 | 1.2 |
| (55) | 1 | (2-1) | 153 | (A4) | 62 | 3.0 |
| (56) | 1 | (2-1) | 153 | (A9) | 61 | 0.8 |
| (57) | 1 | (2-1) | 153 | (A10) | 62 | 0.8 |
| (C1) | C6 | — | — | (A4) | 62 | 0.8 |

TABLE 7

| | | Viscoelastic and other characteristics of the toner | | | | | | | | |
|---|---|---|---|---|---|---|---|---|---|---|
| | | | | | | | | G′ (Pa) at | SEM | |
| | Toner | D 1 | D 50 | D 1 | D 50 | Difference | Difference | 30° C. to | temp. | Difference in |
| Toner | particles | 90° C. | 90° C. | 150° C. | 150° C. | 150° C. | 90° C. | 50° C. | (° C.) | viscoelasticity |
| (1) | 1 | 1.21 | 1.42 | 0.60 | 1.53 | 0.93 | 0.21 | 2.5 × 10⁸-4.8 × 10⁸ | 82 | 3.3 |
| (2) | 2 | 1.35 | 1.51 | 0.63 | 1.59 | 0.96 | 0.16 | 2.7 × 10⁸-5.3 × 10⁸ | 85 | 3.2 |
| (3) | 3 | 1.26 | 1.42 | 0.59 | 1.62 | 1.03 | 0.16 | 2.2 × 10⁸-4.5 × 10⁸ | 80 | 3.5 |
| (4) | 4 | 1.28 | 1.47 | 0.60 | 1.59 | 0.99 | 0.19 | 2.5 × 10⁸-4.8 × 10⁸ | 82 | 3.3 |
| (5) | 5 | 1.33 | 1.40 | 0.58 | 1.45 | 0.87 | 0.07 | 2.5 × 10⁸-4.8 × 10⁸ | 82 | 3.7 |
| (6) | 6 | 1.27 | 1.50 | 0.53 | 1.60 | 1.07 | 0.23 | 2.5 × 10⁸-4.8 × 10⁸ | 82 | 3.4 |
| (7) | 7 | 1.32 | 1.48 | 0.65 | 1.57 | 0.92 | 0.16 | 2.5 × 10⁸-4.8 × 10⁸ | 83 | 3.2 |
| (8) | 8 | 1.30 | 1.46 | 0.63 | 1.61 | 0.98 | 0.16 | 2.5 × 10⁸-4.8 × 10⁸ | 83 | 3.5 |
| (9) | 9 | 1.26 | 1.47 | 0.60 | 1.55 | 0.95 | 0.21 | 2.5 × 10⁸-4.8 × 10⁸ | 82 | 3.3 |
| (10) | 10 | 1.27 | 1.35 | 0.52 | 1.43 | 0.91 | 0.08 | 1.5 × 10⁸-4.3 × 10⁸ | 88 | 2.5 |
| (11) | 11 | 1.21 | 2.12 | 0.87 | 1.95 | 1.08 | 0.91 | 2.9 × 10⁸-5.2 × 10⁸ | 80 | 3.8 |
| (12) | 12 | 1.47 | 1.61 | 0.79 | 1.87 | 1.08 | 0.14 | 1.3 × 10⁸-4.2 × 10⁸ | 74 | 3.7 |
| (13) | 13 | 1.26 | 1.45 | 0.65 | 1.61 | 0.96 | 0.19 | 3.2 × 10⁸-6.1 × 10⁸ | 88 | 3.1 |
| (14) | 14 | 1.31 | 1.47 | 0.67 | 1.52 | 0.85 | 0.16 | 4.5 × 10⁸-6.8 × 10⁸ | 89 | 1.5 |
| (15) | 15 | 1.24 | 1.47 | 0.63 | 1.55 | 0.92 | 0.23 | 3.1 × 10⁸-4.8 × 10⁸ | 87 | 2.2 |
| (16) | 16 | 1.22 | 1.44 | 0.58 | 1.81 | 1.23 | 0.22 | 2.5 × 10⁸-4.8 × 10⁸ | 83 | 3.1 |
| (17) | 17 | 1.25 | 1.46 | 0.58 | 1.51 | 0.93 | 0.21 | 2.7 × 10⁸-5.0 × 10⁸ | 90 | 2.6 |
| (18) | 18 | 1.22 | 1.39 | 0.56 | 1.59 | 1.03 | 0.17 | 8.5 × 10⁷-3.2 × 10⁸ | 79 | 2.9 |
| (19) | 19 | 1.27 | 1.53 | 0.53 | 1.57 | 1.04 | 0.26 | 2.1 × 10⁸-4.6 × 10⁸ | 80 | 2.6 |
| (20) | 20 | 1.31 | 1.49 | 0.57 | 1.53 | 0.96 | 0.18 | 2.4 × 10⁸-4.9 × 10⁸ | 87 | 3.8 |
| (21) | 21 | 1.35 | 1.63 | 0.91 | 2.39 | 1.48 | 0.28 | 2.8 × 10⁸-5.2 × 10⁸ | 78 | 2.4 |
| (22) | 22 | 0.55 | 0.74 | 0.63 | 1.53 | 0.90 | 0.19 | 2.2 × 10⁸-4.5 × 10⁸ | 84 | 3.7 |
| (23) | 23 | 1.35 | 1.65 | 0.51 | 1.98 | 1.47 | 0.30 | 1.8 × 10⁸-4.4 × 10⁸ | 78 | 3.2 |
| (24) | C1 | 1.25 | 1.44 | 0.58 | 2.45 | 1.67 | 0.19 | 2.5 × 10⁸-7.6 × 10⁸ | 90 | 2.9 |
| (25) | C2 | 1.24 | 1.84 | 0.63 | 2.25 | 1.62 | 0.60 | 1.2 × 10⁸-3.6 × 10⁸ | 72 | 2.5 |
| (26) | C3 | 1.18 | 1.38 | 0.59 | 2.14 | 1.55 | 0.20 | 2.6 × 10⁸-4.7 × 10⁸ | 82 | 3.4 |
| (27) | C4 | 1.18 | 2.23 | 0.63 | 2.27 | 1.64 | 1.05 | 2.9 × 10⁸-5.1 × 10⁸ | 83 | 3.1 |
| (28) | C5 | 1.19 | 1.64 | 0.52 | 2.21 | 1.69 | 0.45 | 2.1 × 10⁸-4.3 × 10⁸ | 83 | 3.2 |
| (C1) | C6 | 1.26 | 2.20 | 0.91 | 2.25 | 1.34 | 0.94 | 3.0 × 10⁸-5.3 × 10⁸ | 72 | — |
| (29) | C7 | 1.31 | 1.62 | 0.67 | 1.94 | 1.27 | 0.31 | 2.9 × 10⁸-5.1 × 10⁸ | 86 | 3.2 |
| (30) | C8 | 1.29 | 1.59 | 0.59 | 2.08 | 1.49 | 0.30 | 2.4 × 10⁸-4.4 × 10⁸ | 81 | 3.2 |
| (31) | 24 | 1.52 | 1.83 | 0.61 | 1.96 | 1.35 | 0.31 | 2.9 × 10⁸-5.4 × 10⁸ | 81 | 3.7 |
| (32) | 25 | 1.24 | 1.64 | 0.87 | 1.95 | 1.08 | 0.40 | 2.9 × 10⁸-5.2 × 10⁸ | 80 | 3.8 |
| (33) | 26 | 1.29 | 1.43 | 0.62 | 1.62 | 1.00 | 0.14 | 3.4 × 10⁸-6.0 × 10⁸ | 89 | 3.2 |
| (34) | 27 | 1.42 | 1.59 | 0.75 | 1.83 | 1.08 | 0.17 | 1.3 × 10⁸-4.3 × 10⁸ | 75 | 3.6 |
| (35) | 28 | 1.22 | 1.54 | 0.64 | 1.67 | 1.03 | 0.32 | 2.9 × 10⁸-5.1 × 10⁸ | 81 | 3.4 |
| (36) | 29 | 1.32 | 1.56 | 0.75 | 1.89 | 1.14 | 0.24 | 2.7 × 10⁸-5.0 × 10⁸ | 82 | 3.2 |
| (37) | 30 | 1.46 | 1.67 | 0.79 | 2.01 | 1.22 | 0.21 | 2.7 × 10⁸-5.1 × 10⁸ | 80 | 3.0 |
| (38) | 31 | 1.21 | 1.41 | 0.51 | 1.98 | 1.47 | 0.20 | 3.1 × 10⁸-5.0 × 10⁸ | 85 | 3.7 |
| (39) | 32 | 1.35 | 1.57 | 0.76 | 2.23 | 1.47 | 0.22 | 2.0 × 10⁸-4.8 × 10⁸ | 80 | 2.9 |

The D1(90), D50(90), D1(150), D50(150), D50(150)−D1(150) (“Difference (150)” in the table), D50(90)−D1(90), the storage modulus G′ at temperatures of 30° C. or above and 50° C. or below, the specific elastic modulus temperature, and log G′(t90-150)−log G′ of toners (40) to (57) are substantially equal to those of toner (1).

### Production of Carrier (1)

### Production of Ferrite Particles

A mixture of 1318 parts of Fe₂O₃, 587 parts of Mn(OH)₂, and 96 parts of Mg(OH)₂ are calcined at a temperature of 900° C. for 4 hours. The calcined mixture, 6.6 parts of polyvinyl alcohol, 0.5 parts of a polycarboxylic acid as a dispersant, and zirconia beads having a diameter of 1 mm are put into water and milled and mixed together in a sand mill to give a liquid dispersion. The volume-average diameter of particles in the dispersion is 1.5 μm.

With this dispersion as the starting material, the particles are grown and dried using a spray drier to give granules having a volume-average diameter of 37 μm. Then these granules are fired at a temperature of 1450° C. for 4 hours using an electric furnace in a gas mixture of oxygen and nitrogen with a partial pressure of oxygen of 1% and then heated at a temperature of 900° C. for 3 hours in the air to give fired granules. The fired granules are disintegrated and classified, and particles having a volume-average diameter of 35 μm are obtained as ferrite particles (1). The arithmetical mean height Ra of the roughness profile of ferrite particles (1) (JIS B0601: 2001) is 0.6 μm.

### Coating Agent (1)

Resin (1) (cyclohexyl methacrylate resin): 15.4 parts
Resin (3) (2-(dimethylamino)ethyl (meth)acrylate resin): 0.39 parts
Carbon black (Cabot, VXC72): 2.24 parts
Melamine resin particles (EPOSTAR S, Nippon Shokubai Co., Ltd.; average diameter, 200 nm): 3.0 parts
Inorganic particles (1): 9.0 parts

Commercially available hydrophobic silica particles (particles of fumed silica having a surface treated with hexamethyldisilazane; volume-average diameter, 40 nm)
Toluene: 250 parts
Isopropyl alcohol: 50 parts

These ingredients and glass beads (diameter, 1 mm; the same amount as toluene) are put into a sand mill and stirred at a speed of 190 rpm for 30 minutes; the product is coating agent (1).

### Production of Carrier B (1)

One thousand (1,000) parts of ferrite particles (1) and half of coating agent (1) are put into a kneader and mixed together for 20 minutes at room temperature (25° C.). Then the mixture is dried by heating to 70° C. and pressure reduction.

The dried mixture is cooled to room temperature (25° C.), the remaining half of coating agent (1) is added, and the ingredients are mixed together for 20 minutes at room temperature (25° C.). Then the mixture is dried by heating to 70° C. and pressure reduction.

Then the dried mixture is removed from the kneader and sieved through a 75-μm mesh so that coarse particles will be removed; the product is carrier B (1).

### Production of Carriers B (2) to (32)

Carriers are obtained in the same manner as in the production of carrier B (1), except that the amount of resin (1), the amount of resin (2), and the amount of inorganic particles (1) and the inorganic particles used are changed according to Table 8. Resin (2) is methyl (meth)acrylate resin.

TABLE 8

| | Coating agent | | | | | | | | | | | |
|---|---|---|---|---|---|---|---|---|---|---|---|---|
| | | | | | | | Inorganic particles | | | | | |
| | | Amount | Amount | Amount | Amount | | | | Average | Coating resin layer | | |
| | | Resin | Resin | Resin | Melamine | Amount | | | diameter | Inorganic | | |
| | | (1) | (2) | (3) | resin | Carbon | | Amount | of primary | particle | Average | |
| | Resins | (% by | (% by | (% by | particles | black (% | | (% by | particles | content (% | thickness | |
| | Species | mass) | mass) | mass) | (% by mass) | by mass) | Type | mass) | D_{B} (nm) | by mass) | T (μm) | D_{B}/T |
| Carrier | CHMA | 15.4 | — | 0.39 | 3.00 | 2.24 | (1) | 9.0 | 40 | 30 | 1.0 | 0.040 |
| B (1) | DMAEMA | | | | | | | | | | | |
| Carrier | CHMA | 17.0 | — | 0.44 | 2.84 | 2.48 | (1) | 5.7 | 40 | 20 | 1.0 | 0.040 |
| B (2) | DMAEMA | | | | | | | | | | | |
| Carrier | CHMA | 12.6 | — | 0.32 | 3.28 | 1.84 | (1) | 14.8 | 40 | 45 | 1.0 | 0.040 |
| B (3) | DMAEMA | | | | | | | | | | | |
| Carrier | CHMA | 12.6 | — | 0.32 | 3.28 | 1.84 | (7) | 14.8 | 93 | 45 | 1.0 | 0.093 |
| B (4) | DMAEMA | | | | | | | | | | | |
| Carrier | CHMA | 13.6 | — | 0.35 | 3.18 | 1.98 | (6) | 12.7 | 88 | 40 | 1.0 | 0.088 |
| B (5) | DMAEMA | | | | | | | | | | | |
| Carrier | CHMA | 16.2 | — | 0.42 | 2.92 | 2.36 | (3) | 7.3 | 7 | 25 | 1.0 | 0.007 |
| B (6) | DMAEMA | | | | | | | | | | | |
| Carrier | CHMA | 16.2 | — | 0.42 | 2.92 | 2.36 | (2) | 7.3 | 4 | 25 | 1.0 | 0.004 |
| B (7) | DMAEMA | | | | | | | | | | | |
| Carrier | CHMA | 23.0 | — | 0.59 | 4.50 | 3.36 | (2) | 13.5 | 4 | 30 | 1.5 | 0.003 |
| B (8) | DMAEMA | | | | | | | | | | | |
| Carrier | CHMA | 21.5 | — | 0.55 | 4.20 | 3.14 | (3) | 12.6 | 7 | 30 | 1.4 | 0.005 |
| B (9) | DMAEMA | | | | | | | | | | | |
| Carrier | CHMA | 9.2 | — | 0.24 | 1.80 | 1.35 | (6) | 5.4 | 88 | 30 | 0.6 | 0.147 |
| B (10) | DMAEMA | | | | | | | | | | | |
| Carrier | CHMA | 7.7 | — | 0.20 | 1.50 | 1.12 | (7) | 4.5 | 93 | 30 | 0.5 | 0.186 |
| B (11) | DMAEMA | | | | | | | | | | | |
| Carrier | CHMA | 15.4 | — | 0.39 | 3.00 | 2.24 | (2) | 9.0 | 4 | 30 | 1.0 | 0.004 |
| B (12) | DMAEMA | | | | | | | | | | | |
| Carrier | CHMA | 15.4 | — | 0.39 | 3.00 | 2.24 | (3) | 9.0 | 7 | 30 | 1.0 | 0.007 |
| B (13) | DMAEMA | | | | | | | | | | | |
| Carrier | CHMA | 15.4 | — | 0.39 | 3.00 | 2.24 | (6) | 9.0 | 88 | 30 | 1.0 | 0.088 |
| B (14) | DMAEMA | | | | | | | | | | | |
| Carrier | CHMA | 15.4 | — | 0.39 | 3.00 | 2.24 | (7) | 9.0 | 93 | 30 | 1.0 | 0.093 |
| B (15) | DMAEMA | | | | | | | | | | | |
| Carrier | CHMA | 7.7 | — | 0.20 | 1.50 | 1.12 | (1) | 4.5 | 40 | 30 | 0.5 | 0.080 |
| B (16) | DMAEMA | | | | | | | | | | | |
| Carrier | CHMA | 9.2 | — | 0.24 | 1.80 | 1.35 | (1) | 5.4 | 40 | 30 | 0.6 | 0.067 |
| B (17) | DMAEMA | | | | | | | | | | | |
| Carrier | CHMA | 21.5 | — | 0.55 | 4.20 | 3.14 | (1) | 12.6 | 40 | 30 | 1.4 | 0.029 |
| B (18) | DMAEMA | | | | | | | | | | | |
| Carrier | CHMA | 23.0 | — | 0.59 | 4.50 | 3.36 | (1) | 13.5 | 40 | 30 | 1.5 | 0.027 |
| B (19) | DMAEMA | | | | | | | | | | | |
| Carrier | CHMA | 17.3 | — | 0.44 | 2.82 | 2.53 | (4) | 5.1 | 12 | 18 | 1.0 | 0.012 |
| B (20) | DMAEMA | | | | | | | | | | | |
| Carrier | CHMA | 17.0 | — | 0.44 | 2.84 | 2.48 | (4) | 5.7 | 12 | 20 | 1.0 | 0.012 |
| B (21) | DMAEMA | | | | | | | | | | | |
| Carrier | CHMA | 11.5 | — | 0.29 | 3.36 | 1.67 | (5) | 16.8 | 62 | 50 | 1.0 | 0.062 |
| B (22) | DMAEMA | | | | | | | | | | | |
| Carrier | CHMA | 11.0 | — | 0.28 | 3.40 | 1.61 | (5) | 17.7 | 62 | 52 | 1.0 | 0.062 |
| B (23) | DMAEMA | | | | | | | | | | | |
| Carrier | CHMA | 15.8 | — | — | 3.00 | 2.24 | (1) | 9.0 | 40 | 30 | 1.0 | 0.040 |
| B (24) | | | | | | | | | | | | |
| Carrier | MMA | — | 15.8 | — | 3.00 | 2.24 | (1) | 9.0 | 40 | 30 | 1.0 | 0.040 |
| B (25) | | | | | | | | | | | | |
| Carrier | CHMA | 15.0 | — | 0.79 | 3.00 | 2.24 | (1) | 9.0 | 40 | 30 | 1.0 | 0.040 |
| B (26) | DMAEMA | | | | | | | | | | | |
| Carrier | CHMA | 16.0 | — | 0.41 | 3.12 | 2.33 | (8) | 9.4 | 40 | 30 | 1.0 | 0.040 |
| B (27) | DMAEMA | | | | | | | | | | | |
| Carrier | CHMA | 16.9 | — | 0.43 | 3.30 | 2.47 | (9) | 9.9 | 40 | 30 | 1.0 | 0.040 |
| B (28) | DMAEMA | | | | | | | | | | | |
| Carrier | CHMA | 16.9 | — | 0.43 | 3.30 | 2.47 | (10) | 9.9 | 10 | 30 | 1.0 | 0.010 |
| B (29) | DMAEMA | | | | | | | | | | | |
| Carrier | CHMA | 16.9 | — | 0.43 | 3.30 | 2.47 | (11) | 9.9 | 30 | 30 | 1.0 | 0.030 |
| B (30) | DMAEMA | | | | | | | | | | | |
| Carrier | CHMA | 16.9 | — | 0.43 | 3.30 | 2.47 | (12) | 9.9 | 50 | 30 | 1.0 | 0.050 |
| B (31) | DMAEMA | | | | | | | | | | | |
| Carrier | CHMA | 16.9 | — | 0.43 | 3.30 | 2.47 | (13) | 9.9 | 60 | 30 | 1.0 | 0.060 |
| B (32) | DMAEMA | | | | | | | | | | | |
| Carrier | CHMA | 18.8 | — | 0.48 | 2.74 | 2.68 | (1) | 2.1 | 40 | 8 | 1.0 | 0.040 |
| B (33) | DMAEMA | | | | | | | | | | | |
| Carrier | CHMA | 9.2 | — | 0.24 | 3.60 | 1.35 | (1) | 21.6 | 40 | 60 | 1.0 | 0.040 |
| B (34) | DMAEMA | | | | | | | | | | | |
| Carrier | CHMA | 19.7 | — | 0.51 | 2.57 | 2.88 | — | — | — | 0 | 1.0 | 0.000 |
| B (35) | DMAEMA | | | | | | | | | | | |

The abbreviations in Table 8 are as follows.
CHMA: Cyclohexyl methacrylate resin
MMA: Methyl (meth)acrylate resin
DMAEMA: 2-(Dimethylamino)ethyl (meth)acrylate resin

### Production of Inorganic Particles to be Contained in the Coating Resin Layer of the Carriers

The inorganic particles to be contained in the coating resin layer of the carriers are as follows.

### Inorganic Particles (1)

Commercially available hydrophobic silica particles (particles of fumed silica having a surface treated with hexamethyldisilazane; volume-average diameter, 40 nm) are prepared and used as inorganic particles (1).

### Inorganic Particles (2)

Eight hundred and ninety (890) parts of methanol and 210 parts of 9.8% aqueous ammonia are put into a 1.5-L glass reaction vessel having a stirrer, a dripping nozzle, and a thermometer and mixed together to give an alkaline catalyst solution. After the alkaline catalyst solution is conditioned to 45° C., 550 parts of tetramethoxysilane and 140 parts of 7.6% aqueous ammonia are simultaneously added dropwise over 450 minutes with stirring; the product is silica particle dispersion (A). The silica particles in silica particle dispersion (A) have a volume-average diameter of 4 nm and a geometric standard deviation by volume of 1.2 ((D84v/D16v)^{1/2}, the square root of the ratio between D16v and D84v, where D16v and D84v are the particle diameters at which the cumulative percentage is 16% and 84%, respectively, in a volume-based particle size distribution plotted starting from the smallest diameter).

Three hundred (300) parts of silica particle dispersion (A) is put into an autoclave fitted with a stirrer, and the stirrer is rotated at a speed of 100 rpm. While the stirrer is rotated continuously, liquid carbon dioxide is poured from a carbon dioxide cylinder into the autoclave using a pump, and the inside of the autoclave is heated with a heater and pressurized with a pump at the same time until it reaches a supercritical state at 150° C. and 15 MPa. The pressure valve is operated to keep the inside of the autoclave at 15 MPa, and the supercritical carbon dioxide is passed so that methanol and water will be removed from silica particle dispersion (A). When 900 parts of carbon dioxide has been supplied into the autoclave, the supply of carbon dioxide is stopped; this gives silica particles in powder form.

The carbon dioxide is maintained supercritical by keeping the inside of the autoclave at 150° C. and 15 MPa with the heater and the pump; in that state and while the stirrer of the autoclave is rotated continuously, 50 parts of hexamethyldisilazane per 100 parts of the silica particles is poured into the autoclave using an entrainer pump, the inside of the autoclave is heated to 180° C., and the materials are allowed to react for 20 minutes. Then supercritical carbon dioxide is passed through the inside of the autoclave again so that an excess of hexamethyldisilazane will be removed. Then the stirring is stopped, the pressure valve is opened to release the pressure inside the autoclave until it reaches atmospheric pressure, and the temperature is lowered to room temperature (25° C.). In this manner, silica particles having a surface treated with hexamethyldisilazane are obtained. The silica particles have a volume-average diameter of 4 nm. The resulting silica particles are used as inorganic particles (2).

### Inorganic Particles (3)

Silica particles having a surface treated with hexamethyldisilazane are obtained in the same manner as in the production of inorganic particles (2); the volume-average diameter of silica particles in the silica particle dispersion, however, is changed to 6 nm by increasing the amounts of tetramethoxysilane and 7.6% aqueous ammonia added dropwise in the production of silica particle dispersion (A). The silica particles have a volume-average diameter of 7 nm. The resulting silica particles are used as inorganic particles (3).

### Inorganic Particles (4)

Commercially available hydrophobic silica particles (particles of fumed silica having a surface treated with hexamethyldisilazane; volume-average diameter, 12 nm) are prepared and used as inorganic particles (4).

### Inorganic Particles (5)

Commercially available hydrophobic silica particles (particles of fumed silica having a surface treated with silicone oil; volume-average diameter, 62 nm) are prepared and used as inorganic particles (5).

### Inorganic Particles (6)

Commercially available hydrophobic silica particles (particles of fumed silica having a surface treated with hexamethyldisilazane; volume-average diameter, 88 nm) are prepared and used as inorganic particles (6).

Inorganic Particles (7)

Commercially available hydrophobic silica particles (particles of fumed silica having a surface treated with hexamethyldisilazane; volume-average diameter, 93 nm) are prepared and used as inorganic particles (7).

### Inorganic Particles (8)

Commercially available calcium carbonate particles (volume-average diameter, 40 nm) are prepared and used as inorganic particles (8).

### Inorganic Particles (9)

Commercially available barium carbonate particles (volume-average diameter, 40 nm) are prepared and used as inorganic particles (9).

### Inorganic Particles (10)

Commercially available barium sulfate particles (BARIFINE BF-40, Sakai Chemical Industry, Co., Ltd.; volume-average diameter, 10 nm) are prepared and used as inorganic particles (10).

### Inorganic Particles (11)

Commercially available barium sulfate particles (BARIFINE BF-20, Sakai Chemical Industry, Co., Ltd.; volume-average diameter, 30 nm) are prepared and used as inorganic particles (11).

### Inorganic Particles (12)

Commercially available barium sulfate particles (BARIFINE BF-21, Sakai Chemical Industry, Co., Ltd.; volume-average diameter, 50 nm) are prepared and used as inorganic particles (12).

### Inorganic Particles (13)

A sample of 0.7 moles as TiO₂ of desulfurized and peptized metatitanic acid, which is a titanium source, is put into a reaction vessel. Then 0.77 moles of an aqueous solution of strontium chloride is added to the reaction vessel so that the SrO/TiO₂ molar ratio will be 1.1. Then a solution of lanthanum oxide in nitric acid is added in an amount that will make the lanthanum (La) content 0.5 moles per 100 moles of strontium. The three ingredients are prepared in such a manner that the initial TiO₂ concentration in the mixture will be 0.75 moles/L. Then the mixture is stirred and warmed to 92° C., 153 mL of a 10 N aqueous solution of sodium hydroxide is added over 3 hours with stirring while the temperature of the mixture is maintained at 92° C., and the resulting mixture is further stirred for 1 hour while its temperature is maintained at 92° C. Then the reaction solution is cooled to 40° C., hydrochloric acid is added until the pH reaches 5.4, and the resulting mixture is stirred for 1 hour. Then the precipitate is washed by repeated decantation and redispersion in water. The pH of the slurry containing the washed precipitate is adjusted to 6.5 with hydrochloric acid, solid-liquid separation is carried out by filtration, and the solid is dried. Then the dried solid is stirred with an ethanol solution of i-butyltrimethoxysilane (i-BTMS) for 1 hour, with the amount of i-BTMS being 20 parts per 100 parts of the solids. Solid-liquid separation is carried out by filtration, and the solid is dried in the air at 130° C. for 7 hours; the product is inorganic particles (13), the volume-average diameter of which is 25 nm.

### Examples 1 to 95 and Comparative Examples 1 to 4

### Production of Electrostatic Charge Image Developers

Of the resulting toners, the toners indicated in Tables 9 to 11 are put into a V-blender and stirred with the carriers indicated in Tables 9 to 11, with the amount of the toner being 8 parts and the amount of the carrier being 100 parts, and the resulting mixtures are sieved through a 212-μm mesh sieve; the products are the electrostatic charge image developers of Examples 1 to 95 and Comparative Examples 1 to 4 indicated in Tables 9 to 11.

### Fog Control Evaluation

A modified DocuPrint Color 3540 image forming apparatus (FUJIFILM Business Innovation Corp.) is prepared, and the resulting electrostatic charge image developers are put into its developing element. A test image with an area coverage of 60% in the color of cyan is printed on 50,000 sheets of A3 paper under high-temperature and high-humidity conditions (35° C. and 75% RH).

### Grading Criteria

A: The density E of the image background (i.e., the area with no printed image) is less than 0.015, with no fog visible to the eye.
B: The density E of the image background is 0.015 or greater and less than 0.030, with no fog visible to the eye.
B⁻: The density E of the image background is 0.030 or greater and less than 0.035, with no fog visible to the eye.
B⁻⁻: The density E of the image background is 0.035 or greater and less than 0.040, with no fog visible to the eye.
C: The density E of the image background is 0.040 or greater and less than 0.050, with no fog visible to the eye.
D: The density E of the image background is 0.050 or greater, with fog visible to the eye.

The above “density E” is the mean of densities measured at nine points in the no-image area with a spectrodensitometer (X-Rite 938, X-Rite) minus the density of a sheet of paper not used in the test.

TABLE 9

| | Toner A | Carrier B | | | |
|---|---|---|---|---|---|
| | Type | Type | D_{B}/D_{A} | D_{B}/D_{C} | Fog control |
| Example 1 | (1) | Carrier B (1) | 0.645 | 0.261 | A |
| Example 2 | (2) | Carrier B (1) | 0.645 | 0.245 | B |
| Example 3 | (3) | Carrier B (1) | 0.645 | 0.252 | B |
| Example 4 | (4) | Carrier B (1) | 0.645 | 0.357 | B |
| Example 5 | (5) | Carrier B (1) | 0.645 | 0.296 | B |
| Example 6 | (6) | Carrier B (1) | 0.645 | 0.137 | B |
| Example 7 | (7) | Carrier B (1) | 0.645 | 0.625 | B |
| Example 8 | (8) | Carrier B (1) | 0.645 | 0.131 | B |
| Example 9 | (9) | Carrier B (1) | 0.645 | 0.702 | B |
| Example 10 | (10) | Carrier B (1) | 0.645 | 0.261 | B |
| Example 11 | (11) | Carrier B (1) | 0.645 | 0.261 | B |
| Example 12 | (12) | Carrier B (1) | 0.645 | 0.261 | B |
| Example 13 | (13) | Carrier B (1) | 0.645 | 0.261 | B |
| Example 14 | (14) | Carrier B (1) | 0.645 | 0.261 | B |
| Example 15 | (15) | Carrier B (1) | 0.645 | 0.261 | B |
| Example 16 | (16) | Carrier B (1) | 0.645 | 0.261 | B |
| Example 17 | (17) | Carrier B (1) | 0.645 | 0.261 | B |
| Example 18 | (18) | Carrier B (1) | 0.645 | 0.261 | B |
| Example 19 | (19) | Carrier B (1) | 0.645 | 0.261 | B |
| Example 20 | (20) | Carrier B (1) | 0.645 | 0.261 | B |
| Example 21 | (21) | Carrier B (1) | 0.645 | 0.261 | B |
| Example 22 | (22) | Carrier B (1) | 0.645 | 0.261 | B |
| Example 23 | (23) | Carrier B (1) | 0.645 | 0.252 | B |
| Example 24 | (24) | Carrier B (1) | 0.645 | 0.242 | B− |
| Example 25 | (25) | Carrier B (1) | 0.645 | 0.211 | B− |
| Example 26 | (26) | Carrier B (1) | 0.645 | 0.261 | B− |
| Example 27 | (27) | Carrier B (1) | 0.645 | 0.261 | B− |
| Example 28 | (28) | Carrier B (1) | 0.645 | 0.261 | B− |
| Example 29 | (29) | Carrier B (1) | 0.645 | 0.261 | B−− |
| Example 30 | (30) | Carrier B (1) | 0.645 | 0.261 | B−− |
| Example 31 | (31) | Carrier B (1) | 0.645 | 0.261 | B− |
| Example 32 | (32) | Carrier B (1) | 0.645 | 0.261 | B− |
| Example 33 | (33) | Carrier B (1) | 0.645 | 0.245 | B− |
| Example 34 | (34) | Carrier B (1) | 0.645 | 0.247 | B− |
| Example 35 | (35) | Carrier B (1) | 0.645 | 0.261 | B− |
| Example 36 | (36) | Carrier B (1) | 0.645 | 0.242 | B− |
| Example 37 | (37) | Carrier B (1) | 0.645 | 0.252 | B− |
| Example 38 | (38) | Carrier B (1) | 0.645 | 0.260 | B− |
| Example 39 | (39) | Carrier B (1) | 0.645 | 0.234 | B− |
| Example 40 | (40) | Carrier B (1) | 0.656 | 0.261 | C |

TABLE 10

| | Toner A | Carrier B | | | |
|---|---|---|---|---|---|
| | Type | Type | D_{B}/D_{A} | D_{B}/D_{C} | Fog control |
| Example 41 | (41) | Carrier B (1) | 0.656 | 0.261 | A |
| Example 42 | (42) | Carrier B (1) | 0.645 | 0.261 | A |
| Example 43 | (43) | Carrier B (1) | 0.645 | 0.261 | A |
| Example 44 | (44) | Carrier B (1) | 0.645 | 0.261 | B |
| Example 45 | (45) | Carrier B (1) | 0.645 | 0.261 | B− |
| Example 46 | (46) | Carrier B (1) | 0.645 | 0.261 | C |
| Example 47 | (47) | Carrier B (1) | 0.500 | 0.261 | A |
| Example 48 | (48) | Carrier B (1) | 0.800 | 0.261 | A |
| Example 49 | (49) | Carrier B (1) | 1.000 | 0.261 | A |
| Example 50 | (50) | Carrier B (1) | 0.645 | 0.261 | A |
| Example 51 | (51) | Carrier B (1) | 0.645 | 0.261 | A |
| Example 52 | (52) | Carrier B (1) | 0.645 | 0.261 | A |
| Example 53 | (53) | Carrier B (1) | 0.645 | 0.261 | A |
| Example 54 | (54) | Carrier B (1) | 0.645 | 0.261 | A |
| Example 55 | (55) | Carrier B (1) | 0.645 | 0.261 | B− |
| Example 56 | (1) | Carrier B (2) | 0.645 | 0.261 | A |
| Example 57 | (1) | Carrier B (3) | 0.645 | 0.261 | B |
| Example 58 | (1) | Carrier B (4) | 1.500 | 0.608 | C |
| Example 59 | (1) | Carrier B (5) | 1.419 | 0.575 | C |
| Example 60 | (1) | Carrier B (6) | 0.113 | 0.046 | B |
| Example 61 | (1) | Carrier B (7) | 0.065 | 0.026 | C |
| Example 62 | (1) | Carrier B (8) | 0.065 | 0.026 | C |
| Example 63 | (1) | Carrier B (9) | 0.113 | 0.046 | B |
| Example 64 | (1) | Carrier B (10) | 1.419 | 0.575 | C |
| Example 65 | (1) | Carrier B (11) | 1.500 | 0.608 | C |
| Example 66 | (1) | Carrier B (12) | 0.065 | 0.026 | C |
| Example 67 | (1) | Carrier B (13) | 0.113 | 0.046 | B |
| Example 68 | (1) | Carrier B (14) | 1.419 | 0.575 | C |
| Example 69 | (1) | Carrier B (15) | 1.500 | 0.608 | C |
| Example 70 | (1) | Carrier B (16) | 0.645 | 0.261 | B |
| Example 71 | (1) | Carrier B (17) | 0.645 | 0.261 | A |
| Example 72 | (1) | Carrier B (18) | 0.645 | 0.261 | A |
| Example 73 | (1) | Carrier B (19) | 0.645 | 0.261 | B |
| Example 74 | (1) | Carrier B (20) | 0.194 | 0.078 | C |
| Example 75 | (1) | Carrier B (21) | 0.194 | 0.078 | C |
| Example 76 | (1) | Carrier B (22) | 1.000 | 0.405 | B |
| Example 77 | (1) | Carrier B (23) | 1.000 | 0.405 | B− |
| Example 78 | (1) | Carrier B (24) | 0.645 | 0.261 | A |
| Example 79 | (1) | Carrier B (25) | 0.645 | 0.261 | A |
| Example 80 | (1) | Carrier B (26) | 0.645 | 0.261 | A |

TABLE 11

| | Toner A | Carrier B | | | |
|---|---|---|---|---|---|
| | Type | Type | D_{B}/D_{A} | D_{B}/D_{C} | Fog control |
| Example 81 | (1) | Carrier B (27) | 0.645 | 0.261 | B |
| Example 82 | (1) | Carrier B (28) | 0.645 | 0.261 | B |
| Example 83 | (1) | Carrier B (29) | 0.161 | 0.065 | B |
| Example 84 | (1) | Carrier B (30) | 0.484 | 0.196 | B |
| Example 85 | (1) | Carrier B (31) | 0.806 | 0.327 | B |
| Example 86 | (1) | Carrier B (32) | 0.968 | 0.392 | B |
| Example 87 | (1) | Carrier B (33) | 0.645 | 0.261 | C |
| Example 88 | (1) | Carrier B (34) | 0.645 | 0.261 | C |
| Example 89 | (49) | Carrier B (14) | 2.200 | 0.575 | B− |
| Example 90 | (7) | Carrier B (14) | 1.419 | 1.375 | B− |
| Example 91 | (8) | Carrier B (13) | 0.113 | 0.023 | B− |
| Example 92 | (47) | Carrier B (12) | 0.050 | 0.026 | C |
| Example 93 | (49) | Carrier B (15) | 2.325 | 0.608 | C |
| Example 94 | (7) | Carrier B (15) | 1.500 | 1.453 | C |
| Example 95 | (8) | Carrier B (12) | 0.065 | 0.013 | C |
| Comparative | (C1) | Carrier B (1) | 0.645 | — | D |
| Example 1 | | | | | |
| Comparative | (56) | Carrier B (1) | 0.656 | 0.261 | D |
| Example 2 | | | | | |
| Comparative | (57) | Carrier B (1) | 0.645 | 0.261 | D |
| Example 3 | | | | | |
| Comparative | (1) | Carrier B (35) | — | — | D |
| Example 4 | | | | | |

As can be seen from these test results, the electrostatic charge image developers of the Examples may be superior in fog control.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An electrostatic charge image developer including a toner A incorporating a toner particle and a silica particle (A) as an external additive, the toner particle containing a binder resin and a resin particle, and the silica particle (A) containing a nitrogen-containing compound containing element molybdenum; and a carrier B incorporating a core and a coating resin layer, the coating resin layer covering the core and containing an inorganic particle, wherein a ratio N_{Mo}/N_{Si} is 0.035 or greater and 0.45 or less, where N_{Mo} and N_{Si} are measured net intensities for the element molybdenum and element silicon, respectively, in the silica particle (A) in x-ray fluorescence analysis.

(((2)))

The electrostatic charge image developer according to (((1))), wherein an amount of the inorganic particle is 10% by mass or more and 50% by mass or less of a total mass of the coating resin layer.

(((3)))

The electrostatic charge image developer according to (((1))) or (((2))), wherein the coating resin layer contains a (meth)acrylic resin having a ring structure.

(((4)))

The electrostatic charge image developer according to any one of (((1))) to (((3))), wherein the resin particle is a crosslinked resin particle.

(((5)))

The electrostatic charge image developer according to (((4))), wherein the crosslinked resin particle is a crosslinked styrene-(meth)acrylic resin particle.

(((6)))

The electrostatic charge image developer according to any one of (((1))) to (((5))), wherein a ratio D_{B}/D_{A} is 0.06 or greater and 2.30 or less, where D_{A} is an average diameter of primary particles for the silica particles (A), and D_{B} is an average diameter of primary particles for the inorganic particles.

(((7)))

The electrostatic charge image developer according to any one of (((1))) to (((6))), wherein a ratio D_{B}/D_{C} is 0.02 or greater and 1.40 or less, where D_{C} is an average diameter of primary particles for the resin particles, and D_{B} is an average diameter of primary particles for the inorganic particles.

(((8)))

The electrostatic charge image developer according to any one of (((1))) to (((7))), wherein each of D1(90), D50(90), D1(150), and D50(150) is 0.5 or greater and 2.5 or less; D50(150)−D1(150) is less than 1.5; and D50(90)−D1(90) is less than 1.0, where D1(90) is a loss tangent tan δ of the toner at a temperature of 90° C. and a strain of 1%, D50(90) is a loss tangent tan δ of the toner at a temperature of 90° C. and a strain of 50%, D1(150) is a loss tangent tan δ of the toner at a temperature of 150° C. and a strain of 1%, and D50(150) is a loss tangent tan δ of the toner at a temperature of 150° C. and a strain of 50%, all measured in dynamic rheometry.

(((9)))

A process cartridge attachable to and detachable from an image forming apparatus, the process cartridge including a developing component that contains the electrostatic charge image developer according to any one of (((1) to (((8))) and develops, using the electrostatic charge image developer, an electrostatic charge image on a surface of an image carrier to form a toner image.

(((10)))

An image forming apparatus including an image carrier; a charging component that charges the image carrier; an exposure component that creates an electrostatic latent image on the image carrier by exposing the charged image carrier to light; a developing component that develops, using an electrostatic charge image developer, the electrostatic latent image to form a toner image, the developer being the electrostatic charge image developer according to any one of (((1))) to (((8))); a transfer component that transfers the toner image from the image carrier to a transfer medium; and a fixing component that fixes the toner image.

(((11)))

An image forming method including charging at least an image carrier; creating an electrostatic latent image on a surface of the image carrier by exposing the image carrier to light; developing, using an electrostatic charge image developer, the electrostatic latent image on the surface of the image carrier to form a toner image, the developer being the electrostatic charge image developer according to (((1))) to (((8))); transferring the toner image on the surface of the image carrier to a surface of a transfer medium; and fixing the toner image.

What is claimed is:

1. An electrostatic charge image developer comprising:
a toner A incorporating a toner particle and a silica particle (A) as an external additive, the toner particle containing a binder resin and a resin particle, and the silica particle (A) containing a nitrogen-containing compound containing element molybdenum; and
a carrier B incorporating a core and a coating resin layer, the coating resin layer covering the core and containing an inorganic particle, wherein:
a ratio N_{Mo}/N_{Si} is 0.035 or greater and 0.45 or less, where N_{Mo} and N_{Si} are measured net intensities for the element molybdenum and element silicon, respectively, in the silica particle (A) in x-ray fluorescence analysis.

2. The electrostatic charge image developer according to claim 1, wherein an amount of the inorganic particle is 10% by mass or more and 50% by mass or less of a total mass of the coating resin layer.

3. The electrostatic charge image developer according to claim 1, wherein the coating resin layer contains a (meth)acrylic resin having a ring structure.

4. The electrostatic charge image developer according to claim 1, wherein the resin particle is a crosslinked resin particle.

5. The electrostatic charge image developer according to claim 4, wherein the crosslinked resin particle is a crosslinked styrene-(meth)acrylic resin particle.

6. The electrostatic charge image developer according to claim 1, wherein a ratio D_{B}/D_{A} is 0.06 or greater and 2.30 or less, where D_{A} is an average diameter of primary particles for the silica particles (A), and D_{B} is an average diameter of primary particles for the inorganic particles.

7. The electrostatic charge image developer according to claim 1, wherein a ratio D_{B}/D_{C} is 0.02 or greater and 1.40 or less, where D_{C} is an average diameter of primary particles for the resin particles, and D_{B} is an average diameter of primary particles for the inorganic particles.

8. The electrostatic charge image developer according to claim 1, wherein:
each of D1(90), D50(90), D1(150), and D50(150) is 0.5 or greater and 2.5 or less;
D50(150)−D1(150) is less than 1.5; and
D50(90)−D1(90) is less than 1.0,
where D1(90) is a loss tangent tan δ of the toner at a temperature of 90° C. and a strain of 1%, D50(90) is a loss tangent tan δ of the toner at a temperature of 90° C. and a strain of 50%, D1(150) is a loss tangent tan δ of the toner at a temperature of 150° C. and a strain of 1%, and D50(150) is a loss tangent tan δ of the toner at a temperature of 150° C. and a strain of 50%, all measured in dynamic rheometry.

9. A process cartridge attachable to and detachable from an image forming apparatus, the process cartridge comprising:
a developing component that contains the electrostatic charge image developer according to claim 1 and develops, using the electrostatic charge image developer, an electrostatic charge image on a surface of an image carrier to form a toner image.

10. A process cartridge attachable to and detachable from an image forming apparatus, the process cartridge comprising:
a developing component that contains the electrostatic charge image developer according to claim 2 and develops, using the electrostatic charge image developer, an electrostatic charge image on a surface of an image carrier to form a toner image.

11. A process cartridge attachable to and detachable from an image forming apparatus, the process cartridge comprising:
a developing component that contains the electrostatic charge image developer according to claim 3 and develops, using the electrostatic charge image developer, an electrostatic charge image on a surface of an image carrier to form a toner image.

12. A process cartridge attachable to and detachable from an image forming apparatus, the process cartridge comprising:
a developing component that contains the electrostatic charge image developer according to claim 4 and develops, using the electrostatic charge image developer, an electrostatic charge image on a surface of an image carrier to form a toner image.

13. A process cartridge attachable to and detachable from an image forming apparatus, the process cartridge comprising:
a developing component that contains the electrostatic charge image developer according to claim 5 and develops, using the electrostatic charge image developer, an electrostatic charge image on a surface of an image carrier to form a toner image.

14. A process cartridge attachable to and detachable from an image forming apparatus, the process cartridge comprising:
a developing component that contains the electrostatic charge image developer according to claim 6 and develops, using the electrostatic charge image developer, an electrostatic charge image on a surface of an image carrier to form a toner image.

15. A process cartridge attachable to and detachable from an image forming apparatus, the process cartridge comprising:
a developing component that contains the electrostatic charge image developer according to claim 7 and develops, using the electrostatic charge image developer, an electrostatic charge image on a surface of an image carrier to form a toner image.

16. A process cartridge attachable to and detachable from an image forming apparatus, the process cartridge comprising:
a developing component that contains the electrostatic charge image developer according to claim 8 and develops, using the electrostatic charge image developer, an electrostatic charge image on a surface of an image carrier to form a toner image.

17. An image forming apparatus comprising:
an image carrier;
a charging component that charges the image carrier;
an exposure component that creates an electrostatic latent image on the image carrier by exposing the charged image carrier to light;
a developing component that develops, using an electrostatic charge image developer, the electrostatic latent image to form a toner image, the developer being the electrostatic charge image developer according to claim 1;
a transfer component that transfers the toner image from the image carrier to a transfer medium; and
a fixing component that fixes the toner image.

18. An image forming apparatus comprising:
an image carrier;
a charging component that charges the image carrier;
an exposure component that creates an electrostatic latent image on the image carrier by exposing the charged image carrier to light;
a developing component that develops, using an electrostatic charge image developer, the electrostatic latent image to form a toner image, the developer being the electrostatic charge image developer according to claim 2;
a transfer component that transfers the toner image from the image carrier to a transfer medium; and
a fixing component that fixes the toner image.

19. An image forming apparatus comprising:
an image carrier;
a charging component that charges the image carrier;
an exposure component that creates an electrostatic latent image on the image carrier by exposing the charged image carrier to light;
a developing component that develops, using an electrostatic charge image developer, the electrostatic latent image to form a toner image, the developer being the electrostatic charge image developer according to claim 3;
a transfer component that transfers the toner image from the image carrier to a transfer medium; and
a fixing component that fixes the toner image.

20. An image forming method comprising:
charging at least an image carrier;
creating an electrostatic latent image on a surface of the image carrier by exposing the image carrier to light;
developing, using an electrostatic charge image developer, the electrostatic latent image on the surface of the image carrier to form a toner image, the developer being the electrostatic charge image developer according to claim 1;
transferring the toner image on the surface of the image carrier to a surface of a transfer medium; and
fixing the toner image.
